(19) United States
(12) Patent Application Publication
(10) Pub. No.: US 2020/0291052 A1
(43) Pub. Date: Sep. 17, 2020

(54) BIS-PHENANTHROLINE IRON MACROCYCLE COMPLEX FOR OXYGEN REDUCTION REACTION

(71) Applicant: Massachusetts Institute of Technology, Cambridge, MA (US)

(72) Inventors: Yogesh Surendranath, Cambridge, MA (US); Travis Marshall-Roth, Cambridge, MA (US)

(21) Appl. No.: 16/820,333

(22) Filed: Mar. 16, 2020

Related U.S. Application Data
(60) Provisional application No. 62/818,284, filed on Mar. 14, 2019.

(51) Int. Cl. C07F 15/02; H01M 4/94; H01M 8/1004; B01J 31/18; B01J 35/00

(52) U.S. Cl. CPC C07F 15/025; H01M 4/94; B01J 21/18; B01J 31/183; B01J 35/0033; H01M 8/1004

(57) ABSTRACT

Disclosed are compounds, compositions, and methods useful for the oxygen reduction reaction (ORR) and capable of operating efficiently at low overpotentials.

### RELATED APPLICATIONS

This application claims the benefit of priority to U.S. Provisional Patent Application No. 62/818,284, filed Mar. 14, 2019.

### GOVERNMENT SUPPORT

This invention was made with government support under SC0014176 awarded by the Department of Energy. The government has certain rights in the invention.

### BACKGROUND

The efficient reduction of molecular oxygen to water is a critical component reaction in many types of fuel cells. Refs. 1,2. Regardless of the fuel source used, the current density output is primarily by slow electron transfer rates in the oxygen reduction half reaction at the cathode. Ref 3. These rates can lag behind the anodic fuel oxidation process by several orders of magnitude thereby urgently motivating the development of improved electrocatalysts for the oxygen reduction reaction (ORR) capable of operating efficiently at low overpotentials. Refs. 4,5. As such, significant effort has been expended developing alternative catalytic materials which are comparably active as Pt-based ORR electrocatalysts at significantly lower cost.

Pyrolyzed iron and nitrogen-doped (Fe—N—C) materials are leading alternatives to replace Pt-based electrocatalysts. However, developmental. progress has been hampered by the fact that the active sites for pyrolyzed catalytic materials remain poorly interrogated. The wide range of preparative procedures found in the literature for the synthesis of doped-graphitic materials has led to uncertainty regarding the identity of the active sites for ORR in these materials. Fe—N—C materials are typically prepared by high temperature pyrolysis of finely dispersed iron salt or porphyrin (refs. 6,7) additives in a MOF (refs. 8,9) or carbon-based support. Refs. 10-12. Much controversy has surrounded the identity of the active sites in pyrolyzed, doped graphitic materials due to the high heterogeneity induced by pyrolysis coupled with a diverse set of synthetic procedures. Metallic iron has been postulated as part of an active site structure (ref. 13) as have various iron-nitrogen coordination environments in an effort to explain X-ray absorption spectroscopy (XAS) results. Refs. 14-17. Numerous reports have corroborated the early assumption that the ORR active sites are principally iron-containing defects in the hexagonal lattice coordinated by nitrogen atoms. Ref. 18.

### SUMMARY

In some embodiments, the disclosure relates to a compound of Formula I or a salt thereof:

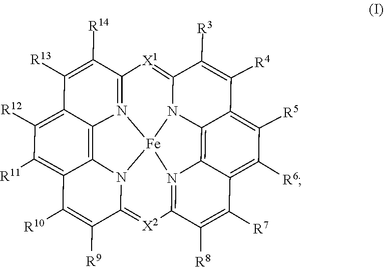

wherein

X¹ and X² are independently N, C(R¹⁵), (O⁺)X⁻, or (S⁺)X⁻;

X⁻ is independently for each occurrence boron tetrafluoride, phosphorus tetrafluoride, phosphorus hexafluoride, alkylsulfonate, fluoroalkylsulfonate, arylsulfonate, bis(alkylsulfonyl)amide, bis(fluoroalkylsulfonyl)amide, bis(arylsulfonyl)amide, (fluoroalkylsulfonyl)(fluoroalkylcarbonyl)amide, halide, nitrate, nitrite, sulfate, hydrogensulfate, alkyl sulfate, aryl sulfate, carbonate, bicarbonate, alkyl carboxylate, aryl carboxylate, phosphate, hydrogen phosphate, dihydrogen phosphate, hypochlorite, or an anionic site of a cation-exchange resin;

Y⁺ is Li⁺, Na⁺, K⁺, Mg²⁺, Ca²⁺, or ⁺NR¹⁶R¹⁷R¹⁸R¹⁹;

R³, R⁴, R⁵, R⁶, R⁷, R⁸, R⁹, R¹⁰, R¹¹, R¹², R¹³, and R¹⁴ are independently hydrogen, halogen, —CN, —OR¹⁵, —CO₂⁻(Y⁺), —SO₃H, —SO₃⁻(Y⁺), —NR¹⁶R¹⁷, —NO₂, substituted or unsubstituted alkyl, substituted or unsubstituted cycloalkyl, substituted or unsubstituted aryl, substituted or unsubstituted heteroaryl, substituted or unsubstituted heterocycloalkyl, haloalkyl, —OC(O)R²⁰, —C(O)R²⁰, —C(O)OR²⁰, —C(O)NR²¹R²², —S(O)R²³, or —SO₂R²³; and

R¹⁵, R¹⁶, R¹⁷, R¹⁸, R¹⁹, R²⁰, R²¹, R²², and R²³ are independently hydrogen, haloalkyl, substituted or unsubstituted alkyl, substituted or unsubstituted cycloalkyl, substituted or unsubstituted aryl, substituted or unsubstituted heteroaryl, or substituted or unsubstituted heterocycloalkyl.

In certain embodiments, X¹ is N; and the compound of Formula I is a Bronsted conjugate acid or a quaternary (C₁-C₆)alkyl ammonium salt at X¹.

In certain embodiments, X² is N; and the compound of Formula I is a Bronsted conjugate acid or a quaternary (C₁-C₆)alkyl ammonium salt at X².

In certain embodiments, X¹ is N; X² is N; the compound of Formula I is a Bronsted conjugate acid or a quaternary (C₁-C₆)alkyl ammonium salt at X¹; and the compound of Formula I is a Bronsted conjugate acid or a quaternary (C₁-C₆)alkyl ammonium salt at X².

In certain embodiments, the disclosure relates to a compound of Formula I or a salt thereof, wherein X¹ is C(R¹⁵).

In some embodiments, the disclosure relates to a compound of Formula I or a salt thereof, wherein X² is C(R¹⁵).

In some embodiments, the disclosure relates to a compound of Formula I or a salt thereof, wherein X¹ is C(R¹⁵); and X² is C(R¹⁵).

In other embodiments, the disclosure relates to a compound of Formula I or a salt thereof, wherein X¹ is N.

In some embodiments, the disclosure relates to a compound of Formula I or a salt thereof, wherein X² is N.

In other embodiments, the disclosure relates to a compound of Formula I or a salt thereof, wherein X¹ is N; and X² is N.

In some embodiments, the disclosure relates to a compound of Formula I or a salt thereof, wherein X¹ is (O⁺)X⁻ or (S⁺)X⁻.

In certain embodiments, the disclosure relates to a compound of Formula I or a salt thereof, wherein X² is (O⁺)X⁻ or (S⁺)X⁻.

In some embodiments, the disclosure relates to a compound of Formula I or a salt thereof, wherein X¹ is (O⁺)X⁻ or (S⁺)X⁻; and X² is (O⁺)X⁻ or (S⁺)X⁻.

In some embodiments, the disclosure relates to a compound of Formula I or a salt thereof, wherein R¹⁵ is hydrogen.

In other embodiments, the disclosure relates to a compound of Formula I or a salt thereof, wherein R¹⁵ is substituted or unsubstituted alkyl. Alternatively, R¹⁵ is substituted or unsubstituted cycloalkyl. In some instances, R¹⁵ is substituted or unsubstituted aryl. In certain embodiments, the disclosure relates to a compound of Formula I or a salt thereof, wherein R¹⁵ is substituted or unsubstituted heteroaryl.

In some embodiments, the disclosure relates to a compound of Formula I or a salt thereof, wherein at least one of R³, R⁴, R⁵, R⁶, R⁷, R⁸, R⁹, R¹⁰, R¹¹, R¹², R¹³, and R¹⁴ is not hydrogen.

In certain embodiments, the disclosure relates to a compound of Formula I or a salt thereof, wherein at least two of R³, R⁴, R⁵, R⁶, R⁷, R⁸, R⁹, R¹⁰, R¹¹, R¹², R¹³, and R¹⁴ are not hydrogen.

In other embodiments, the disclosure relates to a compound of Formula I or a salt thereof, wherein at least three of R³, R⁴, R⁵, R⁶, R⁷, R⁸, R⁹, R¹⁰, R¹¹, R¹², R¹³, and R¹⁴ are not hydrogen.

In some embodiments, the disclosure relates to a compound of Formula I or a salt thereof, wherein at least four of R³, R⁴, R⁵, R⁶, R⁷, R⁸, R⁹, R¹⁰, R¹¹, R¹², R¹³, and R¹⁴ are not hydrogen.

In some embodiments, the disclosure relates to a compound of Formula I or a salt thereof, wherein R³, R⁴, R⁵, R⁶, R⁷, R⁸, R⁹, R¹⁰, R¹¹, R¹², R¹³, and R¹⁴ are hydrogen; and X¹ is C(R¹⁵), (O⁺)X⁻, or (S⁺)X⁻.

In certain embodiments, the disclosure relates to a compound of Formula I or a salt thereof, wherein R³, R⁴, R⁵, R⁶, R⁷, R⁸, R⁹, R¹⁰, R¹¹, R¹², R¹³, and R¹⁴ are hydrogen; X¹ is C(R¹⁵), (O⁺)X⁻, or (S⁺)X⁻; and X² is C(R¹⁵), (O⁺)X⁻, or (S⁺)X⁻.

In some embodiments, the disclosure relates to a compound of Formula I or a salt thereof, wherein R³, R⁴, R⁵, R⁶, R⁷, R⁸, R⁹, R¹⁰, R¹¹, R¹², R¹³, and R¹⁴ are hydrogen; and X¹ is C(R¹⁵).

In other embodiments, the disclosure relates to a compound of Formula I or a salt thereof, wherein R³, R⁴, R⁵, R⁶, R⁷, R⁸, R⁹, R¹⁰, R¹¹, R¹², R¹³, and R¹⁴ are hydrogen; X¹ is C(R¹⁵); and X² is C(R¹⁵).

In some embodiments, the disclosure relates to a compound of Formula I or a salt thereof, wherein R³, R⁴, R⁵, R⁶, R⁷, R⁸, R⁹, R¹⁰, R¹¹, R¹², R¹³, and R¹⁴ are hydrogen; and X¹ is (O⁺)X⁻ or (S⁺)X⁻.

In certain embodiments, the disclosure relates to a compound of Formula I or a salt thereof, wherein R³, R⁴, R⁵, R⁶, R⁷, R⁸, R⁹, R¹⁰, R¹¹, R¹², R¹³, and R¹⁴ are hydrogen; X¹ is (O⁺)X⁻ or (S⁺)X⁻; and X² is (O⁺)X⁻ or (S⁺)X⁻.

In some embodiments, the disclosure relates to a compound of Formula I or a salt thereof, wherein R³, R⁴, R⁵, R⁶, R⁷, R⁸, R⁹, R¹⁰, R¹¹, R¹², R¹³, and R¹⁴ are hydrogen; X¹ is N; and X² is N.

In some embodiments, the disclosure relates to a composition comprising a compound of Formula I or a salt thereof and a support material; wherein the compound is in contact with the support material.

In certain embodiments, the disclosure relates to a composition wherein the support material comprises carbon. For example, the support material comprises carbon powder. In some instances, the support material comprises carbon black (CB), multi-walled carbon nanotubes (MWCNT), graphene oxide (GO), or reduced graphene oxide (rGO).

In some embodiments, the disclosure relates to a composition wherein the compound is adsorbed on the support material.

In some embodiments, the disclosure relates to a cathode catalyst, comprising a compound of Formula I or a salt thereof or a composition comprising a compound of Formula I or a salt thereof.

In certain embodiments, the disclosure relates to a fuel cell, comprising a cathode catalyst comprising a compound of Formula I or a salt thereof or a composition comprising a compound of Formula I or a salt thereof.

In some embodiments, the disclosure relates to a method of reducing oxygen, comprising:

in an electrochemical device, applying current to a mixture comprising an aqueous medium, hydrogen gas, oxygen gas, and a compound of Formula I or a salt thereof or a composition comprising a compound of Formula I or a salt thereof.

In some embodiments, the disclosure relates to a method of reducing oxygen, wherein the aqueous medium is an alkaline medium.

In certain embodiments, the disclosure relates to a method of reducing oxygen, wherein the electrochemical device is an anion-exchange membrane fuel cell or an alkaline metal-air battery.

In some embodiments, the disclosure relates to a method of reducing oxygen, wherein the aqueous medium is an acidic medium.

In certain embodiments, the disclosure relates to a method of reducing oxygen, wherein the electrochemical device is a proton-exchange membrane fuel cell.

Other features, objects, and advantages of the invention will be apparent from the detailed description, and from the claims.

### BRIEF DESCRIPTION OF THE DRAWINGS

FIG. 1 depicts a synthetic route to (phen₂N₂)H₂ (compound 5, also known as phencirH₂) and the Fe(III) complex 6, (phen₂N₂)FeCl.

FIG. 2 depicts optical spectrum of (phen₂N₂)H₂ (black, 25 μM in MeCN containing 20 mM trifluoroacetic acid) and [(phen₂N₂)Fe]⁺ (red, 3.5 μM in MeCN). No optical transitions were observed beyond 800 nm to the instrumentation limit of 1100 nm.

FIG. 3 depicts X-ray absorption near edge structure (XANES) spectra of (phen₂N₂)FeCl, reduced (phen₂N₂)FeCl, Fe—N—C, reduced Fe—N—C, and OEPFeCl.

FIG. 4 depicts k²-weighted Fourier transform of the iron k-edge extended X-ray absorption fine structure spectroscopy (EXAFS) data for (phen₂N₂)FeCl, Fe—N—C, and OEPFeCl.

FIG. 5 depicts high resolution N₁ₛ X-ray photoelectron spectroscopy (XPS) data of (phen₂N₂)FeCl and Fe—N—C (A); and high resolution Fe₂ₚ XPS of (phen₂N₂)FeCl and Fe—N—C (B).

FIG. 6 depicts zero-field ⁵⁷Fe Mössbauer spectra of (phen₂N₂)FeCl under inert atmosphere at 90 K (A); and zero-field ⁵⁷Fe Mössbauer spectra of (phen₂N₂)FeCl upon reduction with Cp₂Co under inert atmosphere at 90 K (B).

FIG. 7 depicts cyclic voltammograms of OEPFeCl, (phen₂N₂)FeCl and Fe—N—C inks collected at 5 mV s⁻ and 2000 RPM in argon-sparged 0.1 M HClO₄.

FIG. 8 depicts cyclic voltammograms of (phen₂N₂)FeCl/Vulcan/Nafion ink dropcast on glassy carbon disk electrodes in N₂- and O₂-saturated (black and red, respectively) 0.1 M HClO₄ aqueous electrolyte collected at 5 mV s⁻¹ and 2000 RPM.

FIG. 9 depicts linear sweep voltammograms of (phen₂N₂)FeCl/Vulcan/Nafion (blue), OEPFeCl/Vulcan/Nafion (orange) and Fe—N—C/Nafion (black) inks dropcast on glassy carbon disk electrodes in N₂- and O₂-saturated 0.1 M HClO₄ aqueous electrolyte collected at a scan rate of 5 mV s⁻¹ while being rotated at 2000 RPM. Background carbon ORR activity is given in teal.

FIG. 10 depicts rotating ring-disk electrode voltammogram (ring: red, disk: black) voltammograms of (phen₂N₂)FeCl/Vulcan/Nafion ink dropcast on glassy carbon disk electrodes in O₂-saturated 0.1 M HClO₄ aqueous electrolyte collected at a scan rate of 5 mV s⁻¹ while being rotated at 2000 RPM. The inset displays the onset region.

FIG. 11 depicts number of electrons transferred as a function of potential during ORR catalysis by (phen₂N₂)FeCl/Vulcan/Nafion ink dropcast on glassy carbon disk electrodes in O₂-saturated 0.1 M HClO₄ aqueous electrolyte collected at a scan rate of 5 mV s⁻¹ while being rotated at 2000 RPM.

FIG. 12 depicts (a) Linear sweep voltammograms of Fe—N—C (black), (phen₂N₂)FeCl (blue), OEPFeCl (orange) inks and blank glassy carbon (teal) collected in O₂-sparged 0.1 M NaOH at a rotation rate of 2000 RPM with a scan rate of 5 mV s⁻¹; (b) RRDE plot of (phen₂N₂)FeCl in O₂-sparged 0.1 M NaOH at a rotation rate of 2000 RPM with a scan rate of 5 mV s¹; (c) Number of electrons transferred; and (d) % H₂O₂ produced in base as a function of potential derived from RRDE data for Fe—N—C (black), (phen₂N₂)FeCl (blue) and OEPFeCl (orange).

FIG. 13 depicts voltammograms demonstrating the influence of CO on ORR performance of inks: (a) (phen₂N₂)FeCl in acid, (b) (phen₂N₂)FeCl in base, (c) Fe—N—C in acid, and (d) Fe—N—C in base. Data was collected in either 0.1 M HClO₄ or 0.1 M NaOH at a rotation rate of 2000 RPM and scan rate of 5 mV s⁻¹. Black traces are initial scans in O₂-sparged media, while red data represent scans recorded in O₂— and CO-sparged media. Blue traces were recorded after clearing liquid-phase CO by sparging with O₂.

FIG. 14 depicts voltammograms demonstrating the influence of KCN on ORR performance of inks: (a) (phen₂N₂)FeCl in base and (b) Fe—N—C in base. Data was collected in 0.1 M NaOH at a rotation rate of 2000 RPM and scan rate of 5 mV s⁻¹. Black traces are initial scans in O₂-sparged media, while red data represent scans recorded in O₂-sparged media solution containing 5 mM KCN. Blue traces were recorded after exchanging the electrolyte.

FIG. 15 depicts cyclic voltammogram of 0.25 mM (phen₂N₂)FeCl in Ar-sparged DMF containing 0.52 mM TlOTf, 22 mM [DMF-H][OTf] and 91 mM [TBA][PF₆] collected at a scan rate of 20 mV s⁻¹.

FIG. 16 depicts cyclic voltammograms of 0.5 mM (ph₄phen₂N₂)FeCl in DMF containing ferrocene, 0.1 M [DMF-H][OTf] and 0.1 M [TBA][PF₆]. Under argon atmosphere without 0.1 M LiCl (a), under argon atmosphere with 0.1 M LiCl (b), under argon atmosphere with the same electrolyte as in (b) before introduction of O₂ (c), and under both argon (black) and oxygen atmosphere (red) with the same electrolyte composition as in (b).

FIG. 17 depicts optical spectra of (phen₂N₂)H₂ (black, 26 μM in DMSO) and (phen₂N₂)FeCl (red, 15 μM in DMSO). No optical transitions were observed beyond 800 nm to the instrumentation limit of 1100 nm.

FIG. 18 depicts Zero-field ⁵⁷Fe Mössbauer spectra of Fe—N—C: [D1: (δ=0.46 mm s⁻¹, |ΔE_{Q}|=1.08 mm s⁻¹), D2: (δ=0.37 mm s⁻¹, |ΔE_{Q}|=3.06 mm s⁻¹), top], (phen₂N₂)FeCl: [(δ=0.39 mm s⁻¹, |ΔE_{Q}|=3.06 mm s⁻¹), middle] and [(phen₂N₂)Fe]₂O: [(δ=0.45 mm s¹, |ΔE_{Q}|=0.87 mm s⁻¹), bottom] recorded at 90 K. The spectrum of (phen₂N₂)FeCl was fit to two quadrupole doublets assigned to (phen₂N₂)FeCl (blue) and a residual Fe₂Cl₆·(DMF)₃ impurity [(δ=0.39 mm s⁻¹, |ΔE_{Q}|=1.27 mm s⁻¹), yellow].

FIG. 19 depicts high resolution N 1s and Fe 2p XPS spectra of Fe—N—C (a and e), [(phen₂N₂)Fe]₂O (b and f), [(OEP)Fe]₂O (c and g), and [(Pc)Fe]₂O (d and h).

FIG. 20 depicts XPS high-resolution N is spectra of (phen₂N₂)Fe]₂O (top), (phen₂N₂)FeCl (middle) and (phen₂N₂)H₂ (bottom) powders mixed with Au powder and pressed onto conductive carbon tape.

FIG. 21 depicts X-ray absorption spectroscopy data for Fe—N—C (black), [(phen₂N₂)Fe]₂O (blue), [(OEP)Fe]₂O (orange) and [(PcFe)]₂O (aqua). XANES spectra (a), and expanded main-edge region (inset), k²-weighted Fe k-edge EXAFS spectra (b), and k²-weighted Fourier transform Fe EXAFS spectra (c). The energy values of the vertical lines and the alphabetical labels in (a) are taken from reference 15.

FIG. 22 depicts cyclic voltammograms of rotating glassy carbon disk electrodes modified with catalyst films containing Fe—N—C (black), (phen₂N₂)FeCl (blue), (OEP)FeCl (orange), and (Pc)FeCl (aqua). Data were recorded at 5 mV s⁻¹ and 2000 rpm rotation rate in O₂-free 0.1 M HClO₄ electrolyte.

FIG. 23 depicts nominal catalyst mass loadings for carbon inks dropcast on 5 mm RDEs. ^{a}Mass loadings calculated for 10 uL aliquots dropcast on glassy carbon RDEs based upon stock ink concentrations for each catalyst which were in the range of 1-1.5 mg mL⁻¹ catalyst and 2.5-4.0 mg mL⁻¹ Vulcan carbon powder. ^{b}Electroactive moles were calculated by integrating the Fe(III/II) redox wave visible in traces recorded under inert atmosphere in 0.1 M HClO₄ at a scan rate of 5 mV s⁻¹. e(phen₂N₂)FeCl and (OEP)FeCl inks were prepared as 1.1 mg mL⁻¹ catalyst mixtures in 2.5 mg mL⁻¹ Vulcan carbon. ^{d}(Pc)FeCl inks were prepared as 1.5 mg mL⁻¹ catalyst mixtures in 3.7 mg mL⁻¹ Vulcan carbon. eFe—N—C catalyst ink was prepared without Vulcan carbon and had a concentration of 4.7 mg mL⁻¹. ^{f}(phen₂N₂)H₂ ink was prepared as a 0.9 mg mL⁻¹ catalyst mixture in 2.7 mg mL⁻¹ Vulcan carbon. ^{g}Bare Vulcan carbon ink was prepared in a stock concentration of 10 mg mL⁻¹.

FIG. 24 depicts cyclic voltammograms of a rotating glassy carbon disk electrode modified with a catalyst film containing (phen₂N₂)FeCl in N₂- (black) and O₂- (red) saturated 0.1 M HClO₄ aqueous electrolyte. Data were recorded at 5 mV s⁻¹ and 2000 rpm rotation rate.

FIG. 25 depicts linear sweep voltammograms of various catalysts recorded in O₂-saturated 0.1 M NaOH at a rotation rate of 2000 rpm and a scan rate of 5 mV s⁻¹ (a) and Log(TOF) values derived from selected ORR polarization curves [shown in (a)] (b).

FIG. 26 depicts linear sweep voltammograms of glassy carbon disk electrodes modified with catalyst films containing Fe—N—C (black), (phen₂N₂)FeCl (blue), (OEP)FeCl (orange), (Pc)FeCl (aqua), Vulcan carbon (green), and (phen₂N₂)H₂ (red) in O₂-saturated 0.1 M HClO₄ electrolyte. Data were recorded at 5 mV s⁻¹ and 2000 rpm rotation rate.

FIG. 27 depicts electrocatalytic ORR performance metrics and metal loadings for (phen₂N₂)FeCl, (OEP)FeCl and Fe—N—C. ^{a}V vs RHE. ^{b}Defined as the potential corresponding to an ORR current density of 0.1 mV cm⁻².

FIG. 28 depicts comparison of ORR linear sweep voltammogram traces for (phen₂N₂)FeCl and (phen₂N₂)H₂ inks (a). Expansion of the onset region (b). The data were recorded at a rotation rate of 2000 rpm and a scan rate of 5 mV s⁻¹ in 0.1 M NaOH.

FIG. 29 depicts Log(TOF) for ORR vs potential (a) for (phen₂N₂)FeCl (blue), (OEP)FeCl (orange), and (Pc)FeCl (aqua). % H₂O₂ vs potential (b) for (phen₂N₂)FeCl (blue), (OEP)FeCl (orange), (Pc)FeCl (aqua), and Fe—N—C (black). All data were recorded in O₂-saturated 0.1 M HClO₄ electrolyte at 5 mV s⁻¹ and 2000 rpm rotation rate.

FIG. 30 depicts electroactive moles and turnover frequencies for (phen₂N₂)FeCl and (OEP)FeCl inks at select potentials.

FIG. 31 depicts RRDE plots of (phen₂N₂)FeCl (a), Fe—N—C (b), and (OEP)FeCl (c) in O₂-saturated 0.1 M HClO₄ aqueous electrolyte. All data were recorded at a rotation rate of 2000 rpm and 5 mV s⁻¹.

FIG. 32 depicts RRDE plots of (phen₂N₂)FeCl (a), Fe—N—C (b), and (OEP)FeCl (c) in O₂-saturated 0.1 M NaOH aqueous electrolyte. All data were recorded at a rotation rate of 2000 rpm and a scan rate of 5 mV s⁻¹.

FIG. 33 depicts % H₂O₂ produced during ORR catalysis as a function of potential in alkaline media. The traces are derived from RRDE data for (phen₂N₂)FeCl (blue), Fe—N—C (black) and (OEP)FeCl (orange) in 0.1 M NaOH aqueous electrolyte.

FIG. 34 depicts electrons transferred during ORR catalysis as a function of potential. The traces are derived from RRDE data for (phen₂N₂)FeCl (blue), Fe—N—C (black) and (OEP)FeCl (orange) in aqueous electrolyte, 0.1 M HClO₄ (a) and 0.1 M NaOH (b).

FIG. 35 depicts RRDE trace for (phen₂N₂)H₂ in 0.1 M NaOH. The inset shows an expansion of the ring current density (a). % H₂O₂ generated as a function of applied potential [derived from (a)] (b). Electrons transferred during ORR catalysis as a function of potential [derived from (a)] (c). Data were recorded at a rotation rate of 2000 rpm and a scan rate of 5 mV s⁻¹.

FIG. 36 depicts ORR linear sweep voltammogram traces for (phen₂N₂)FeCl (blue) and (phen₂N₂)H₂ (red) inks from FIG. 6 with [(phen₂N₂)Fe]₂O (black) in 0.1 M HClO₄ (a) and 0.1 M NaOH (b). The data were recorded at 2000 rpm rotation rate and a scan rate of 5 mV s⁻¹.

FIG. 37 depicts XPS survey spectra of (phen₂N₂)H₂ (top), (phen₂N₂)Fe]₂O (middle) and [(OEP)Fe]₂O (bottom) powders mixed with Au powder and pressed onto carbon tape. Red labels refer to elements present in the molecular formula of the analyte while blue labels denote other elements.

FIG. 38 depicts XPS survey spectra of (phen₂N₂)FeCl (top), Fe—N—C (middle) and (OEP)FeCl (bottom) powders mixed with Au powder and pressed onto carbon tape. Red labels refer to elements present in the molecular formula of the analyte while blue labels denote other elements.

FIG. 39 depicts XPS high resolution N is spectra of (phen₂N₂)Fe]₂O (a), (phen₂N₂)FeCl (b), [(OEP)Fe]₂O (c) and (OEP)FeCl (d) mixed with Au powder and pressed onto conductive carbon tape.

FIG. 40 depicts relative populations of iron environments in Fe—N—C derived from high-resolution XPS Fe 2p3/2 measurements.

FIG. 41 depicts XPS high resolution Fe 2p spectra of (phen₂N₂)Fe]₂O (top) and (phen₂N₂)FeCl (bottom) mixed with Au powder and pressed onto conductive carbon tape.

FIG. 42 depicts XPS high resolution Fe 2p spectra of [(OEP)Fe]₂O (top) and (OEP)FeCl (bottom) mixed with Au powder and pressed onto conductive carbon tape.

FIG. 43 depicts comparison the pre-edge features from iron K-edge XANES spectra of [(phen₂N₂)Fe]₂O (blue), Fe—N—C (black), [(OEP)Fe]₂O (orange) and [(Pc)Fe]₂O (aqua).

FIG. 44 depicts fits of EXAFS data for [(phen₂N₂)Fe]₂O (a), [(OEP)Fe]₂O (b), and Fe—N—C (c). Real and imaginary components are shown as black and red traces respectively with fits given as dashed blue traces.

FIG. 45 depicts computed structure of [(phen₂N₂)Fe(III)]⁺ visualized from the top and side.

FIG. 46 depicts linear sweep voltammograms of (phen₂N₂)FeCl (blue), Vulcan carbon (green) and FeCl₃/Vulcan (purple) inks polarized in O₂-saturated 0.1 M HClO₄ electrolyte. All data were recorded at a rotation rate of 2000 rpm at a scan rate of 5 mV s⁻¹.

FIG. 47 depicts pH dependence of the Fe(III/II) redox couple of (phen₂N₂)FeCl/Nafion/Vulcan ink in a modified aqueous Britton-Robinson buffer (50 mM each of NaHSO₄, Na₂HPO₄ and B(OH)₃). pH values were adjusted by adding concentrated aqueous HClO₄ and/or NaOH.

FIG. 48 depicts zero-field Mössbauer spectrum of [(OEP)Fe]₂O: (δ=0.41 mm s⁻¹, |ΔE_{Q}|=0.67 mm s⁻¹) recorded at 90 K.

FIG. 49 depicts zero-field Mössbauer spectrum of [(Pc)Fe]₂O: (δ=0.24 mm s⁻¹, |ΔE_{Q}|=1.26 mm s⁻¹) recorded at 90 K.

### DETAILED DESCRIPTION

### Overview

The four-electron, our-proton reduction of molecular oxygen to water is the efficiency-limiting half reaction in low temperature fuel cells. Regardless of the fuel source used, the current density output is primarily limited by the slow electron transfer kinetics of the oxygen reduction reaction (ORR) taking place at the cathode. The sluggish kinetics involved in this half reaction necessitate high catalyst loadings at the cathode to generate practical current densities. The prototypical material for catalyzing this reaction in commercial fuel cells is platinum metal (Pt) supported on carbon. However, the high cost and scarcity of Pt impedes the large-scale deployment of fuel cell devices and motivates the development of Earth-abundant electrocatalysts for oxygen reduction. These catalysts must operate at low overpotentials and with high selectivity for the four-electron reduction of oxygen to water instead of the two-electron reduction process to generate hydrogen peroxide. Since early reports of oxygen reduction catalyzed by macrocyclic first-row transition metal complexes, there has been a global effort to develop selective and efficient ORR catalysts featuring base metal active sites.

Pyrolyzed iron- and nitrogen-doped (Fe—N—C) materials are leading Earth-abundant alternatives to Pt-based ORR electrocatalysts, however significant increases in catalyst performance are needed to make these materials technologically viable. Systematic improvement of these materials is hampered by the limited molecular-level understanding or control of the iron active sites. Fe—N—C materials are typically prepared by the high temperature pyrolysis of finely dispersed iron salts, porphyrins, or phthalocyanines along with a metal-organic framework (MOF) or carbon-based support. The uncontrolled nature of pyrolysis leads to a wide diversity of iron environments as well as extended solid iron phases in the resulting Fe—N—C materials. This poor control, combined with the wide variability in preparative procedures, has led to longstanding uncertainty about the local structure of the iron active sites responsible for ORR, thereby impeding systematic improvements to catalytic performance.

Numerous recent studies have provided significant insight into possible active site structures on Fe—N—C materials. While metallic iron has been postulated as an active site, mononuclear Fe—N₄ active sites are more commonly invoked to explain correlations between X-ray absorption spectroscopy (XAS) or ⁵⁷Fe Mössbauer spectroscopy with ORR activity. Despite the growing consensus that Fe—N₄ sites are essential for ORR, the ligation environment of these iron sites remains uncertain. Indeed, even though iron porphyrin and phthalocyanine complexes can be used as precursors to Fe—N—C materials, there is growing appreciation that the core pyrrolic ligation environment of these precursors changes substantially upon pyrolysis. In particular, the first shell Fe—N bond lengths in Fe—N—C materials have been reported to be substantially shorter than the macrocyclic iron complex precursor used in the material synthesis. Furthermore, X-ray photoelectron spectroscopy (XPS) studies have pointed to the presence of metal-coordinated pyridinic nitrogen moieties as opposed to metal-bound pyrrolic nitrogens in Fe—N—C materials. ⁵⁷Fe Mössbauer spectra of many iron porphyrin and phthalocyanine complexes differ dramatically from main ⁵⁷Fe Mössbauer doublets assigned to the putative Fe—N₄ actives sites in Fe—N—C materials. In addition, atomic-resolution TEM data indicate the presence of mono-dispersed iron atoms bound within the plane of graphitic carbon suggesting that the ligating groups are 6-membered heterocycles rather than the 5-membered rings found in porphyrins and phthalocyanines. Based on these spectroscopic and imaging results, there is a growing body of evidence that the Fe—N₄ sites in Fe—N—C materials are ligated by pyridinic moieties fused within graphitic.

Despite substantial evidence for pyridinic:Fe—N₄ sites in Fe—N—C materials, nearly all molecular Fe-based ORR catalysts are macrocyclic complexes that feature pyrrolic coordination environments. Studies on homogeneous and adsorbed pyrrolic Fe complexes have shed significant insight into the mechanistic aspects of ORR including structure-function correlations and scaling relationships. However, the pyrrolic coordination environment of these molecular complexes makes them ineffective models for Fe—N—C materials, complicating spectroscopic assignments, and structure-activity correlations. Indeed, adsorbed pyrrolic Fe macrocycles generally display inferior activity and selectivity for ORR relative to Fe—N—C materials. Clearly, systematic progress in the understanding of Fe—N—C active sites and the rational design of improved catalysts requires new Fe—N₄ molecular complexes that can serve as high fidelity structural and functional mimics of Fe—N—C materials.

A better understanding of the catalytic active site can be developed via a bottom-up synthesis of molecular model complexes that mimic the spectroscopic features and catalytic ORR behavior of the pyrolyzed Fe—N—C catalyst. The D1 and D2 Mössbauer doublets believed to represent N₄Fe-sites are different from iron complexes of porphyrin (refs. 19,20) and phthalocyanine, suggesting a structural change during pyrolysis and motivating the investigation. Refs. 21,22.

Examples of pyridinic N₄ macrocyclic ligands exist in the literature. Notably, the aza-bridged bis-1,10-phenanthroline hexaazamacrocycle, (phen₂N₂)H₂ (phen₂N₂=1,14:7,8-diethenotetrapyrido[2,1,6-de:2′,1′,6′-gh:2″,1″,6″-kl:2′″,1′″,6′″-na][1,3,5,8,10,12]hexaazacyclotetradecine), as well as its cobalt(Il), nickel(II) and copper(II) complexes have been reported and applied to DNA binding studies and carbon dioxide reduction catalysis. The present disclosure is related to the synthesis and characterization of this pyridinic Fe—N₄ macrocyclic fragment and compare its ⁵⁷Fe Mössbauer, XPS, and XAS features and ORR performance to those of prototypical Fe—N—C, iron octaethylporphyrin, (OEP)Fe, and iron phthalocyanine, (Pc)Fe, catalysts. It was demonstrated that the iron coordination environment in [(phen₂N₂)Fe]₂O closely resembles that of Fe—N—C materials and that (phen₂N₂)FeCl displays superior catalytic activity and selectivity relative to (OEP)FeCl and (Pc)FeCl, closely approaching the performance metrics of Fe—N—C materials, These studies establish (phen₂N₂)Fe complexes as high-fidelity structural and functional mimics of Fe—N₄ active sites in Fe—N—C materials.

A tetrapyridinic coordination complex hearing an extended π system capable of increased metal-ligand backbonding interactions should provide an accurate model of the pyrolized Fe—N—C catalyst. The resulting complex should be quite Lewis acidic, which has been shown to stabilize a dicationic metal, likely with some ligand-based radical character. Consequently, such a tetrapyridinic complex should be reduced at more anodic potentials relative to typical iron macrocycle complexes, thereby enabling superior ORR performance analogous to Fe—N—C materials.

### Definitions

For convenience, before further description of the present invention, certain terms employed in the specification, examples and appended claims are collected here. These definitions should be read in light of the remainder of the disclosure and understood as by a person of skill in the art. Unless defined otherwise, all technical and scientific terms used herein have the same meaning as commonly understood by a person of ordinary skill in the art.

In order for the present invention to be more readily understood, certain terms and phrases are defined below and throughout the specification.

The articles “a” and “an” are used herein to refer to one or to more than one (i.e., to at least one) of the grammatical object of the article. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Structures depicted herein are also meant to include compounds that differ only in the presence of one or more isotopically enriched atoms. For example, compounds produced by the replacement of a hydrogen with deuterium or tritium, or of a carbon with a ¹³C- or ¹⁴C-enriched carbon are within the scope of this invention.

“Alkyl” refers to a fully saturated cyclic or acyclic, branched or unbranched carbon chain moiety having the number of carbon atoms specified, or up to 30 carbon atoms if no specification is made. For example, alkyl of 1 to 8 carbon atoms refers to moieties such as methyl, ethyl, propyl, butyl, pentyl, hexyl, heptyl, and octyl, and those moieties which are positional isomers of these moieties. Alkyl of 10 to 30 carbon atoms includes decyl, undecyl, dodecyl, tridecyl, tetradecyl, pentadecyl, hexadecyl, heptadecyl, octadecyl, nonadecyl, eicosyl, heneicosyl, docosyl, tricosyl and tetracosyl. In certain embodiments, a straight chain or branched chain alkyl has 30 or fewer carbon atoms in its backbone (e.g., C₁-C₃₀ for straight chains, C₃-C₃₀ for branched chains), and more preferably 20 or fewer. Alkyl groups may be substituted or unsubstituted.

As used herein, the term “alkylene” refers to an alkyl group having the specified number of carbons, for example from 2 to 12 carbon atoms, that contains two points of attachment to the rest of the compound on its longest carbon chain. Non-limiting examples of alkylene groups include methylene —(CH₂)—, ethylene —(CH₂CH₂)—, n-propylene —(CH₂CH₂CH₂)—, isopropylene —(CH₂CH(CH₃))—, and the like. Alkylene groups can be cyclic or acyclic, branched or unbranched carbon chain moiety, and may be optionally substituted with one or more substituents.

“Cycloalkyl” means mono- or bicyclic or bridged or spirocyclic, or polycyclic saturated carbocyclic rings, each having from 3 to 12 carbon atoms. Likewise, preferred cycloalkyls have from 3-10 carbon atoms in their ring structure, and more preferably have 3-6 carbons in the ring structure. Cycloalkyl groups may be substituted or unsubstituted.

Unless the number of carbons is otherwise specified, “lower alkyl,” as used herein, means an alkyl group, as defined above, but having from one to ten carbons, more preferably from one to six carbon atoms in its backbone structure such as methyl, ethyl, n-propyl, isopropyl, n-butyl, isobutyl, sec-butyl, and tert-butyl. Likewise, “lower alkenyl” and “lower alkynyl” have similar chain lengths. Throughout the application, preferred alkyl groups are lower alkyls. In certain embodiments, a substituent designated herein as alkyl is a lower alkyl.

“Alkenyl” refers to any cyclic or acyclic, branched or unbranched unsaturated carbon chain moiety having the number of carbon atoms specified, or up to 26 carbon atoms if no limitation on the number of carbon atoms is specified; and having one or more double bonds in the moiety. Alkenyl of 6 to 26 carbon atoms is exemplified by hexenyl, heptenyl, octenyl, nonenyl, decenyl, undecenyl, dodenyl, tridecenyl, tetradecenyl, pentadecenyl, hexadecenyl, heptadecenyl, octadecenyl, nonadecenyl, eicosenyl, heneicosoenyl, docosenyl, tricosenyl, and tetracosenyl, in their various isomeric forms, where the unsaturated bond(s) can be located anywhere in the moiety and can have either the (Z) or the (E) configuration about the double bond(s). Alkenyl groups may be substituted or unsubstituted.

“Alkynyl” refers to hydrocarbyl moieties of the scope of alkenyl, but having one or more triple bonds in the moiety.

The terms “alkoxyl” or “alkoxy” as used herein refers to an alkyl group, as defined below, having an oxygen moiety attached thereto. Representative alkoxyl groups include methoxy, ethoxy, propoxy, tert-butoxy, and the like. An “ether” is two hydrocarbons covalently linked by an oxygen. Accordingly, the substituent of an alkyl that renders that alkyl an ether is or resembles an alkoxyl, such as can be represented by one of —O-alkyl, —O-alkenyl, or —O-alkynyl.

The terms “amine” and “amino” are art-recognized and refer to both unsubstituted and substituted amines, e.g., a moiety that can be represented by the formulae:

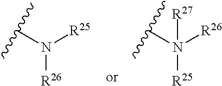

wherein R²⁵, R²⁶ and R²⁷ each independently represent a hydrogen, an alkyl, an alkenyl, an alkynyl, an aryl, a cycloalkyl, a cycloalkenyl, a heterocyclyl, or a polycyclyl.

The term “amide”, as used herein, refers to a group

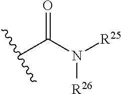

wherein R²⁵ and R²⁶ are as defined above.

The term “aryl” as used herein includes 3- to 12-membered substituted or unsubstituted single-ring aromatic groups in which each atom of the ring is carbon (i.e., carbocyclic aryl) or where one or more atoms are heteroatoms (i.e., heteroaryl). Preferably, aryl groups include 5- to 12-membered rings, more preferably 6- to 10-membered rings The term “aryl” also includes polycyclic ring systems having two or more cyclic rings in which two or more carbons are common to two adjoining rings wherein at least one of the rings is aromatic, e.g., the other cyclic rings can be cycloalkyls, cycloalkenyls, cycloalkynyls, aryls, heteroaryls, and/or heterocyclyls. Carboycyclic aryl groups include benzene, naphthalene, phenanthrene, phenol, aniline, and the like. Heteroaryl groups include substituted or unsubstituted aromatic 3- to 12-membered ring structures, more preferably 5- to 12-membered rings, more preferably 5- to 10-membered rings, whose ring structures include one to four heteroatoms. Heteroaryl groups include, for example, pyrrole, furan, thiophene, imidazole, oxazole, thiazole, triazole, pyrazole, pyridine, pyrazine, pyridazine and pyrimidine, and the like. Aryl and heteroaryl can be monocyclic, bicyclic, or polycyclic.

The term “halo”, “halide”, or “halogen” as used herein means halogen and includes, for example, and without being limited thereto, fluoro, chloro, bromo, iodo and the like, in both radioactive and non-radioactive forms. In one embodiment, halo is selected from the group consisting of fluoro, chloro and bromo.

The terms “heterocyclyl” or “heterocyclic group” refer to 3- to 12-membered ring structures, more preferably 5- to 12-membered rings, more preferably 5- to 10-membered rings, whose ring structures include one to four heteroatoms. Heterocycles can be monocyclic, bicyclic, spirocyclic, or polycyclic. Heterocyclyl groups include, for example, thiophene, thianthrene, furan, pyran, isobenzofuran, chromene, xanthene, phenoxathiin, pyrrole, imidazole, pyrazole, isothiazole, isoxazole, pyridine, pyrazine, pyrimidine, pyridazine, indolizine, isoindole, indole, indazole, purine, quinolizine, isoquinoline, quinoline, phthalazine, naphthyridine, quinoxaline, quinazoline, cinnoline, pteridine, carbazole, carboline, phenanthridine, acridine, pyrimidine, phenanthroline, phenazine, phenarsazine, phenothiazine, furazan, phenoxazine, pyrrolidine, oxolane, thiolane, oxazole, piperidine, piperazine, morpholine, lactones, lactams such as azetidinones and pyrrolidinones, sultams, sultones, and the like. The heterocyclic ring can be substituted at one or more positions with such substituents as described above, as for example, halogen, alkyl, aralkyl, alkenyl, alkynyl, cycloalkyl, hydroxyl, amino, nitro, sulfhydryl, imino, amido, phosphate, phosphonate, phosphinate, carbonyl, carboxyl, silyl, sulfamoyl, sulfinyl, ether, alkylthio, sulfonyl, ketone, aldehyde, ester, a heterocyclyl, an aromatic or heteroaromatic moiety, —CF₃, —CN, and the like.

As used herein, the term “nitro” means —NO₂; the term “halogen” designates —F, —Cl, —Br, or —I; the term “sulfhydryl” means —SH; the term “hydroxyl” means —OH; the term “sulfonyl” means —SO₂—; the term “azido” means N₃; the term “cyano” means CN; the term “isocyanato” means —NCO; the term “thiocyanato” means —SCN; the term “isothiocyanato” means —NCS; and the term “cyanato” means —OCN.

The term “carbonyl” is art-recognized and includes such moieties as can be represented by the general formula:

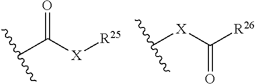

wherein X is a bond or represents an oxygen or a sulfur, and R²⁵ and R²⁶ are as defined above. Where X is an oxygen and R²⁵ or R²⁶ is not hydrogen, the formula represents an “ester”. Where X is an oxygen, and R²⁵ is as defined above, the moiety is referred to herein as a carboxyl group, and particularly when R²⁵ is a hydrogen, the formula represents a “carboxylic acid”. Where X is an oxygen, and R²⁶ is hydrogen, the formula represents a “formate”. In general, where the oxygen atom of the above formula is replaced by sulfur, the formula represents a “thiocarbonyl” group. Where X is a sulfur and R²⁵ or R²⁶ is not hydrogen, the formula represents a “thioester” group. Where X is a sulfur and R²⁵ is hydrogen, the formula represents a “thiocarboxylic acid” group. Where X is a sulfur and R²⁶ is hydrogen, the formula represents a “thioformate” group. On the other hand, where X is a bond, and R²⁵ is not hydrogen, the above formula represents a “ketone” group. Where X is a bond, and R²⁵ is hydrogen, the above formula represents an “aldehyde” group.

The term “sulfonylamide” is art-recognized and includes a moiety that can be represented by the formula:

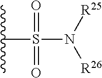

in which R²⁵ and R²⁶ are as defined above.

The term “sulfate” is art recognized and includes a moiety that can be represented by the formula:

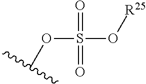

in which R²⁵ is as defined above.

The term “sulfonamide” is art recognized and includes a moiety that can be represented by the formula:

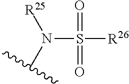

in which R²⁵ and R²⁶ are as defined above.

The term “sulfonate” is art-recognized and includes a moiety that can be represented by the formula:

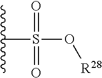

in which R²⁸ is an electron pair, hydrogen, alkyl, cycloalkyl, or aryl.

The terms “sulfoxido” or “sulfinyl”, as used herein, refers to a moiety that can be represented by the formula:

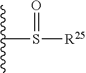

in which R²⁵ is as defined above.

As used herein, the definition of each expression, e.g., alkyl, m, n, etc., when it occurs more than once in any structure, is intended to be independent of its definition elsewhere in the same structure.

The term “substituted” refers to moieties having substituents replacing a hydrogen on one or more carbons of the backbone. It will be understood that “substitution” or “substituted with” includes the implicit proviso that such substitution is in accordance with permitted valence of the substituted atom and the substituent, and that the substitution results in a stable compound, e.g., which does not spontaneously undergo transformation such as by rearrangement, cyclization, elimination, etc. As used herein, the term “substituted” is contemplated to include all permissible substituents of organic compounds. In a broad aspect, the permissible substituents include acyclic and cyclic, branched and unbranched, carbocyclic and heterocyclic, aromatic and non-aromatic substituents of organic compounds. The permissible substituents can be one or more and the same or different for appropriate organic compounds. For purposes of this invention, the heteroatoms such as nitrogen may have hydrogen substituents and/or any permissible substituents of organic compounds described herein which satisfy the valences of the heteroatoms. Substituents can include any substituents described herein, for example, a halogen, a hydroxyl, a carbonyl (such as a carboxyl, an alkoxycarbonyl, a formyl, or an acyl), a thiocarbonyl (such as a thioester, a thioacetate, or a thioformate), an alkoxy, a phosphoryl, a phosphate, a phosphonate, a phosphinate, an amino, an amido, an amidine, an imine, a cyano, a nitro, an azido, a sulfhydryl, an alkylthio, a sulfate, a sulfonate, a sulfamoyl, a sulfonamido, a sulfonyl, a heterocyclyl, an aralkyl, or an aromatic or heteroaromatic moiety. In certain embodiments, the substituents on substituted alkyls are selected from C₁₋₆ alkyl, C₃₋₆ cycloalkyl, halogen, carbonyl, cyano, or hydroxyl. In other embodiments, the substituents on substituted alkyls are selected from fluoro, carbonyl, cyano, or hydroxyl. It will be understood by those skilled in the art that substituents can themselves be substituted, if appropriate. Unless specifically stated as “unsubstituted,” references to chemical moieties herein are understood to include substituted variants. For example, reference to an “aryl” group or moiety implicitly includes both substituted and unsubstituted variants.

For purposes of this invention, the chemical elements are identified in accordance with the Periodic Table of the Elements, CAS version, Handbook of Chemistry and Physics, 67th Ed., 1986-87, inside cover.

### Compound Synthesis and Characterization

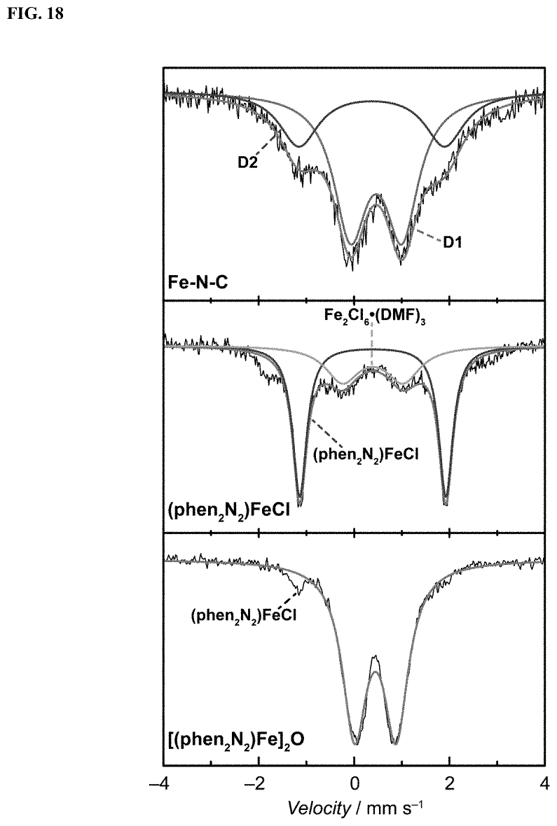

A prototypical Fe—N—C material was synthesized by a combination of literature methods. Briefly, Fe—N—C was prepared by pyrolysis of a mixture of iron(II) acetate, 1,10-phenanthroline and ZIF-8 metal organic framework under a reducing atmosphere (5% H₂ in Ar). After pyrolysis, the sample was washed with 0.1 M H₂SO₄ to remove trace Fe(0). The ⁵⁷Fe Mössbauer spectrum of this material (FIG. 18, top) displays two quadrupole doublets. The narrow doublet, commonly referred to as the D1 doublet, displays an isomer shift (δ) of 0.46 mm s⁻¹ and a quadrupole splitting (|ΔE_{Q}|) of 1.08 mm s⁻¹ and the wide doublet, commonly referred to as the D2 doublet, is characterized by δ=0.37 mm s⁻¹ and |ΔE_{Q}|=3.06 mm s⁻¹. These parameters are in line with previously reported Fe—N—C materials. These features were recently postulated to arise from Fe—N₄ sites existing in high-spin Fe(III) and low-spin Fe(II) states, respectively, although other assignments have been made previously, including D1 as a low spin Fe(II) site and D2 as an intermediate spin Fe(II) site.

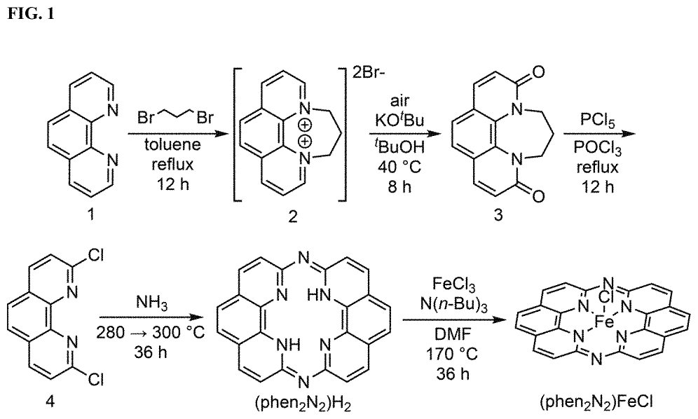

The iron macrocyclic complex, (phen₂N₂)FeCl, can be obtained in five steps (FIG. 1). This scalable synthetic procedure has been optimized to furnish (phen₂N₂)FeCl in high yield, allowing large quantities of material to be produced, in contrast to many iron porphyrin complexes. (Phen₂N₂)FeCl and all synthetic intermediates are stable upon exposure to dioxygen and water and can be easily handled without special precautions.

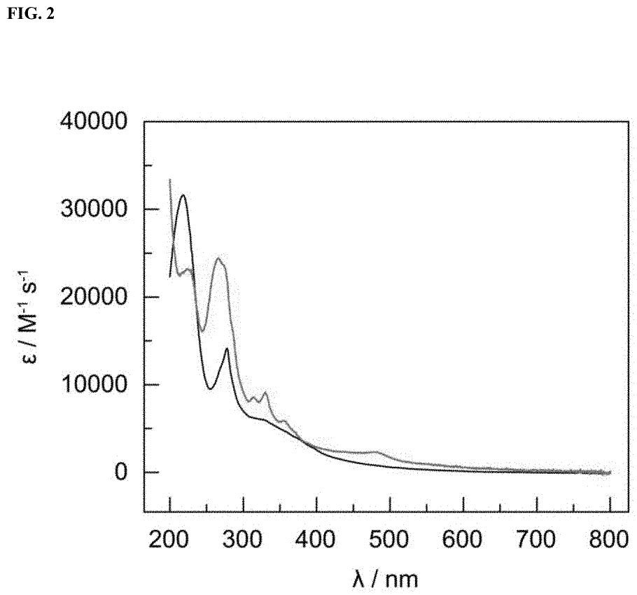

The optical spectrum of (phen₂N₂)FeCl in MeCN (FIG. 2) is dominated by peaks centered at 223 and 266 nm in the UV region. These are π→π* transitions with some metallic character. A series of low-intensity transitions in the low-UV and visible regions are due to lower-energy it-type transitions that have some Fe—Cl σ* or π* character. No absorptions are observed in the near IR region. Some reported tetraaza[14]annulene iron(III) chloride complexes give qualitatively similar spectra, albeit with a hypsochromic shift and increase in the complexity of the mid-spectrum peaks, presumably due to increased opportunities for ligand-based π* transitions.

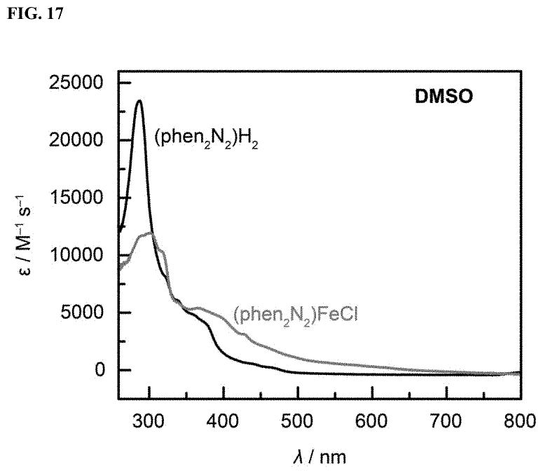

UV-Vis data of (phen₂N₂)FeCl in DMSO (FIG. 17) also support formation of the metalated complex with a bathochromic shift of the ligand π→π* transitions and the appearance of shoulders on the main π→π* peak. Additionally, the ligand peaks at 360 at 376 nm broaden and increase substantially in intensity relative to the main π→π* peak upon metalation. A new peak appears at 429 nm, while the broad, low-intensity ligand peaks at 439 and 467 nm vanish. The resulting spectrum upon metalation is similar to spectra of tetraaza[14]annulene iron(III) chloride complexes in DMSO.

The ⁵⁷Fe Mössbauer spectrum of (phen₂N₂)FeCl (FIG. 18, middle) reveals a major quadrupole doublet assigned to (phen₂N₂)FeCl and a minor doublet assigned to residual Fe₂Cl₆·(DMF)₃. The major quadrupole doublet for (phen₂N₂)FeCl is described by δ=0.39 mm s⁻¹ and |ΔE_{Q}|=3.06 mm s⁻¹. These parameters are dramatically different from those of (OEP)FeCl which displays an δ of 0.30 mm s⁻¹ and a |ΔE_{Q}| of 0.60 mm s⁻¹. Additionally, they also differ from those of (Pc)FeCl which is characterized by an δ of 0.28 mm s⁻¹ and a |ΔE_{Q}| of 2.95 mm s⁻¹. The particularly large |ΔE_{Q}| observed for (phen₂N₂)FeCl suggests that the iron center exists in an S=3/2 intermediate spin state or an S=3/2, 5/2 admixture spin state as has been observed for other iron(III) N₄ macrocycles complexes. This assignment is consistent with our calculations on (phen₂N₂)FeCl, which predict an intermediate-spin ground state. This electronic structure is consistent with a compressed N₄-binding pocket (see below) that stabilizes the S=3/2 spin state. Although the ⁵⁷Fe Mössbauer parameters for (phen₂N₂)FeCl are similar to those of the D2 doublet in Fe—N—C, we caution against overinterpreting this similarity because ⁵⁷Fe Mössbauer spectra are highly sensitive to axial ligation (see below) and the axial Cl in (phen₂N₂)FeCl is distinct from the putative OHₓ ligand present in Fe—N—C materials.

To better mimic the axial O-ligation present in the material, (phen₂N₂)FeCl was subjected to Soxhlet extraction with ethanol. This served to remove some residual iron salts and generate the μ-oxo [(phen₂N₂)Fe]₂O via reaction with adventitious water and base. Similar conversions are well-documented for sterically unprotected porphyrin complexes. While this species is catalytically inactive in acidic electrolyte, it provides a good spectroscopic model for Fe—N—C materials and the analogous [(OEP)Fe]₂O, and [(Pc)Fe]₂O were synthesized by literature methods for comparison.

The ⁵⁷Fe Mössbauer spectrum of the [(phen₂N₂)Fe]₂O complex is a doublet (FIG. 18, bottom), described by δ=0.45 mm s⁻¹ and |ΔE_{Q}|=0.87 mm s⁻¹. Our sample of [(OEP)Fe]₂O displays ⁵⁷Fe Mössbauer parameters of δ=0.41 mm s⁻¹ and |ΔE_{Q}|=0.67 mm s⁻¹. Likewise, our sample of [(Pc)Fe]₂O displays ⁵⁷Fe Mössbauer parameters of δ=0.25 mm s⁻¹ and |ΔE_{Q}|=1.26 mm s⁻¹. Notably, the ⁵⁷Fe Mössbauer parameters for both [(OEP)Fe]₂O, and [(phen₂N₂)Fe]₂O as well as other μ-oxo compounds are within the range of values reported for the D1 doublet in Fe—N—C materials. The δ and |ΔE_{Q}| values which characterize [(Pc)Fe]₂O are outside the typical values for the D1 doublet, however some reported values for Fe—N—C derived from pyrolyzed iron porphyrins are close. The vast differences in the ⁵⁷Fe Mössbauer spectra of (phen₂N₂)Fe, (OEP)Fe, and (Pc)Fe upon exchange of the axial ligand suggest that ⁵⁷Fe Mössbauer spectroscopy alone may be insufficient to distinguish pyrrolic from pyridinic ligation at putative Fe—N₄ sites in Fe—N—C materials.

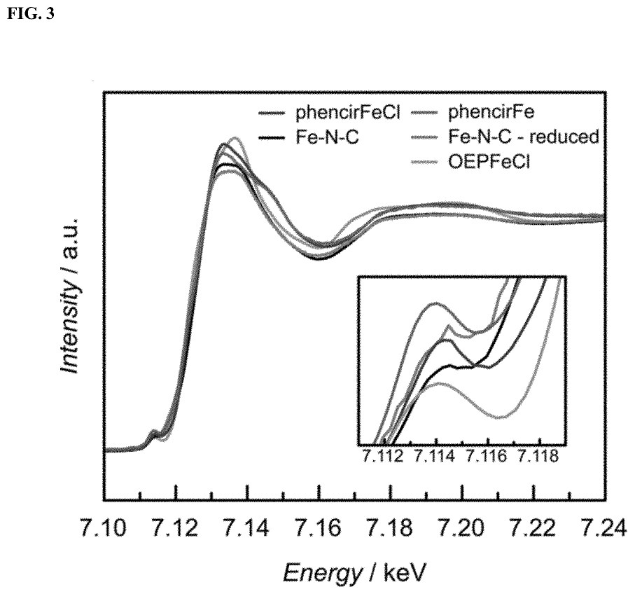

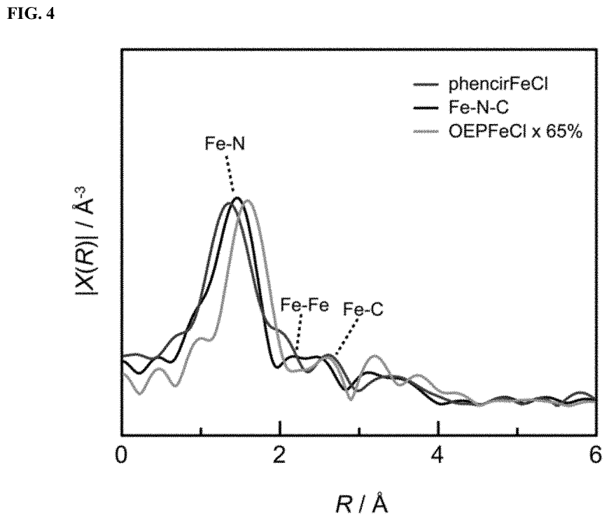

The near-edge feature in the X-ray absorption spectrum (XAS) of (phen₂N₂)FeCl is consistent with a symmetric complex bearing a two-fold rotational axis and is similar in position to OEPFeCl. The pre-edge feature located at 7114.3 eV is quantitatively similar to that given by a pyrolyzed Fe—N—C sample synthesized by a combination of published methods^{8,25} with slight alterations (FIG. 3). Structural parameters derived from the k²-weighted Fourier transform of the iron k-edge EXAFS data (FIG. 4) as well as the similar shape of the XANES spectrum for both (phen₂N₂)FeCl and Fe—N—C indicate analogous coordination environments (Table 1).

TABLE 1
Iron k-edge Fourier transform fitting parameters.

| | | | | | | Pre-edge | XANES |
|---|---|---|---|---|---|---|---|
| | Scattering | | R | Δσ² | ΔEₒ | energy | energy |
| Sample | Path | CN | (Å) | (Å²) | (eV) | (keV) | (keV) |
| (phen₂N₂)FeCl | Fe—N | 4.3 | 1.93 | 0.005 | −1.5 | 7.1143 | 7.1223 |
| | Fe—Cl | 1.0 | 2.33 | 0.004 | | | |
| | Fe—O | 0.7 | 1.99 | 0.001 | | | |
| (phen₂N₂)Fe | Fe—N | 4.0 | 1.94 | 0.005 | −1.0 | 7.1137 | 7.1222 |
| | Fe—Cl | 0.7 | 2.35 | 0.004 | | | |
| Fe—N—C | Fe—N | 4.0 | 1.94 | 0.005 | −5.5 | 7.1142 | 7.1257 |
| | Fe—O | 1.7 | 2.04 | 0.001 | | | |
| Fe—N—C | Fe—N | 4.0 | 1.99 | 0.005 | −4.5 | 7.1142 | 7.1240 |
| (reduced) | | | | | | | |

These results strongly suggest a structural resemblance between the iron atoms in Fe—N—C and (phen₂N₂)FeCl with Fe—N vectors of 1.94 and 1.93 Å, respectively.

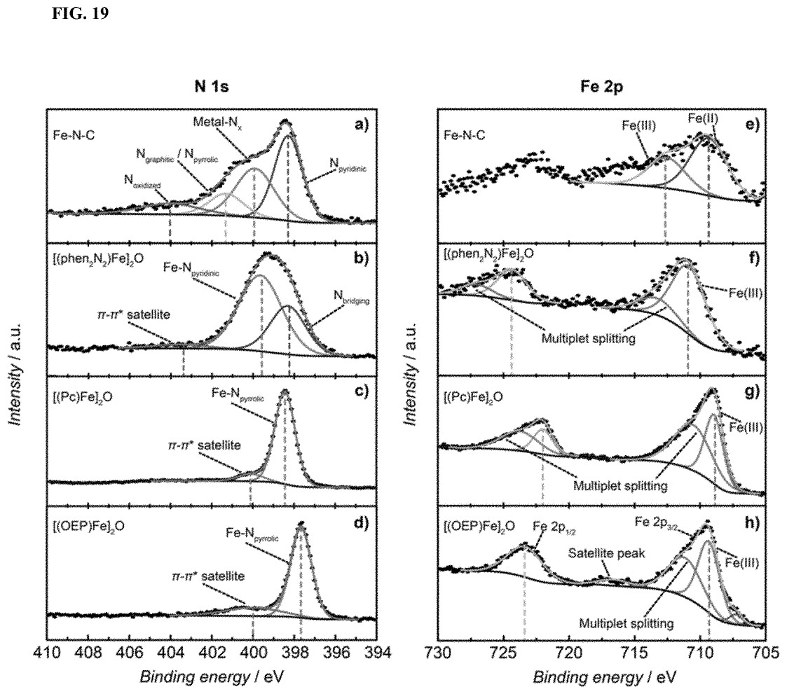

The nitrogen environments present in Fe—N—C, [(phen₂N₂)Fe]₂O, (phen₂N₂)H₂, [(OEP)Fe]₂O, and [(Pc)Fe]₂O were analyzed by X-ray photoelectron spectroscopy (XPS). For Fe—N—C, we observed a broad N is XPS signal similar to that reported for other Fe—N—C materials (FIG. 19, a). The N peak envelope for Fe—N—C spans from 396 to 407 eV and can be deconvoluted into four peaks, previously assigned to oxidized (404.0 eV), graphitic/pyrrolic (401.3 eV), metal-coordinated (399.9 eV) and pyridinic nitrogen (398.3 eV). This sample was prepared by pyrolysis of a zinc imidazolate MOF, ZIF-8, therefore the metal-coordinated N peak is expected to result from both iron and zinc coordination. Literature reports suggest that the binding energy of the coordinated N peak is largely insensitive to metal identity.

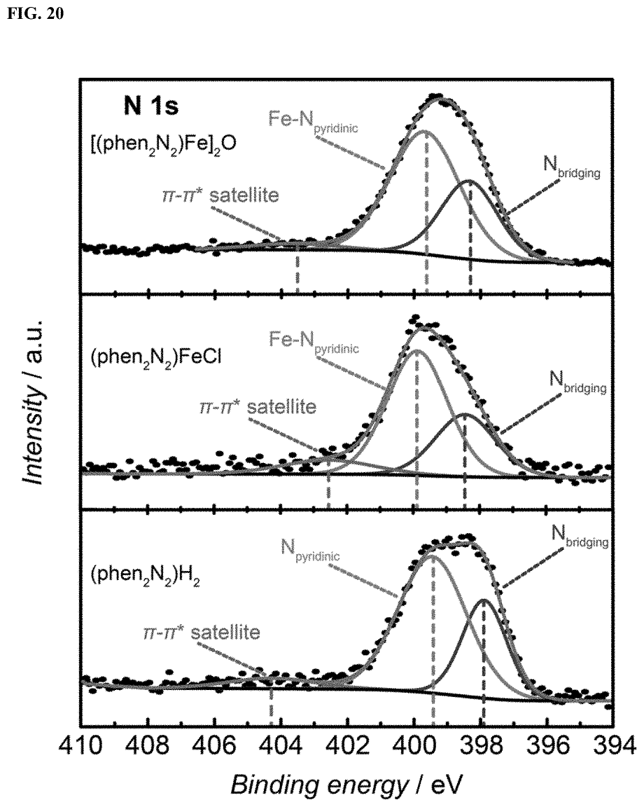

The very broad peak envelope for Fe—N—C contrasts with the well-defined nitrogen environments in [(OEP)Fe]₂O, [(Pc)Fe]₂O, and [(phen₂N₂)Fe]₂O. For [(phen₂N₂)Fe]₂O, high resolution N is spectra (FIG. 19, b) reveal a single broad peak centered at 399.3 eV that can be deconvoluted into two components centered at 398.3 and 399.6 eV with a peak integration ratio of 1:2. Based on the integration ratio and the symmetry of the (phen₂N₂)Fe subunits in [(phen₂N₂)Fe]₂O, we assign the 398.3 peak to the to the bridgehead nitrogen atoms and the 399.6 peak to the coordinated pyridine nitrogen atoms. In comparison, the N is XPS spectrum (FIG. 20, bottom) of (phen₂N₂)H₂ is dominated by two peaks corresponding to bridging and pyridinic nitrogen atoms at 397.9 and 399.4 eV, respectively in a 1:2 ratio. This indicates that both bridging and pyridinic nitrogen atoms shift to higher binding energies upon metalation with iron. Similar changes in the N 1s spectrum have been reported for free-base porphyrins upon metalation. In contrast, the XPS N is spectra of [(OEP)Fe]₂O and [(Pc)Fe]₂O differ markedly from that of [(phen₂N₂)Fe]₂O. The spectrum of [(OEP)Fe]₂O consists of a sharp peak at 397.6 eV with a broad satellite peak centered at 400.0 eV (FIG. 19, c). The spectrum of [(Pc)Fe]₂O is similar with a sharp peak at 398.4 eV with a satellite peak centered at 400.1 eV (FIG. 19, d). N is peaks for (phen₂N₂)FeCl, (OEP)FeCl, (Pc)FeCl appear within 0.3-0.4 eV of the corresponding peaks for the μ-oxo compounds, indicating that the identity of the axial ligand does not impact the N 1s binding energy to the same extent as does changing the nature of the metal-coordinated nitrogen atoms from pyrrolic to pyridinic. Importantly, the N is peaks for the coordinated pyridinic nitrogen atoms in the (phen₂N₂)Fe complexes match well with the peak corresponding to the metal-coordinated pyridinic nitrogen component (399.9 eV) of Fe—N—C, whereas the N is peaks of the coordinated pyrrolic nitrogen atoms in (OEP)Fe and (Pc)Fe complexes appear at significantly lower binding energies. Together, the XPS data indicate that the iron-coordinated N environment in [(phen₂N₂)Fe] species are electronically very similar to the metal-coordinated N environments in Fe—N—C materials.

The iron environments present in Fe—N—C, [(phen₂N₂)Fe]₂O, [(OEP)Fe]₂O, and [(Pc)Fe]₂O were also examined by XPS. Consistent with previously reported data of Fe—N—C materials, we observe Fe 2p_{3/2} peaks at 709.8 and 713.5 eV (FIG. 19, e) assigned to Fe(II) and Fe(III) formal oxidation states, respectively. In contrast, [(OEP)Fe]₂O (FIG. 19, g) displays Fe 2p_{3/2} and 2p_{1/2} peaks at 709.3 and 723.3 eV, respectively. Similarly, [(Pc)Fe]₂O (FIG. 19, h) exhibits Fe 2p_{3/2} and 2p_{1/2} peaks at 708.9 and 722.0 eV, respectively. Significant asymmetry on the main Fe 2p_{3/2} peak for both [(OEP)Fe]₂O and [(Pc)Fe]₂O compounds was observed. The asymmetry is attributed to multiplet splitting and is thought to arise from core-hole interactions with the open-shell electronic structure of the high-spin ferric centers. Similar features are observed for (OEP)FeCl and (Pc)FeCl, albeit with a ˜0.7-0.9 eV shift to higher binding energy. These XPS features are distinct from those observed for [(phen₂N₂)Fe]₂O (FIG. 19, f) which displays Fe 2p_{3/2} and 2p_{1/2} peaks at 710.8 and 724.3 eV. We note that (phen₂N₂)FeCl shows Fe 2p_{3/2} and 2p_{1/2} peaks at similar binding energies, 710.8 and 724.7 eV, respectively, and that residual FeCl₃ salts are likely to be subsumed into these peaks. As with [(OEP)Fe]₂O and [(Pc)Fe]₂O, we also observe significant asymmetry in the Fe 2p_{3/2} peak of [(phen₂N₂)Fe]₂O that we also attribute to core-hole interactions with an open-shell ferric center. There is also some asymmetry to the Fe 2p_{1/2} peak which likely originates from the same effect. Importantly, we observe a >1.5 eV shift to higher binding energy for the main Fe 2p_{3/2} peak for [(phen₂N₂)Fe]₂O relative to both [(OEP)Fe]₂O and [(Pc)Fe]₂O. This observation is consistent with increased π-acidity of the pyridinic macrocycle in [(phen₂N₂)Fe]₂O, which withdraws electron density from the iron center. Notably, the peak in Fe—N—C previously assigned to Fe(III) is 2.7 eV positive of the corresponding Fe(III) peak for [(phen₂N₂)Fe]₂O but even more positive than the same peak in [(OEP)Fe]₂O and [(Pc)Fe]₂O. These data suggest that while the Fe(III) centers in Fe—N—C may exist in an even more withdrawing ligation environment, a pyridinic macrocycle complex such as [(phen₂N₂)Fe]₂O provides a better structural model for Fe—N—C than pyrrolic macrocycles such as [(OEP)Fe]₂O and [(Pc)Fe]₂O. Indeed, the strongly electron withdrawing environment in the material helps to explain the positive shift of the putative Fe(II) component of Fe—N—C, which makes it appear close in energy to the main Fe 2p_{3/2} peaks for both of the Fe(III) complexes examined here. Taken as a whole, the XPS data are consistent with nitrogen and iron environments in [(phen₂N₂)Fe]₂O that are more electropositive than a typical pyrrolic macrocycle and more similar to the metal-NX sites in Fe—N—C.

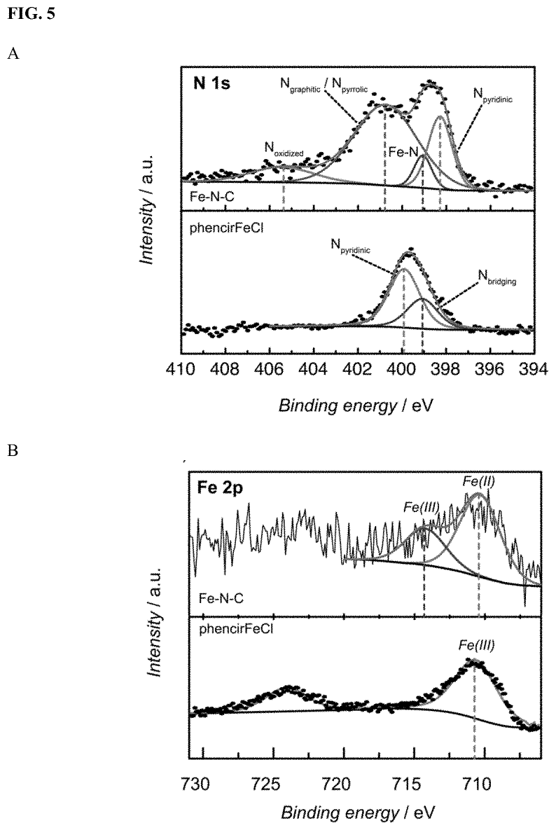

XPS results (FIG. 5.) for (phen₂N₂)FeCl are consistent with a complex with a N:Cl:Fe ratio of 6:1:1 (Table 2) and indicate substantial electronic changes as a result of metal coordination to the dianionic species, (phen₂N₂)²⁻.

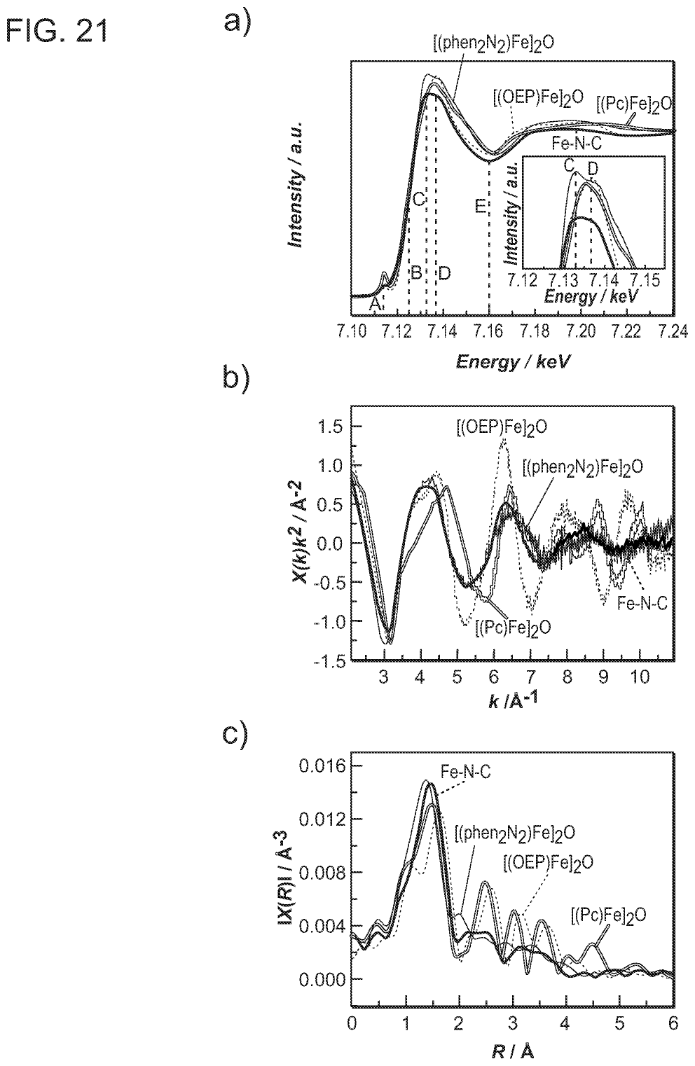

XAS results demonstrate a strong resemblance between Fe—N—C and [(phen₂N₂)Fe]₂O. We next examined the electronic structure and coordination environment of the iron centers in Fe—N—C, [(phen₂N₂)Fe]₂O, [(OEP)Fe]₂O, and [(Pc)Fe]₂O by X-ray absorption spectroscopy (XAS). The XANES spectrum of our Fe—N—C preparation (FIG. 21, a, black) matches those reported in the literature. While a rigorous analysis of the X-ray absorption near edge structure (XANES) spectra for Fe—N—C materials is challenging due to the presumed presence of a mixture of Fe(II) and Fe(III) as well as an unknown degree of heterogeneity in the local coordination environment of each iron, the XANES line shapes have been exhaustively examined for a wide variety of pyrolyzed Fe—N—C catalysts and features of the XANES have been correlated to ORR activity. In particular, the intensity of the first main edge peak, C, has been found to positively correlate with ORR activity, whereas the intensities of the main edge shoulder, B, and the higher energy main edge peak, D, have been shown to anticorrelate with ORR activity (FIG. 21, a, dotted vertical lines). Notably, the XANES spectra of [(OEP)Fe]₂O (FIG. 21, a, orange) and [(Pc)Fe]₂O shows enhanced intensity for D with [(OEP)Fe]₂O also showing enhanced intensity for B. These features contrast the XANES spectra of [(phen₂N₂)Fe]₂O (FIG. 21, a, blue), which shows a higher intensity for C, and lower intensities for B and D. The intensity of pre-edge peak, A, has also been shown to positively correlate with ORR activity. We find that the pre-edge peak line shape for [(phen₂N₂)Fe]₂O matches closely with that of Fe—N—C, but that the peak intensity for both is lower than that for [(OEP)Fe]₂O and dramatically lower than the sharp pre-edge feature observed for [(Pc)Fe]₂O. Given the high sensitivity of the pre-edge peak to the identity of the axial ligand in similar tetrapyrrolic complexes as well as distortions in the Fe—N₄ plane made possible by variation of the Fe—O—Fe angle in [(OEP)Fe]₂O and [(Pc)Fe]₂O, we refrain from overinterpreting the pre-edge peak shapes or intensity. Nonetheless, the suppressed intensity at B and D and increased intensity at C for [(phen₂N₂)Fe]₂O suggests that the (phen₂N₂)Fe molecular analogue is a superior model for the active sites in Fe—N—C materials relative to pyrrolic macrocycles.

Extended X-ray absorption fine structure (EXAFS) data provide further evidence in support of the structural similarity between the iron coordination environments in [(phen₂N₂)Fe]₂O and Fe—N—C. The k²-weighted EXAFS oscillations for Fe—N—C (FIG. 21, b, black) exhibit remarkably similar amplitudes and periods to the EXAFS of [(phen₂N₂)Fe]₂O (FIG. 21, b, blue) out to ˜10.0 Å⁻¹ with only a small phase shift beyond ˜6.0 Å⁻¹. In contrast, the k²-weighted EXAFS for [(OEP)Fe]₂O (FIG. 21, b, orange) and [(Pc)Fe]₂O (FIG. 21, b, aqua) displays amplitudes and periods that differ dramatically from the EXAFS of [(phen₂N₂)Fe]₂O and Fe—N—C beyond ˜3.5 Å⁻¹.

The similarity between Fe—N—C and [(phen₂N₂)Fe]₂O is also reflected in the k²-weighted Fourier transform EXAFS radial distribution spectra (FIG. 21, c). The [(phen₂N₂)Fe]₂O complex displays a broad primary coordination shell scattering peak at 1.36 A apparent distance, similar to the first shell peak for Fe—N—C at 1.46 A apparent distance. In contrast, the first shell scattering peak for [(OEP)Fe]₂O and [(Pc)Fe]₂O appears at 1.62 Å and 1.47 Å apparent distance and display prominent shoulders at lower apparent distances that are not observed in Fe—N—C or [(phen₂N₂)Fe]₂O. Likewise, both [(phen₂N₂)Fe]₂O and Fe—N—C have no prominent scattering interactions beyond 2 Å, whereas significant higher order scattering is observed for [(OEP)Fe]₂O, and [(Pc)Fe]₂O. Taking together, the raw EXAFS data for Fe—N—C mostly matches by the spectrum of [(phen₂N₂)Fe]₂O and is quite distinct from that of either [(OEP)Fe]₂O or [(Pc)Fe]₂O.

The EXAFS peaks for all four materials are well modeled with a five-coordinate Fe center bearing four equatorial Fe—N scatterers and one axial Fe—O scatterer. The fits from modeling the data return Fe—N scattering paths of 1.94, 1.97, 2.06, and 1.94 A for Fe—N—C, [(phen₂N₂)Fe]₂O, [(OEP)Fe]₂O, and [(Pc)Fe]₂O, respectively. The Fe—N distances for both [(OEP)Fe]₂O and [(Pc)Fe]₂O agree with the corresponding distances extracted from crystal structures. Importantly, these Fe—N bond lengths reflect not only the N—N separation in the ligand, but also the degree of pucker of the Fe center out of the equatorial plane. Thus, this distance alone cannot distinguish pyridinic from pyrrolic ligation and, indeed, we see similar Fe—N vectors for [(phen₂N₂)Fe]₂O and [(Pc)Fe]₂O. Furthermore, for [(phen₂N₂)Fe]₂O, the 1.97 Å Fe—N distance extracted from EXAFS modeling is substantially higher than the 1.86 Å distance predicted from calculation if the Fe were to reside in the N₄ plane for the phen₂N₂ ligand, further evincing that the Fe center is puckered. This reasoning is also in line with a computational XAS study that showed an enhancement of the main edge peak C (FIG. 21, a, blue) as the displacement of Fe from the N₄ plane was increased.³³ Consistent with the Fe—N—C material having a putative OHₓ axial ligand, the EXAFS fits return an Fe—O scattering path of 2.04 Å, slightly larger than the range of Fe—O scattering paths, 1.79-1.73 Å, extracted for the molecular μ-oxo complexes. Taking both the raw k²-weighted EXAFS oscillations and the Fourier transform EXAFS spectra into account, the XAS data highlight that [(phen₂N₂)Fe]₂O is a particularly good model of the Fe sites in Fe—N—C catalysts.

TABLE 2
C—, N—, O—, Fe— and Cl-content for (phen₂N₂)FeCl and
Fe—N—C derived from XPS measurements.

| Sample | at % C | at % N | at % O | at % Fe | at % Cl |
|---|---|---|---|---|---|
| (phen₂N₂)FeCl | 64.80 | 9.45 | 10.66 | 1.28 | 1.87 |
| Fe—N—C | 85.07 | 5.58 | 8.42 | 0.13 | — |

N 1s and N 2p XPS data for (phen₂N₂)H₂, and its cobalt, nickel and copper complexes have been reported.²⁶ In comparison, the N is peak of (phen₂N₂)FeCl is shifted to higher binding energy (399.7 eV) and can be modeled as two components centered at 399.1 and 399.9 eV with an area ratio of 1:2 (FIG. 5, A). The two peaks reported for (phen₂N₂)H₂ coalesce as the four pyridinic nitrogen atoms move following iron coordination. Similar alterations in the N 1s spectrum have been reported for different free-base porphyrins upon metallation.²⁷ The iron environment of (phen₂N₂)FeCl (FIG. 5, B) is consistent with other Fe(III) macrocyclic complexes²⁸ and characterized by Fe 2p_{1/2} and Fe 2p_{3/2} peaks located at 724.1 and 710.6 eV, respectively.

By comparison, Fe—N—C shows a broadened N1s peak which can be deconvoluted into four peaks, consistent with oxidized (405.5 eV), graphitic/pyrrolic (400.8 eV), Fe—N (399.1 eV) and pyridinic nitrogen (398.3 eV) (FIG. 5, A, top; Table 3).²⁹

TABLE 3
Relative populations of nitrogen environments in
Fe—N—C derived from high-resolution XPS N 1s measurements.

| | % | % | % | % |
|---|---|---|---|---|
| | Pyridinic N | M-N | Pyrrolic/Graphitic N | Oxidized N |
| Fe—N—C | 42.01 | 33.19 | 13.44 | 11.34 |

Overlap with the (phen₂N₂)FeCl N 1s peak is consistent with the metal-coordinated pyridinic nitrogen component (399.1 eV) evident upon deconvolution. There is overlap between Fe 2p_{3/2} peaks for (phen₂N₂)FeCl and Fe—N—C, but a notable shift is evident between the position of the iron(III) component in each sample. This is attributed to the highly Lewis acidic environment surrounding in-plane surface-confined iron atoms (FIG. 5, B). Little Fe(0) is observed, consistent with the FT-EXAFS data, and a mixture of Fe(III) and Fe(II) is clearly indicated (Table 4), consistent with the XANES results.

TABLE 4
Relative populations of iron environments in Fe—N—C
derived from high-resolution XPS Fe 2p measurements.

| | % Fe(II) | % Fe(III) |
|---|---|---|
| Fe—N—C | 35.40 | 64.60 |

The ratio of Fe to Fe—N-type nitrogen in the Fe—N—C catalyst is close to 1:4, as expected.

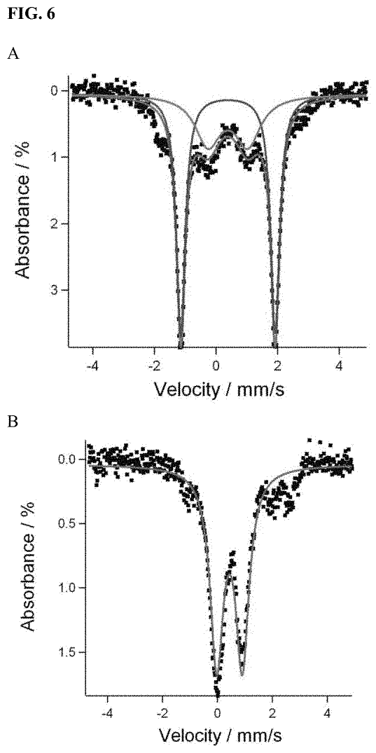

(Phen₂N₂)FeCl is best described as an S=3/2 spin system, in good agreement with computational results. The zero-field Mössbauer spectrum of (phen₂N₂)FeCl presents as a quadrupole doublet (δ=0.39 mm s⁻¹ and |ΔE_{Q}|=3.06 mm s⁻¹, FIG. 6, A) most consistent with an intermediate spin system and similar in magnitude to previously reported porphyrin,^{19,30-34} porphycene,³⁵ tetraazaannulene²⁴ iron(III) complexes bearing various substitutions (Table 5).

TABLE 5
Zero-Field Mössbauer Parameters of (phen₂N₂)FeCl, (phen₂N₂)Fe, Fe—N—C and
D1/D2 Doublets Present in Reported Pyrolyzed Fe/N/C Materials.

| Complex or | | | | | | | |
|---|---|---|---|---|---|---|---|
| material | | | | | | Active | |
| (preparative | Spectral | Structural | δ,^{a} | \|ΔE_{Q}\|, | | Site for | |
| method) | Component | Assigment | mm s⁻¹ | mm s^{-l} | T, K | ORR | Reference |
| (phen₂N₂)Fe^{III}Cl | — | Fe^{II}N₄, LS | 0.39 | 3.06 | 90 | — | This work |
| (phen₂N₂)Fe^{II} | — | | 0.44 | 0.93 | 90 | FeN₄ | This work |
| Fe—N—C | D1 | | 0.49 | 1.17 | 90 | FeNₓ | This work |
| (pyrolyzed | | | | | | | |
| ZIF-8 MOF) | | | | | | | |
| Fe/N/C | D2 | Fe^{II}N₄, LS | 0.36 | 0.98 | 293 | | Nat. Mater. |
| (pyrolyzed | | | | | | | 2015, 14, |
| ZIF-8 MOF)¹⁸ | | | | | | | 937-942. |
| Phen/PANI | D1 | | 0.40 | 2.59 | 70 | | J. Am. Chem. |
| Additive | D2 | | 0.30 | 0.86 | | | Soc. 2014, |
| Fe/N/C²⁰ | | | | | | | 136, 978-985. |
| T(p-OCH₃) | D1 | Fe^{II}N₄, LS | 0.41 | 0.61 | 77 | — | J. Chem. |
| PPFe²¹ | | | | | | | Soc. Faraday |
| | | | | | | | Trans. 1 |
| | | | | | | | 1981, 77, |
| | | | | | | | 2827-2843. |
| TPPFeCl | D1 | Fe^{II}N₄, LS | 0.63 | 0.96 | 130 | | Angew. |
| (pyrolyzed)²² | | | | | | | Chem. Int. |
| | | | | | | | Ed. 1999, 38, |
| | | | | | | | 3181-3183. |
| Fe/N/C (ZIF-8 | D1 | Fe^{II}N₄, LS | 0.37 | 0.74 | 298 | | J. Phys. |
| MOF)²³ | D2 | Fe^{II}N₄, IS | 0.32 | 2.63 | | | Chem. Lett. |
| | D3 | Fe^{II}N₄, HS | 1.00 | 2.21 | | | 2014, 5, |
| | Sextet | Iron Carbide | 0.13 | 0.08 | | | 3750-3756. |

A previously reported S=3/2 iron(III) iodide complex of a dianonic N₄ macrocyclic ligand³⁶ shows similar Mössbauer parameters (δ=0.18 mm s⁻¹ and |ΔE_{Q}|=3.56 mm s⁻¹)³⁷ although the relatively elevated isomer shift and smaller quadrupole splitting values of (phen₂N₂)FeCl may indicate a slight S=3/2, 5/2 admixture. The Mössbauer parameters of various S=3/2 iron(III) porphyrins are more similar to (phen₂N₂)FeCl.³⁸⁻⁴⁰

Chemical reduction of (phen₂N₂)FeCl with Cp₂Co under inert atmosphere results in a reduction in the intensity of the Fe—Cl bond vector as well as a shift to lower pre-edge and XANES energies (FIG. 3 and Table 1). Analogous reduction of Fe—N—C displays an increase in the intensity of the pre-edge feature along with a decrease in the intensity evident in the FT-EXAF S data, indicating removal of axially-bound ligands from the iron-containing sites in the material. The zero-field Mössbauer spectrum of reduced (phen₂N₂)FeCl (FIG. 6, B) is represented by a single quadrupolar doublet with δ=0.44 mm s⁻¹ and |ΔE_{Q}|=0.93 mm s⁻¹. These values indicate a correspondence to the D1 doublet reported for a range of synthetic Fe—N—C preparations (Table 5) with median δ and |ΔE_{Q}| values of 0.45 mm s⁻¹ and 0.89 mm s⁻¹, respectively.

### Electrochemical Studies

Homogeneous:

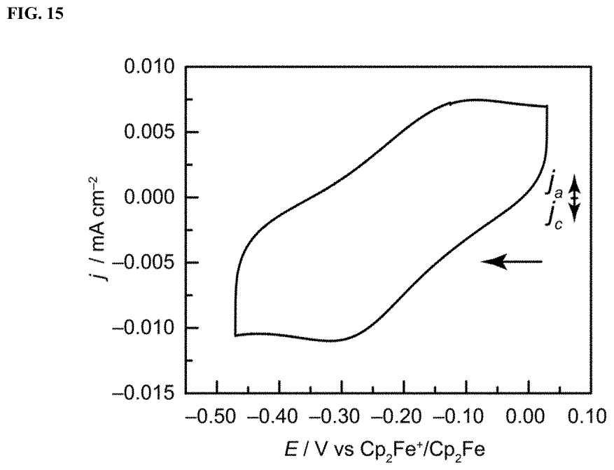

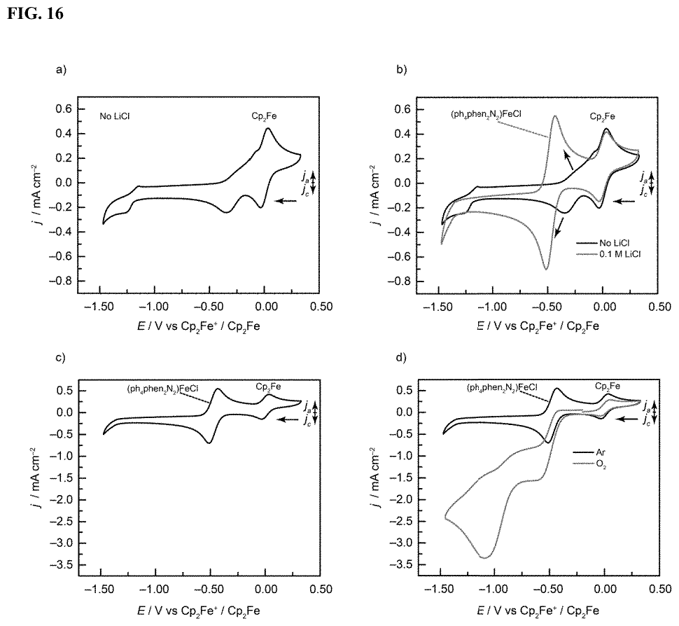

The initial electrochemical characterization of (phen₂N₂)FeCl was performed under inert atmosphere in N,N′-dimethylformamide containing a slight molar excess of Tl(OTf) and 60 mM [DMF-H][OTf] (FIG. 15). The Fe(III/II) couple is found to be located at −0.158 V vs Cp₂Fe⁺/Cp₂Fe which is several hundred millivolts more positive of most reported iron porphyrins in similar solvent and electrolyte mixtures.⁴¹

Heterogeneous:

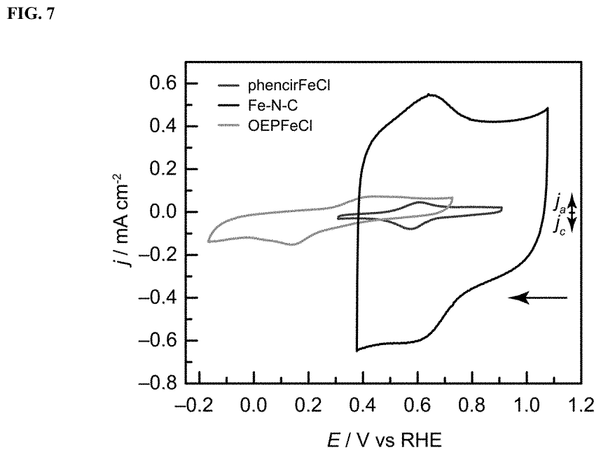

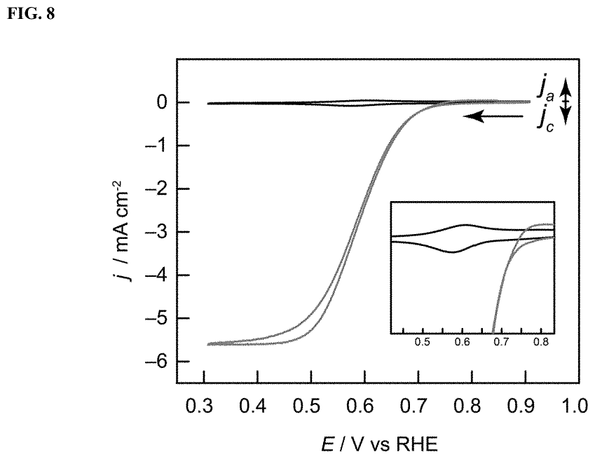

Samples of (phen₂N₂)FeCl and pyrolyzed Fe—N—C were independently processed into heterogeneous inks and dropcast onto polished glassy carbon rotating disk electrodes. Cyclic voltammograms taken in 0.1 M HClO₄ under Ar-atmosphere (FIG. 7) demonstrate that (phen₂N₂)FeCl and Fe—N—C have similar redox potentials, far anodic of that displayed by a comparable porphyrin such as OEPFeCl (0.27 V vs RHE). These reversible waves are assigned as the Fe(III/II) redox couple for each catalyst. Introduction of an O₂-atmosphere in the presence of (phen₂N₂)FeCl gives a catalytic wave whose E_{1/2} potential roughly corresponds to the reversible wave observed under inert atmosphere (FIG. 8), both confirming that (phen₂N₂)FeCl is a ORR catalyst and validating the assignment of the redox couple. In both acidic and basic media (phen₂N₂)FeCl displays improved ORR onset values (0.74 V and 0.88 V vs RHE, respectively) compared to OEPFeCl (0.45 V and 0.74 V vs RHE, respectively). This suggests a substantial difference in ORR performance based upon the primary coordination sphere and correlates with the shift in the E_{1/2} value.

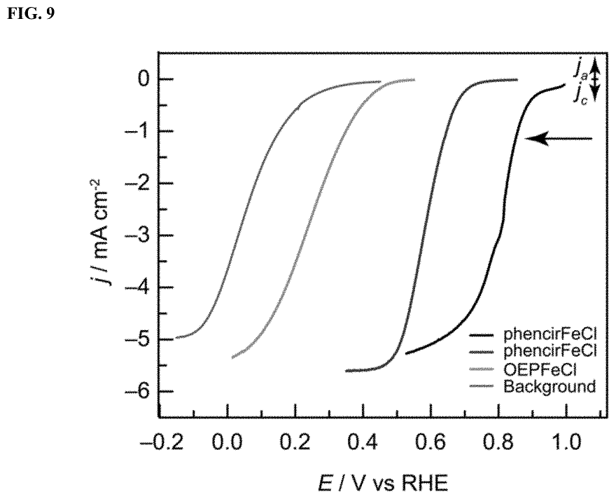

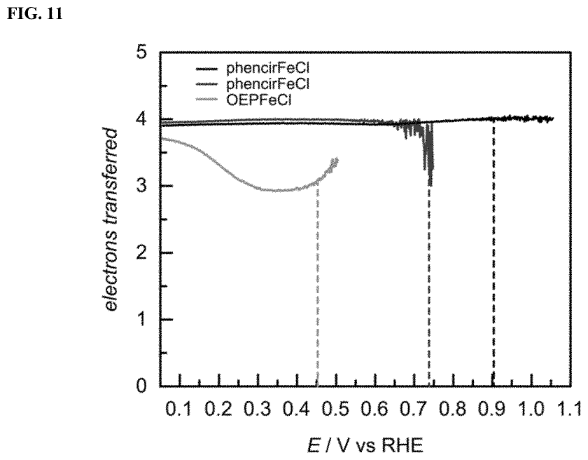

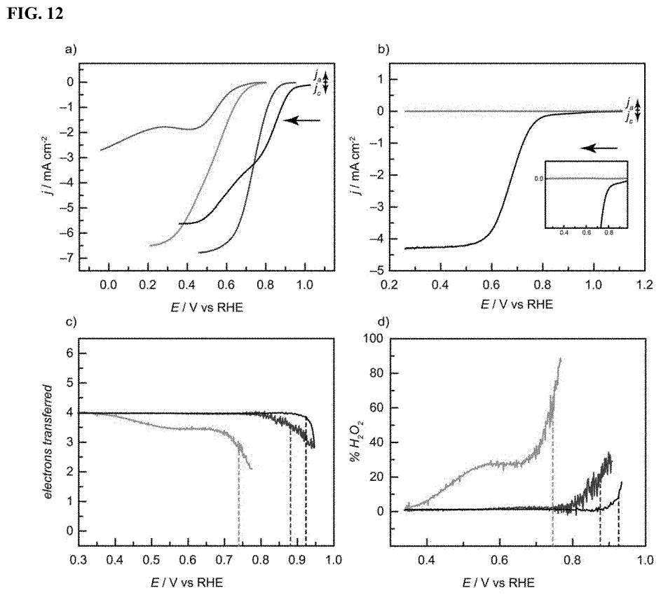

The relative electrochemical ORR activities and behavior of both (phen₂N₂)FeCl and Fe—N—C were then examined. In comparison to the Fe—N—C materials, (phen₂N₂)FeCl displays inferior activity (FIG. 9, blue and black traces) and stability in acidic conditions (FIG. 11). In basic media, the stability and activity of (phen₂N₂)FeCl are improved, with more positive onset potentials, slower degradation (see FIG. 12, (a) and (b)) and a closer match to the performance of Fe—N—C materials (see Table 6).

(Phen₂N₂)Fe displays an Fe(III/II) redox potential higher than (OEP)Fe and more similar to Fe—N—C. Both model compounds and the Fe—N—C material were evaluated electrochemically as thin films supported on glassy carbon electrodes. In a typical preparation, Fe—N—C powders were dispersed in a 7:2:1 combination of CH₂Cl₂, ethanol, and 5 wt % Nafion solution (75 wt % ethanol and 20 wt % water), respectively. The resulting inks were dropcast onto a glassy carbon disk electrode and allowed to dry in air to generate a well-adhered catalyst film. A similar procedure was used for (phen₂N₂)FeCl and (OEP)FeCl with inclusion of Vulcan carbon powder to enhance film conductivity. We expect that any residual FeCl₃ salts present in the (phen₂N₂)FeCl sample will readily dissolve into the acidic electrolyte and will, therefore, not impact the electrochemical results. In line with this expectation, we find that FeCl₃/Vulcan inks are inactive for ORR.

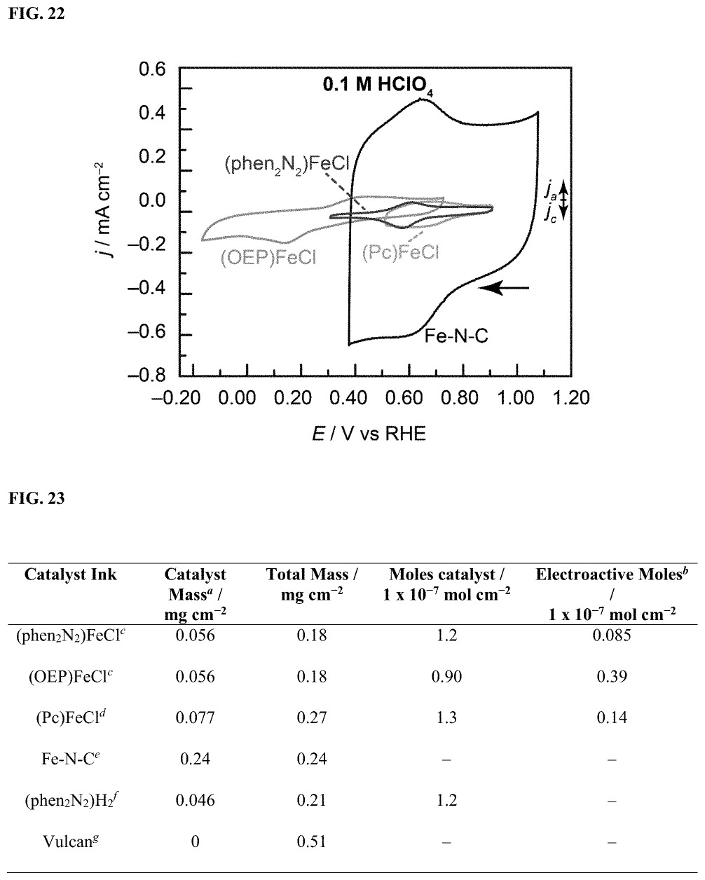

Cyclic voltammograms of Fe—N—C, (phen₂N₂)FeCl, and (OEP)FeCl recorded in the absence of O₂ provide insight into the redox potential of the metal center. For (OEP)Fe (FIG. 22, orange), we observe a broad redox feature with E_{1/2}=0.27 V (all potentials are reported vs the reversible hydrogen electrode, RHE), similar to reported values for carbon-supported iron porphyrin complexes.^{112,133} For (phen₂N₂)Fe (FIG. 22, blue), we observe a reversible redox wave at 0.59 V. Based on the known Nernstian pH dependence of Fe(III/II) couples for adsorbed porphyrin complexes as well as the quasi-Nernstian behavior of the redox wave for (phen₂N₂)Fe, we assign these redox processes to the one-electron, one-proton reduction of Fe(III)-OH to Fe(II)-OH₂. For Fe—N—C (FIG. 22, black), we observe a large double layer capacitance, consistent with the high surface area of the material, and a pronounced redox wave at 0.63 V (FIG. 22). Other literature reports have observed waves for Fe—N—C materials at 0.8 V, in line with the onset of ORR catalysis at Fe—N—C materials (see below) and so we attribute the wave we observe at 0.63 V to proton-coupled electron transfer (PCET) reactions of quinone and hydroxyl moieties on the Fe—N—C surface. We postulate that the actual Fe(III)-OH/Fe(II)-OH2 redox process for Fe—N—C is obscured by the large double layer charging background in this high surface area material and the likely distribution of iron redox potentials in the heterogeneous material. We also note that some Fe redox centers may not engage in PCET reactivity and would, therefore, not be expected to display a redox wave. Nonetheless, the 0.32 V positive shift of the Fe redox couple for (phen₂N₂)Fe vs (OEP)Fe is consistent with the more electron withdrawing character of the pyridinic primary ligation sphere, which brings this model complex much closer in electronic character to the electropositive iron environments in Fe—N—C materials.

The observed Fe(III/II) redox waves result from only a fraction of the catalyst loaded into the dropcast film. The integrated charge in the Fe(III/II) redox waves of the (phen₂N₂)FeCl catalyst film corresponds to 7% of the total catalyst loading (FIG. 23). This contrasts with the (OEP)FeCl film, for which the Fe(III/II) wave integration corresponds to 43% of the total catalyst loading. We attribute this difference to the improved solubility of the porphyrin catalyst leading to better dispersion within the film. Nonetheless, these PCET redox potentials provide a good indication that the iron centers in (phen₂N₂)Fe are more electropositive than those in (OEP)Fe.

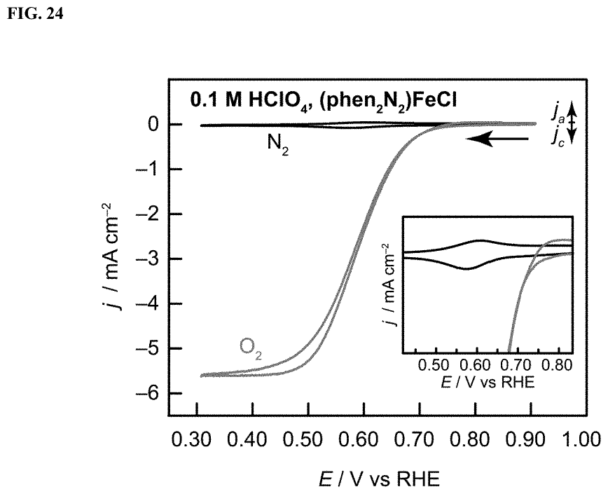

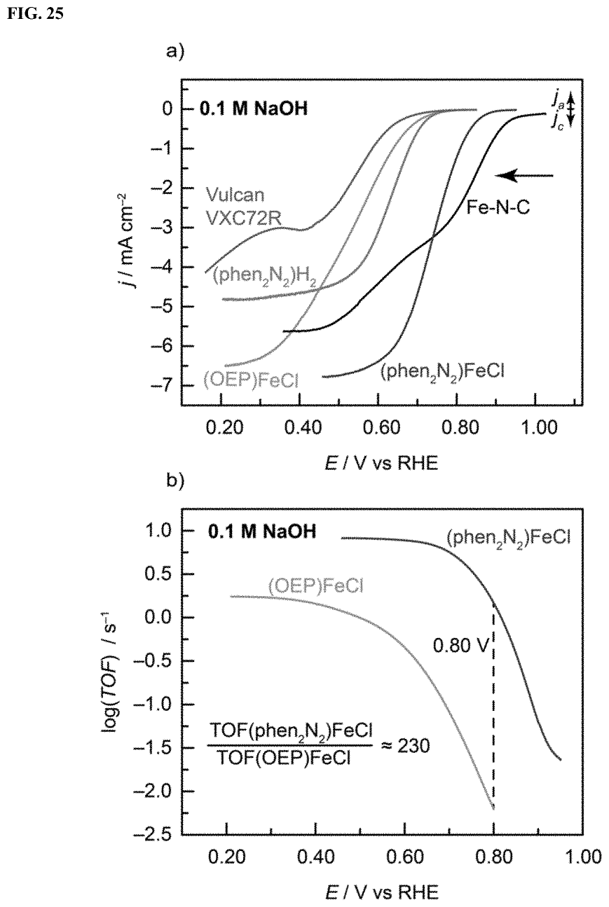

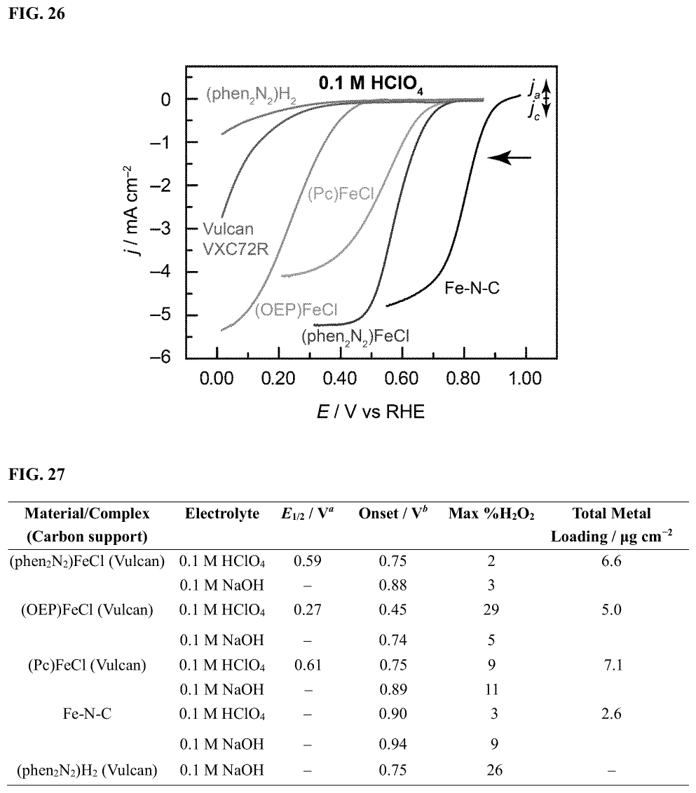

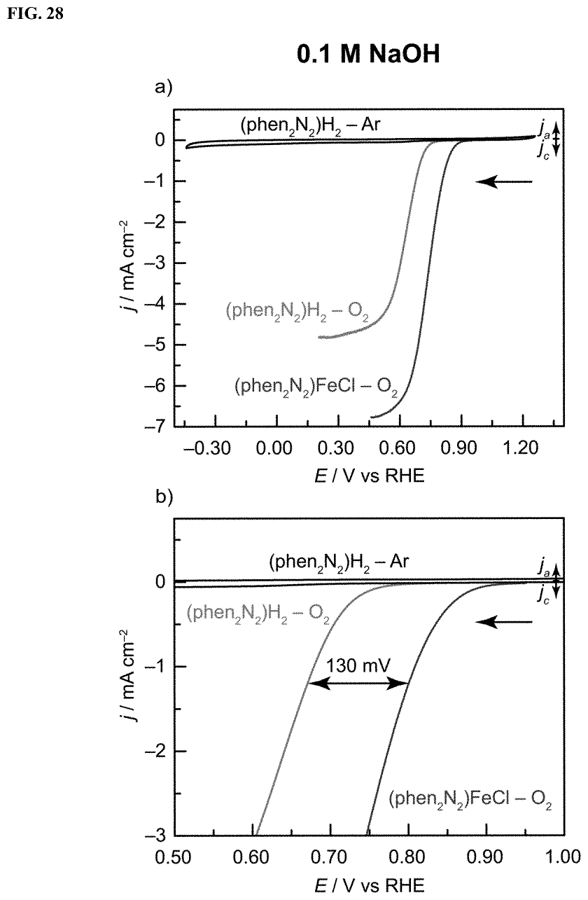

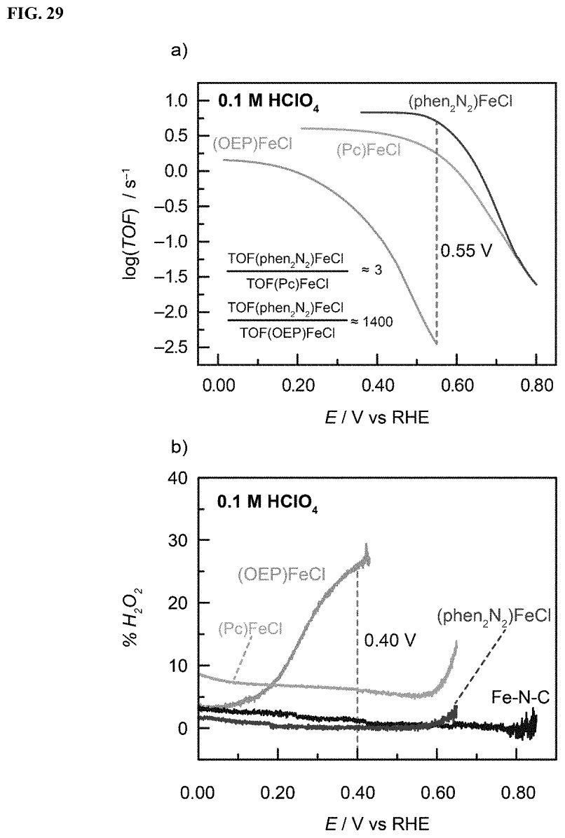

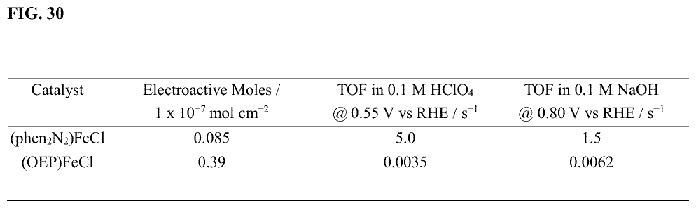

(Phen₂N₂)FeCl catalyzes ORR at lower overpotentials and with higher TOF values than (OEP)FeCl. (Phen₂N₂)FeCl is a potent catalyst for the oxygen reduction reaction. In O₂-saturated 0.1 M HClO₄, the reversible surface redox wave at 0.59 V (FIG. 24, black) is replaced by a large catalytic wave that displays an onset potential of 0.75 V (all onset potentials correspond to a current density of 0.1 mA cm⁻² and all electrochemical performance parameters are collected in FIG. 27) and reaches a current plateau at ˜0.5 V (FIG. 24, red). This catalytic wave spans the same potential range as the reversible redox feature in the absence of O₂ suggesting that ORR catalysis is mediated by the Fe(III/II) redox process (FIG. 24, inset). Catalytic activity is improved in basic media with an onset of 0.88 V in 0.1 M KOH (FIG. 25, a). The catalytic activity of (phen₂N₂)FeCl (FIG. 26 , blue) is significantly greater than that of (OEP)FeCl (FIG. 26, orange), which displays onset potentials of 0.45 and 0.74 V in HClO₄ and KOH, respectively. Additionally, the unmetalated (phen₂N₂)H₂ ligand has activity comparable to the carbon background (FIG. 26, green) in acidic media with an onset potential of 0.34 V (FIG. 26, red) and activity slightly higher than background in alkaline media with an onset potential of 0.75 V, 130 mV negative of (phen₂N₂)FeCl (FIG. 25, a, and FIG. 28). Notably, the 0.3 V increase in ORR onset potential for (phen₂N₂)FeCl relative to (OEP)FeCl in acid is comparable to the 0.32 V positive shift in the Fe(III/II) redox potential. For homogeneous molecular iron porphyrins, TOF values typically track inversely with the Fe(III/II) redox potential. Yet, for (phen₂N₂)FeCl, the dramatic increase in Fe(III/II) potential does not seem to lead to a correlated decrease in ORR rate⁷² suggesting that (phen₂N₂)FeCl does not follow the same linear free-energy correlations observed for molecular porphyrin catalysts. The catalytic enhancement is also reflected in significantly increased per-site turnover frequencies (TOFs). TOF values in electron passed per site per second were extracted as a function of potential by dividing the current density by the integrated charge passed in the Fe(III/II) redox feature (FIG. 25, b, and FIG. 29, a). Remarkably, (phen₂N₂)FeCl displays a dramatically enhanced TOF that is 1400-fold higher than that of (OEP)FeCl in the activation-controlled region at 0.55 V in 0.1 M HClO₄ and 230-fold higher in the same region at 0.80 V in 0.1 M NaOH (FIG. 30). These observations establish that changing the primary coordination environment from pyrrolic to pyridinic leads to a dramatic enhancement in catalytic activity for ORR.

Although the catalytic performance of (phen₂N₂)FeCl is superior to (OEP)FeCl, it remains at a deficit to Fe—N—C. While the Fe(III/II) redox potential is difficult to discern for Fe—N—C, the positive shift of the Fe(III) peak in the XPS suggest that the iron centers in Fe—N—C are even more electropositive than the those in (phen₂N₂)FeCl and this may contribute to the higher onset potentials of 0.90 and 0.94 V observed for the Fe—N—C catalyst in acidic and alkaline media, respectively, (FIG. 26 and FIG. 25, a, black). Furthermore, unlike in (phen₂N₂)FeCl, the iron centers in Fe—N—C interact strongly with the delocalized band states of the N-doped graphitic carbon matrix and, indeed, a recent study on cobalt porphyrins indicates that strong electron coupling to graphite can dramatically increase ORR activity relative to a porphyrin of identical local structure with weak coupling to the surface. Studies are ongoing to synthesize (phen₂N₂)FeCl analogs that can be conjugated to graphitic carbon electrodes to directly examine the role of electronic coupling on ORR activity. Notwithstanding, the fact that a discrete molecular complex such as (phen₂N₂)FeCl displays an ORR onset within 150 mV of champion Fe—N—C materials suggests enormous opportunities for rational molecular design of highly active Fe-based ORR catalysts based upon pyridinic macrocyclic complexes.

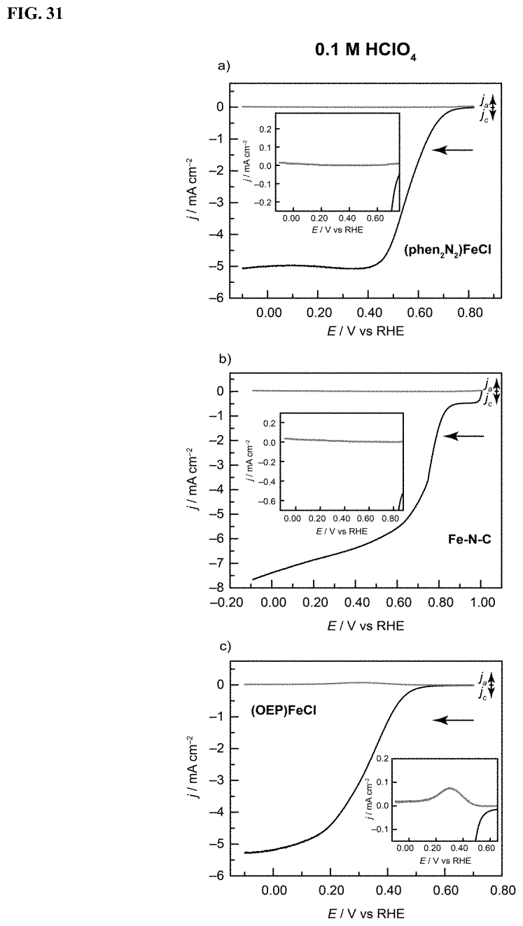

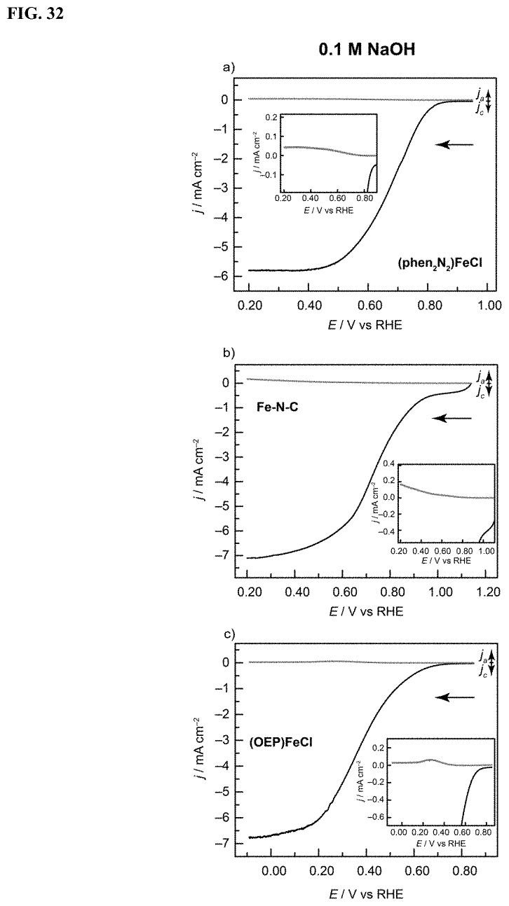

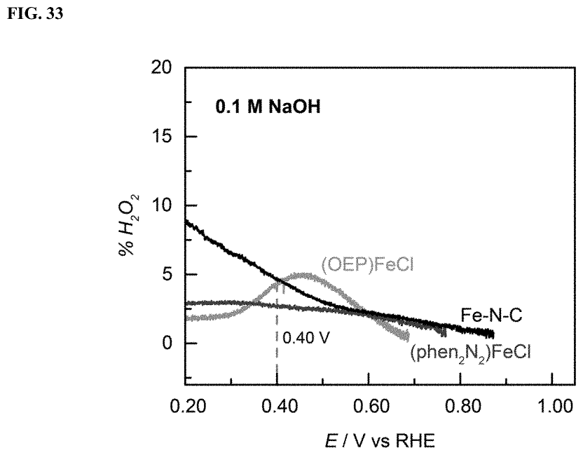

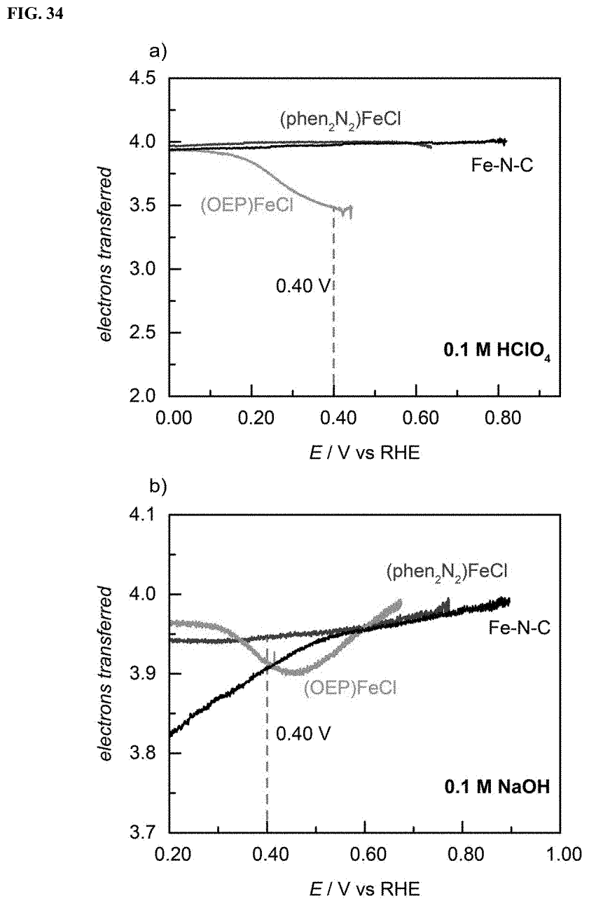

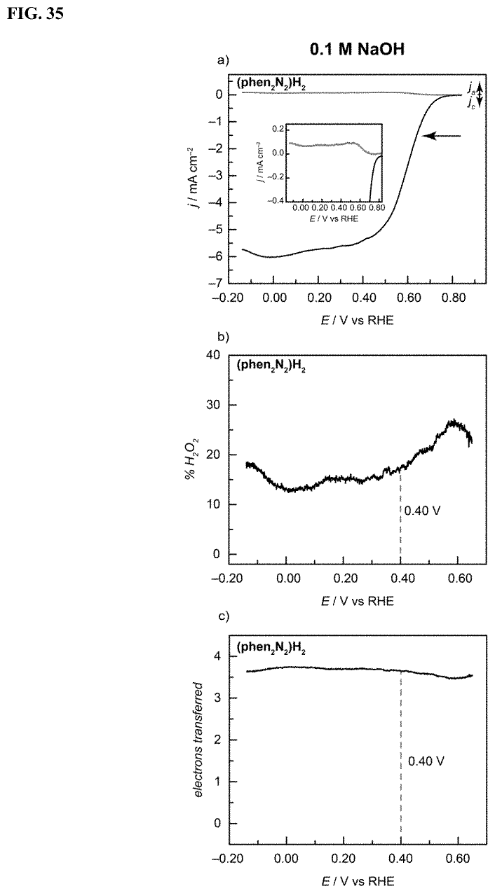

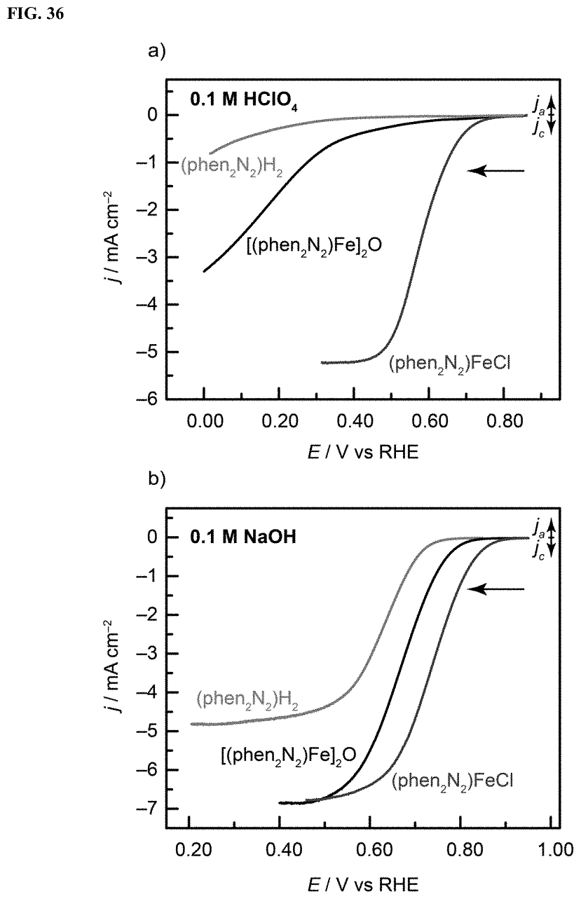

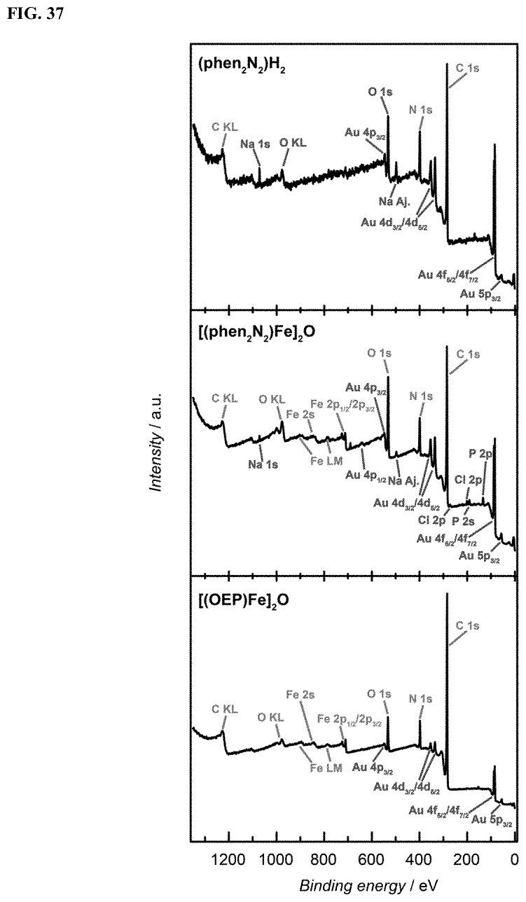

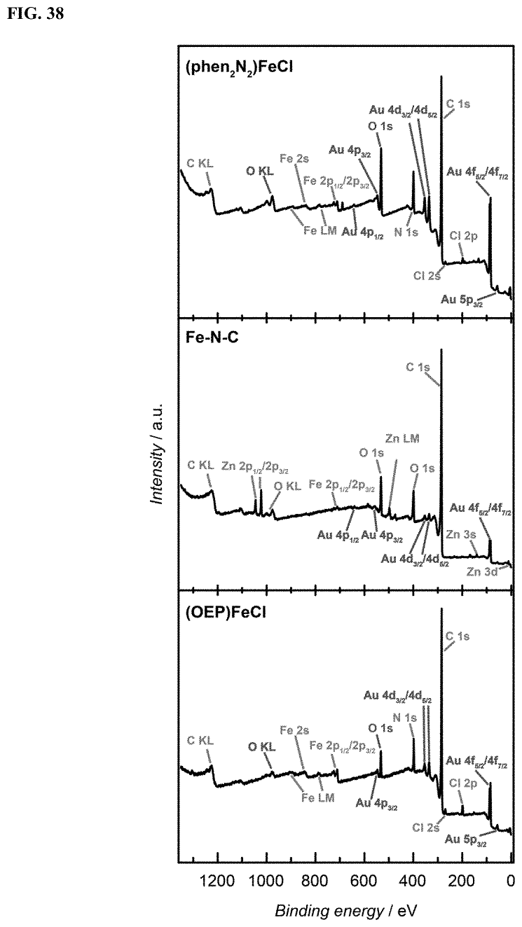

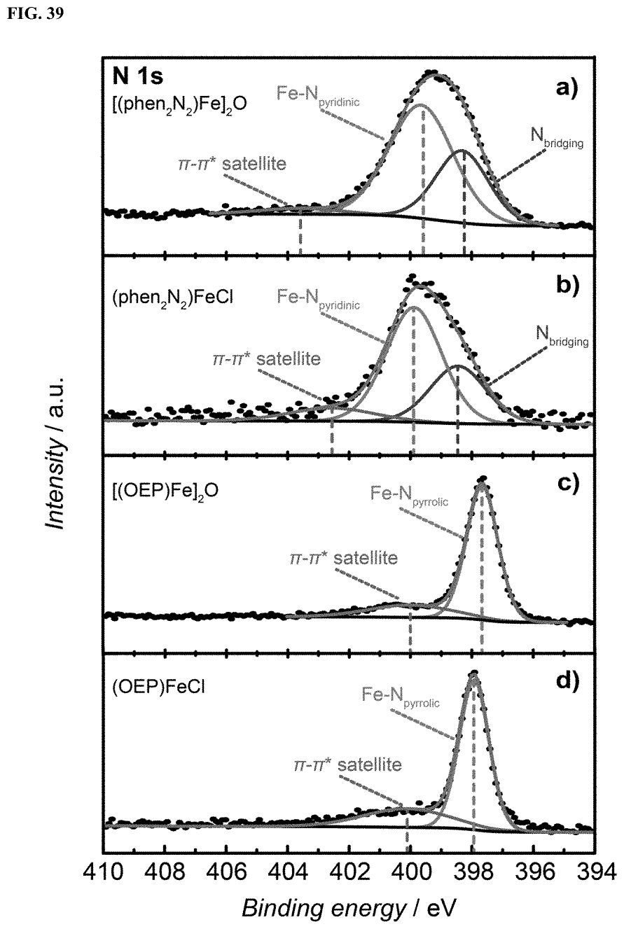

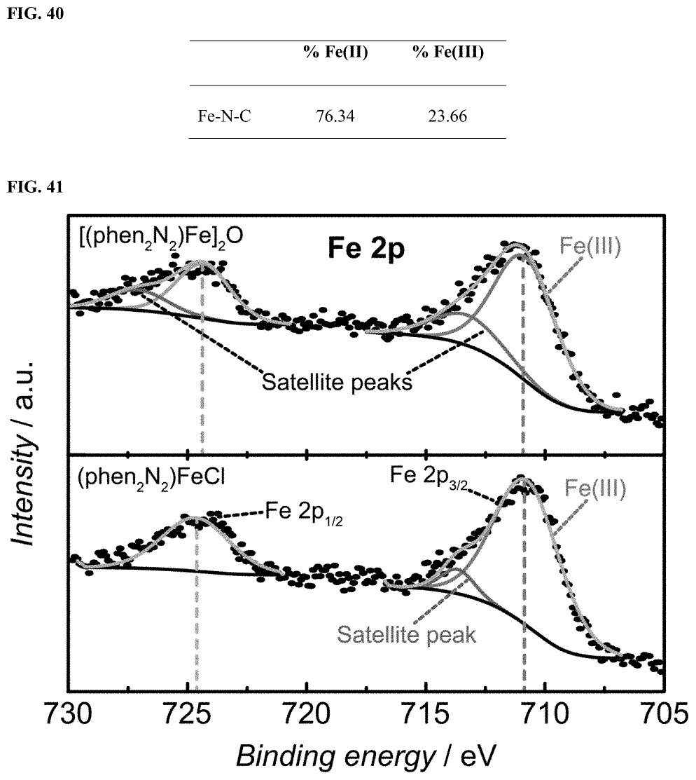

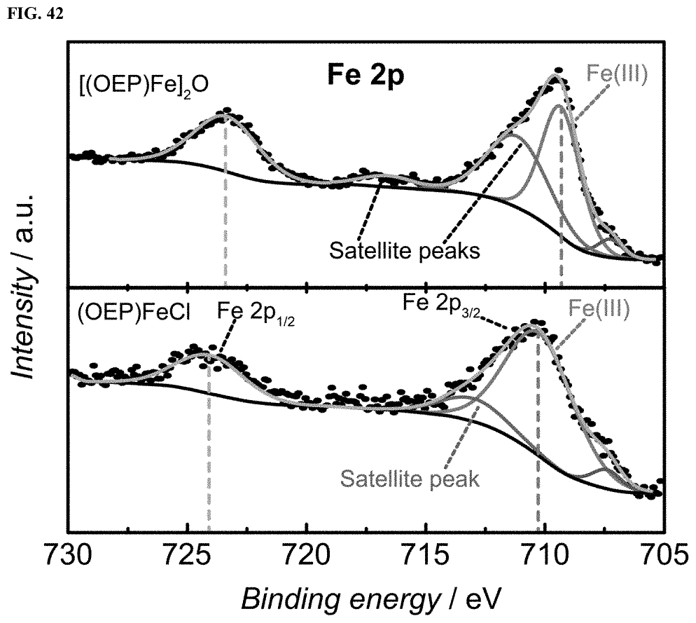

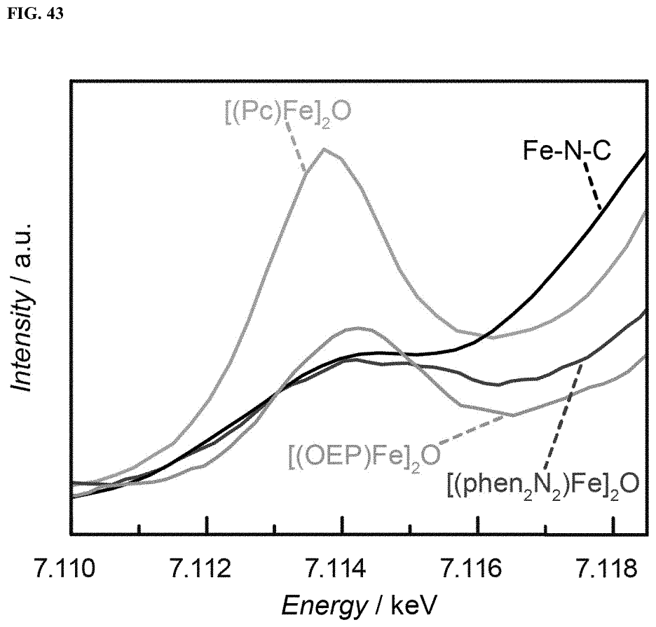

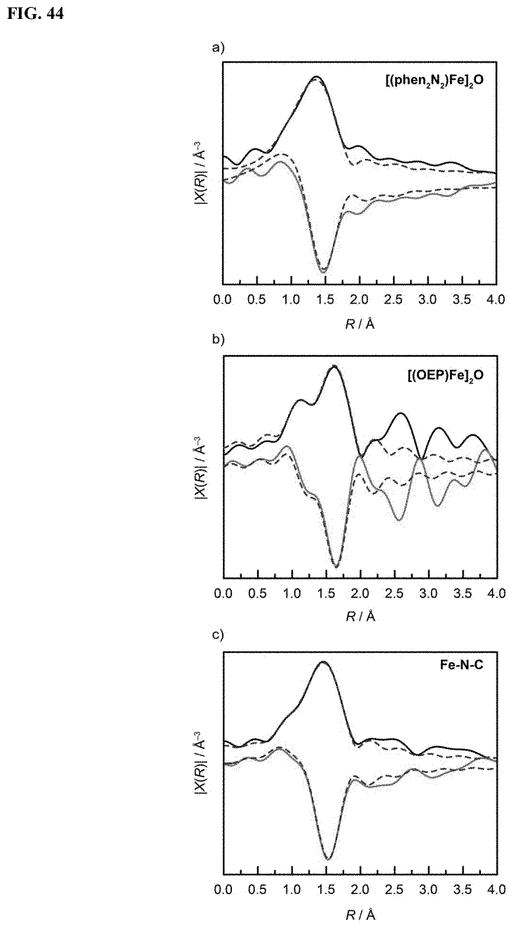

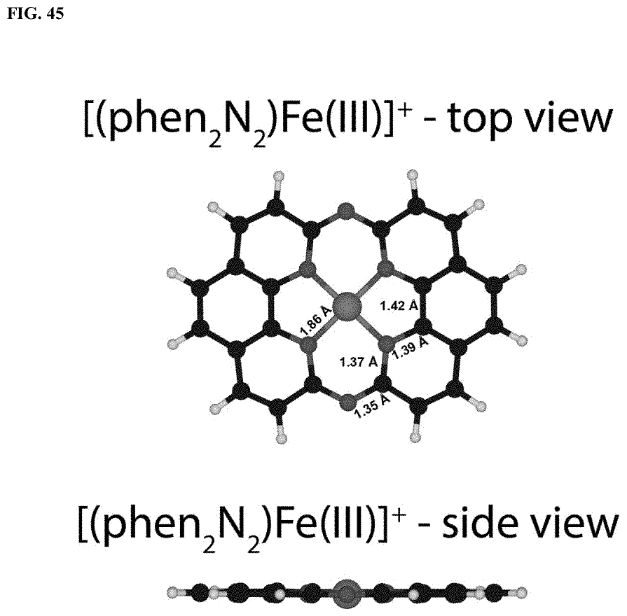

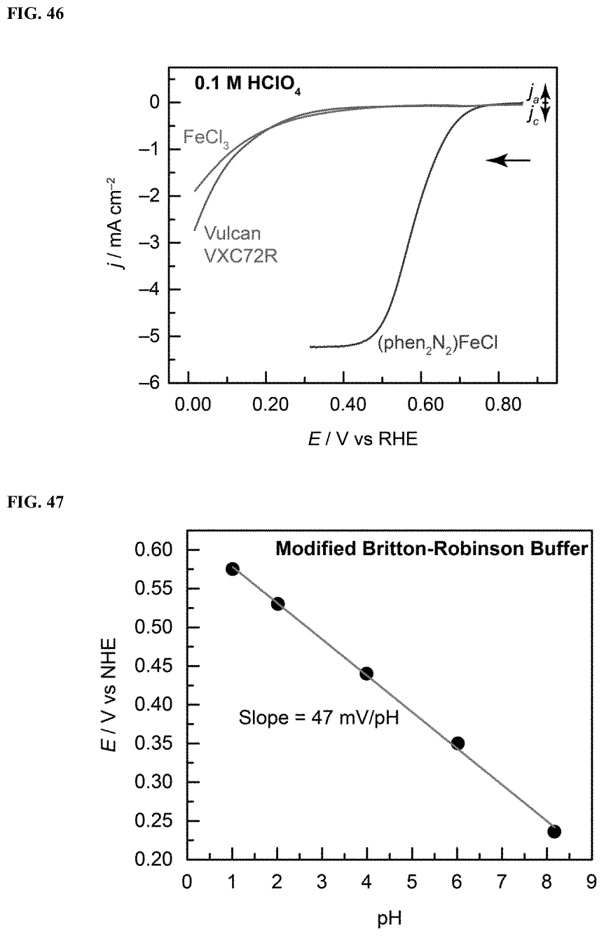

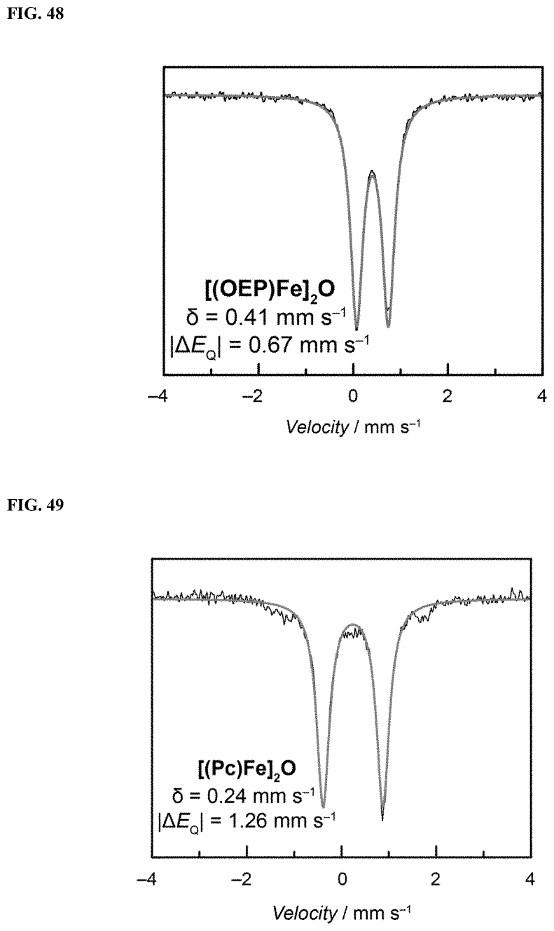

Furthermore, (phen₂N₂)FeCl displays high selectivity for the four-electron reduction of O₂ that is comparable to Fe—N—C and greater than that of (OEP)FeCl. Using rotating ring disk electrode (RRDE) voltammetry (FIGS. 31 and 32) we determined the percent H₂O₂ produced as a function of applied potential for all three catalysts (FIG. 29, b and FIG. 33). For (phen₂N₂)FeCl, H₂O₂ production stabilizes rapidly, reaching values of <1% and 3% in acid and alkaline media at 0.40 V vs RHE, respectively (FIG. 29, b, and FIG. 33, blue).These values correspond to 3.99 and 3.95 electrons transferred in each condition, respectively, (FIG. 34). Indeed, in both acidic and alkaline media, the selectivity of (phen₂N₂)FeCl in the transport-limited region surpasses that of Fe—N—C at the same potential (1% and 5% H₂O₂ in 0.1 M HClO₄ and 0.1 M NaOH, respectively, at 0.40 V). Further, in stark contrast to (phen₂N₂)FeCl, (OEP)FeCl displays significantly lower selectivity with 26% and 4% H₂O₂ in acidic and alkaline media, respectively, at the same potential of 0.40 V (FIG. 29, b, and FIG. 33, orange). Notably, for both (phen₂N₂)FeCl and Fe—N—C, the hydrogen peroxide percentages increase in alkaline media and this may result from the action of less-selective non-metallic active sites capable of ORR in alkaline media. Indeed, for the metal-free (phen₂N₂)H₂ ligand supported on carbon, we observed significantly higher levels of H₂O₂ in alkaline media (17% at 0.40 V and a maximum of 26%, FIG. 35, b). Overall, these results highlight the ability of this tetrapyridinic Fe—N₄ coordination environment to facilitate selective O₂-reduction pathways in both acidic and alkaline media. The similar trends in selectivity between this complex and Fe—N—C further support the notion that the (phen₂N₂)Fe motif is an effective functional model of Fe—N—C catalysts.

Whereas Fe—N—C materials are relatively stable, we observe limited stability of the (phen₂N₂)FeCl catalyst with activity decaying in acidic media over the course of several slow scan cyclic voltammograms (15-20 min). A similar deactivation is also observed for (OEP)FeCl and is well-documented in the literature. These observations highlight the important role of the carbon framework in increasing the relative stability of Fe—N₄ sites in Fe—N—C materials against oxidative and protolytic decomposition induced by the acidic conditions and the presence of parasitic amounts of H₂O₂.¹⁴⁷ Indeed, we posit that extending the aromatic periphery around the (phen₂N₂)FeCl active site could enhance stability and provide a path towards the bottom-up synthesis of robust Fe-based ORR catalysts.

TABLE 6
Electrochemical Oxygen Reduction Onset and Selectivity
of Fe—N—C and Vulcan-Supported Iron Macrocycle Complexes.

| | | Onset potential | |
|---|---|---|---|
| Complex^{a} | Electrolyte | (V)^{b,c} | Max % H₂O₂ |
| Fe—N—C | 0.1M HClO₄ | 0.91 | ~1 |
| | 0.1M NaOH | 0.91 | ~1 |
| (phen₂N₂)Fe^{III}Cl | 0.1M HClO₄ | 0.74 | <4 |
| | 0.1M NaOH | 0.88 | ~1 |
| (OEP)Fe^{III}Cl | 0.1M HClO₄ | 0.45 | 28 |
| | 0.1M NaOH | 0.74 | 13 |

^{a}OEP refers to 2,3,7,8,12,13,17,18-octaethylporphyrin.
^{b}V vs RHE.
^{c}Defined as the point where the current density surpasses 0.1 mV cm⁻².

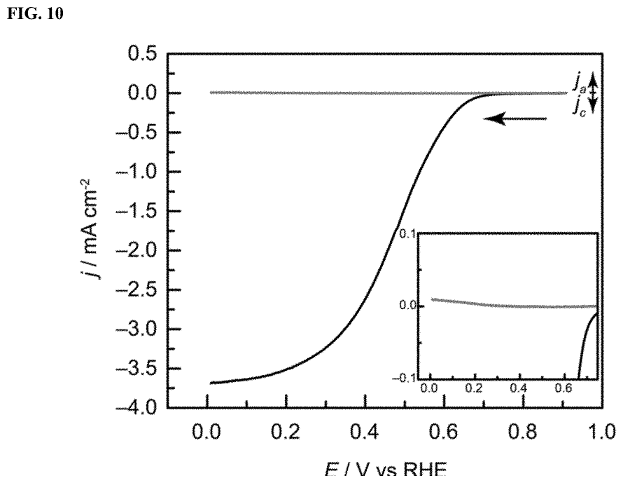

ORR catalyzed by (phen₂N₂)FeCl (FIG. 10) demonstrated limited production of hydrogen peroxide (H₂O₂) in basic media (FIG. 12, d). The number of electrons transferred as a function of applied potential in acidic media is given in FIG. 11, and in basic media in FIG. 12, c. After reaching an appreciable current density, the number of electrons transferred remains near 4 for the subsequent potential range, with a maximum of about 4% H₂O₂ produced over a large overpotential regime, in good agreement with a range of pyrolyzed catalysts characterized by prominent D1 components in their respective Mössbauer spectra.

Density functional theory (DFT) was used to model the catalytic properties of porphyrin, (phen₂N₂), and two Fe—N₄ macrocycles with extended aromatic systems to represent the Fe—N—C materials for comparison. To evaluate catalytic activity and to compare to the experimental data, the binding energy of each of these catalysts with O₂ was calculated (see Table 7). Notably, (phen₂N₂)Fe binds O₂ more strongly than porphyrinFe by 0.25 eV, whereas the extended systems bind O₂ even more strongly. Such a trend in O₂ binding strength is in agreement with the observed trend in catalytic activity for a reaction that is limited by the concentration of O₂ while the observed selectivity is similarly consistent with a catalyst possessing a more negative enthalpy of O₂-binding.

TABLE 7
Calculated Binding Energies of Small Molecules
to PorphyrinFe^{II}, (phen₂N₂)Fe^{II} and Fe—N—C.

| | Binding Energy (eV) | | |
|---|---|---|---|
| Catalyst | O₂ | CO | CN⁻ |
| PorphyrinFe | −0.32 | −0.73 | −0.54 |
| (phen₂N₂)Fe | −0.57 | −0.90 | −0.68 |
| (phen₂N₂)Fe Extended 1 (Fe—N—C) | −0.91 | −1.18 | −0.78 |
| (phen₂N₂)e Extended 2 (Fe—N—C) | −0.76 | −1.05 | −0.79 |

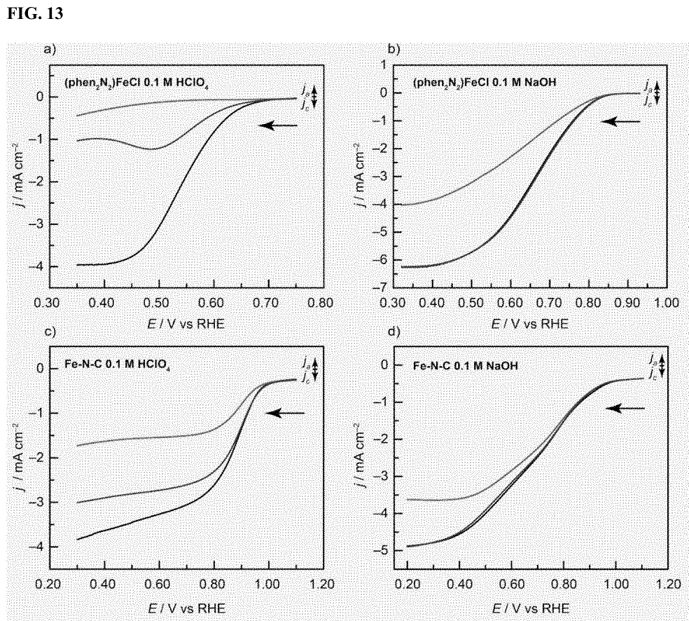

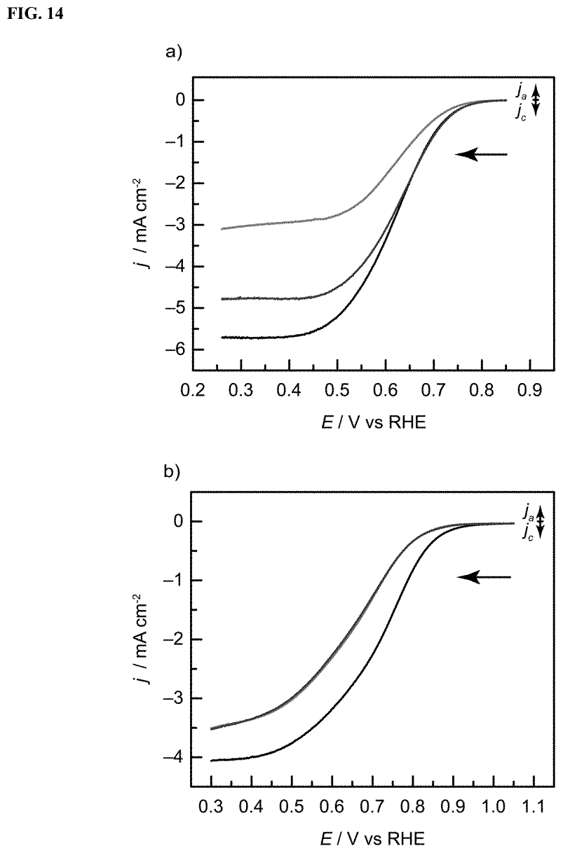

The influence of CO and KCN on the catalytic waves was examined (FIGS. 13 and 14). In acidic media simultaneously sparged with CO and O₂, both partial and complete suppression of ORR activity for Fe—N—C and (phen₂N₂)FeCl was observed, respectively (FIG. 13). It can be reversed by removal of CO.⁴¹ Similar results are obtained in base. Given the ease of reversal, the ORR behavior can be attributed to a reduction in the relative partial pressure of O₂ in the cell when the solution is also being sparged with CO, as well as weakened CO binding at more anodic potentials where vFeCl and Fe—N—C catalyze ORR.⁴² ORR onset and limiting current values in the presence of KCN are diminished for both (phen₂N₂)FeCl and Fe—N—C, indicating a competition for the iron sites that is not completely reversed upon immersing the electrodes in fresh electrolyte.

The (phen₂N₂)Fe core developed here also allows for rational design of improved ORR catalysts. Unlike for Fe—N—C materials, synthetic derivatization of the (phen₂N₂)Fe architecture will uniformly modify all the active sites in the material, allowing for the extraction of molecular-level free-energy correlations. Moreover, borrowing from extensive studies of molecular porphyrin complexes, the secondary coordination sphere around the (phen₂N₂)Fe core can be tuned to generate three-dimensional surface active site environments that would be impossible to synthesize faithfully and selectively by traditional pyrolysis methods. s. Thus, the molecular model complex developed here provides a powerful platform with which to advance the synthesis and understanding of single-site heterogeneous electrocatalysts for critical energy conversation reactions

### Compounds of the Invention

In some embodiments, the disclosure relates to a compound of Formula I or a salt thereof:

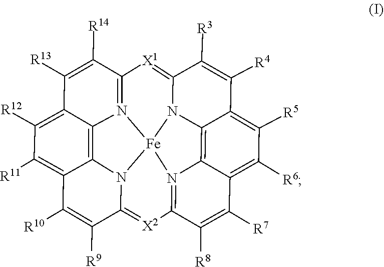

wherein

X¹ and X² are independently N, C(R¹⁵), (O⁺)X⁻, or (S⁺)X⁻;

X⁻ is independently for each occurrence boron tetrafluoride, phosphorus tetrafluoride, phosphorus hexafluoride, alkylsulfonate, fluoroalkylsulfonate, arylsulfonate, bis(alkylsulfonyl)amide, bis(fluoroalkylsulfonyl)amide, bis(arylsulfonyl)amide, (fluoroalkylsulfonyl)(fluoroalkylcarbonyl)amide, halide, nitrate, nitrite, sulfate, hydrogensulfate, alkyl sulfate, aryl sulfate, carbonate, bicarbonate, alkyl carboxylate, aryl carboxylate, phosphate, hydrogen phosphate, dihydrogen phosphate, hypochlorite, or an anionic site of a cation-exchange resin;

Y⁺ is Li⁺, Na⁺, K⁺, Mg²⁺, Ca²⁺, or ⁺NR¹⁶R¹⁷R¹⁸R¹⁹;

R³, R⁴, R⁵, R⁶, R⁷, R⁸, R⁹, R¹⁰, R¹¹, R¹², R¹³, and R¹⁴ are independently hydrogen, halogen, —CN, —OR¹⁵, —CO₂⁻(Y⁺), —SO₃H, —SO₃⁻(Y⁺), —NR¹⁶R¹⁷, —NO₂, substituted or unsubstituted alkyl, substituted or unsubstituted cycloalkyl, substituted or unsubstituted aryl, substituted or unsubstituted heteroaryl, substituted or unsubstituted heterocycloalkyl, haloalkyl, —OC(O)R²⁰, —C(O)R²⁰, —C(O)OR²⁰, —C(O)NR²¹R²², —S(O)R²³, or —SO₂R²³; and

R¹⁵, R¹⁶, R¹⁷, R¹⁸, R¹⁹, R²⁰, R²¹, R²² and R²³ are independently hydrogen, haloalkyl, substituted or unsubstituted alkyl, substituted or unsubstituted cycloalkyl, substituted or unsubstituted aryl, substituted or unsubstituted heteroaryl, or substituted or unsubstituted heterocycloalkyl.

In certain embodiments, X¹ is N; and the compound of Formula I is a Bronsted conjugate acid or a quaternary (C₁-C₆)alkyl ammonium salt at X¹.

In certain embodiments, X² is N; and the compound of Formula I is a Bronsted conjugate acid or a quaternary (C₁-C₆)alkyl ammonium salt at X².

In certain embodiments, X¹ is N; X² is N; the compound of Formula I is a Bronsted conjugate acid or a quaternary (C₁-C₆)alkyl ammonium salt at X¹; and the compound of Formula I is a Bronsted conjugate acid or a quaternary (C₁-C₆)alkyl ammonium salt at X².

In certain embodiments, the disclosure relates to a compound of Formula I or a salt thereof, wherein X¹ is C(R¹⁵).

In some embodiments, the disclosure relates to a compound of Formula I or a salt thereof, wherein X² is C(R¹⁵).

In some embodiments, the disclosure relates to a compound of Formula I or a salt thereof, wherein X¹ is C(R¹⁵); and X² is C(R¹⁵).

In other embodiments, the disclosure relates to a compound of Formula I or a salt thereof, wherein X¹ is N.

In some embodiments, the disclosure relates to a compound of Formula I or a salt thereof, wherein X² is N.

In other embodiments, the disclosure relates to a compound of Formula I or a salt thereof, wherein X¹ is N; and X² is N.

In some embodiments, the disclosure relates to a compound of Formula I or a salt thereof, wherein X¹ is (O⁺)X⁻ or (S⁺)X⁻.

In certain embodiments, the disclosure relates to a compound of Formula I or a salt thereof, wherein X² is (O⁺)X⁻ or (S⁺)X⁻.

In some embodiments, the disclosure relates to a compound of Formula I or a salt thereof, wherein X¹ is (O⁺)X⁻ or (S⁺)X⁻; and X² is (O⁺)X⁻ or (S⁺)X⁻.

In some embodiments, the disclosure relates to a compound of Formula I or a salt thereof, wherein R¹⁵ is hydrogen.

In other embodiments, the disclosure relates to a compound of Formula I or a salt thereof, wherein R¹⁵ is substituted or unsubstituted alkyl. Alternatively, R¹⁵ is substituted or unsubstituted cycloalkyl. In some instances, R¹⁵ is substituted or unsubstituted aryl. In certain embodiments, the disclosure relates to a compound of Formula I or a salt thereof, wherein R¹⁵ is substituted or unsubstituted heteroaryl.

In some embodiments, X¹ is C(R¹⁵), (O⁺)X⁻, or (S⁺)X⁻.

In some embodiments, X² is C(R¹⁵), (O⁺)X⁻, or (S⁺)X⁻.

In some embodiments, each of R³, R⁴, R⁵, R⁶, R⁷, R⁸, R⁹, R¹⁰, R¹¹, R¹², R¹³, and R¹⁴ is hydrogen.

In some embodiments, each of R⁴, R⁷, R¹⁰, and R¹⁴ is phenyl.

In some embodiments, R³, R⁴, R⁵, R⁶, R⁷, R⁸, R⁹, R¹⁰, R¹¹, R¹², R¹³, and R¹⁴ are hydrogen; X¹ is N; and X² is N.

In some embodiments, the disclosure relates to a compound of Formula I or a salt thereof, wherein at least one of R³, R⁴, R⁵, R⁶, R⁷, R⁸, R⁹, R¹⁰, R¹¹, R¹², R¹³, and R¹⁴ is not hydrogen.

In certain embodiments, the disclosure relates to a compound of Formula I or a salt thereof, wherein at least two of R³, R⁴, R⁵, R⁶, R⁷, R⁸, R⁹, R¹⁰, R¹¹, R¹², R¹³, and R¹⁴ are not hydrogen.

In some embodiments, the disclosure relates to a compound of Formula I or a salt thereof, wherein at least three of R³, R⁴, R⁵, R⁶, R⁷, R⁸, R⁹, R¹⁰, R¹¹, R¹², R¹³, and R¹⁴ are not hydrogen.

In some embodiments, the disclosure relates to a compound of Formula I or a salt thereof, wherein at least four of R³, R⁴, R⁵, R⁶, R⁷, R⁸, R⁹, R¹⁰, R¹¹, R¹², R¹³, and R¹⁴ are not hydrogen.

In some embodiments, the disclosure relates to a compound of Formula I or a salt thereof, wherein R³, R⁴, R⁵, R⁶, R⁷, R⁸, R⁹, R¹⁰, R¹¹, R¹², R¹³, and R¹⁴ are hydrogen; and X¹ is C(R¹⁵), (O⁺)X⁻, or (S⁺)X⁻.

In some embodiments, the disclosure relates to a compound of Formula I or a salt thereof, wherein R³, R⁴, R⁵, R⁶, R⁷, R⁸, R⁹, R¹⁰, R¹¹, R¹², R¹³, and R¹⁴ are hydrogen; X¹ is C(R¹⁵), (O⁻)X⁻, or (S⁺)X⁻; and X² is C(R¹⁵), (O⁺)X⁻, or (S⁺)X⁻.

In some embodiments, the disclosure relates to a compound of Formula I or a salt thereof, wherein R³, R⁴, R⁵, R⁶, R⁷, R⁸, R⁹, R¹⁰, R¹¹, R¹², R¹³, and R¹⁴ are hydrogen; and X¹ is C(R¹⁵).

In some embodiments, the disclosure relates to a compound of Formula I or a salt thereof, wherein R³, R⁴, R⁵, R⁶, R⁷, R⁸, R⁹, R¹⁰, R¹¹, R¹², R¹³, and R¹⁴ are hydrogen; X¹ is C(R¹⁵); and X² is C(R¹⁵).

In some embodiments, the disclosure relates to a compound of Formula I or a salt thereof, wherein R³, R⁴, R⁵, R⁶, R⁷, R⁸, R⁹, R¹⁰, R¹¹, R¹², R¹³, and R¹⁴ are hydrogen; and X¹ is (O⁺)X⁻ or (S⁺)X⁻.

In some embodiments, the disclosure relates to a compound of Formula I or a salt thereof, wherein R³, R⁴, R⁵, R⁶, R⁷, R⁸, R⁹, R¹⁰, R¹¹, R¹², R¹³, and R¹⁴ are hydrogen; X¹ is (O⁺)X⁻ or (S⁺)X⁻; and X² is (O⁺)X⁻ or (S⁺)X⁻.

In some embodiments, the disclosure relates to a compound of Formula I or a salt thereof, wherein R³, R⁴, R⁵, R⁶, R⁷, R⁸, R⁹, R¹⁰, R¹¹, R¹², R¹³, and R¹⁴ are hydrogen; X¹ is N; and X² is N.

### Methods of Oxygen Reduction

In some embodiments, the disclosure relates to a composition comprising a compound of Formula I or a salt thereof and a support material; wherein the compound is in contact with the support material.

In some embodiments, the disclosure relates to a composition wherein the support material comprises carbon.

In some embodiments, the disclosure relates to a composition wherein the support material comprises carbon powder.

In some embodiments, the disclosure relates to a composition wherein the support material comprises carbon black (CB), multi-walled carbon nanotubes (MWCNT), graphene oxide (GO), or reduced graphene oxide (rGO).

In some embodiments, the disclosure relates to a composition wherein the compound is adsorbed on the support material.

In some embodiments, the disclosure relates to a cathode catalyst, comprising a compound of Formula I or a salt thereof or a composition comprising a compound of Formula I or a salt thereof.

In some embodiments, the disclosure relates to a fuel cell, comprising a cathode catalyst comprising a compound of Formula I or a salt thereof or a composition comprising a compound of Formula I or a salt thereof.

In some embodiments, the disclosure relates to a method of reducing oxygen, comprising:

in an electrochemical device, applying current to a mixture comprising an aqueous medium, hydrogen gas, oxygen gas, and a compound of Formula I or a salt thereof or a composition comprising a compound of Formula I or a salt thereof.

In some embodiments, the disclosure relates to a method of reducing oxygen, wherein the aqueous medium is an alkaline medium.

In some embodiments, the disclosure relates to a method of reducing oxygen, wherein the electrochemical device is an anion-exchange membrane fuel cell or an alkaline metal-air battery.

In some embodiments, the disclosure relates to a method of reducing oxygen, wherein the aqueous medium is an acidic medium.

In some embodiments, the disclosure relates to a method of reducing oxygen, wherein the electrochemical device is a proton-exchange membrane fuel cell.

### EXAMPLES

Although methods and materials similar or equivalent to those described herein can be used in the practice of the present invention, suitable methods and materials are described below. The invention is further described in the following examples, which do not limit the scope of the invention described in the claims.

General Synthetic Considerations

Where indicated, synthetic procedures were carried out under an inert atmosphere in a nitrogen-filled glovebox. All other synthetic transformations were carried out on the benchtop without effort to exclude dioxygen or moisture. Anhydrous 1,10-phenanthroline (99%), 1,3-dibromopropane (98%), tert-butanol (99%) and phosphorus pentachloride (98%) were obtained from Alfa Aesar. Potassium tert-butoxide (97%) and phosphoryl chloride (99%) were obtained from TCI and Sigma Aldrich, respectively. Compressed anhydrous ammonia (99.995%) was purchased from Airgas. N,N-dimethylformamide was deoxygenated and dried using a Glass Contour System (SG Water USA, Nashua, N.H.) and stored in the glovebox over 4 Å molecular sieves. D₂O, CDCl₃ and d-TFA were purchased from Sigma-Aldrich and Cambridge Isotope Laboratories and used without further purification. 2, 3, 7, 8, 12, 13, 17, 18-Octaethyl-21H, 23H-porphine iron(III) chloride (OEP-FeCl) was purchased from Frontier Scientific. OEP-FeCl was used without further purification. Routine NMR spectra were recorded on Varian Mercury 300, Bruker Avance III 400 and Varian Inova 500 spectrometers. Chemical shifts for ¹H and ¹³C{¹H} spectra are reported in ppm downfield of TMS, with spectra referenced using the chemical shifts of the solvent residuals. Spectra collected in d-TFA were referenced to a benzene solvent residual by including a small capillary of C₆D₆ in the sample tube. UV-visible spectra were measured in a 1-cm quartz cell on a Varian Cary 50 monochromatic spectrophotometer. MALDI-TOF mass spectra were obtained using a Bruker Omniflex instrument operating in reflectron mode, and the peaks reported are the mass number of the most intense peak in the isotope envelopes. Samples consisted of mixtures of analyte with 1,4-bis(5-phenyl-2-oxazolyl)benzene (POPOP) as a desorption matrix. In all cases, the observed isotope patterns were in good agreement with calculated ones. Elemental analyses were performed by Robertson Microlit Laboratories (Ledgewood, N.J.).

Compounds 2-4 were obtained according to the procedures of Guo and coauthors⁴³ with several modifications: Compound 2 was synthesized using toluene as the solvent. Compound 3 was prepared using the modified workup described by Song et al.⁴⁴ The workup procedure for compound 4 was simplified by decomposing the POCl₃ solvent with aqueous ammonium hydroxide (30%) to a pH greater than 8 and filtering the resulting precipitate. The solid was washed with water, and dried in a 60° C. oven.

General Electrochemical Methods

i. Homogeneous. N,N-dimethylformamide previously treated as described above was stored in the glovebox before use for the preparation of all non-aqueous electrolytes. Trifluoroacetic acid (ReagentPlus® 99%) and tetrabutylammonium hexafluorophosphate (99%) were obtained from Sigma Aldrich. Thallium triflate (99%) was purchased from Strem Chemicals and used as received. [TBA][PF₆] was recrystallized from EtOH and stored in a 60° C. oven before use. [DMF-H][OTf] was synthesized by a known procedure⁴⁶ and stored in the glovebox until use. In all cases, a custom Ag/AgCl pseudoreference electrode was used, constructed from a Ag/AgCl wire placed in a glass housing filled with 0.1 M [TBA][PF₆] in DMF and isolated from the bulk solution by a Vycor® frit. The experimental potentials measured against the pseudoreference electrode were adjusted to the Fc/Fc⁺ redox couple by spiking the electrolyte with a small quantity of ferrocene. In all cases glassy carbon rod electrodes were used as both the cathode and anode. See FIG. 15.

Caution: Thallium is extremely toxic and is easily absorbed through the skin, particularly in the presence of a solvent like DMF. Handle with care. We elected to use TlOTf rather than a more common halide abstraction agent such as AgOTf due to the fact that the Tl redox couple is found at more cathodic potentials and is therefore less likely to convolute a cyclic voltammetry measurement.

ii. Heterogeneous. Sodium hydroxide (99.99%, semiconductor grade), potassium ferricyanide (ACS grade) and potassium sulfate (99.99%, semiconductor grade) were obtained from Sigma Aldrich and used as received. 5 wt % perfluorinated Nafion® resin solution was obtained from Ion Power Inc. Aqueous electrolyte solutions were prepared with deionized water purified to a resistivity of 18.2 M Ω-cm using a Milliq water purification system (Millipore Corporation). Monarch 1300 and Vulcan VXC72R carbon powders were obtained from Cabot Corporation and used as received. Glassy carbon disk electrodes were obtained from Pine Research Instrumentation, Inc. Hg/HgO and Hg/Hg₂SO₄ reference electrodes were obtained from CHI instruments, Inc. A titanium mesh was used as the counter electrode for all electrochemical experiments. The titanium counter was constructed of titanium wire (99.9%) and titanium gauze (40 mesh) obtained from Alfa Aesar and was treated with aqua regia prior to use.

All electrochemical experiments were conducted at ambient temperature using a Biologic VSP 16-channel potentiostat and a three-electrode electrochemical cell. In all cases, the counter electrode was isolated from the working compartment by a counter compartment equipped with a porous glass frit. Hg/HgO and Hg/Hg₂SO₄ reference electrodes were used for all experiments conducted in alkaline and acidic aqueous electrolytes, respectively. The Hg/HgO reference was stored in 3 M NaOH solution between measurements. Electrode potentials measured in aqueous alkaline media were converted to the reversible hydrogen electrode (RHE) scale using the following relationship: E(RHE)=E(Hg/HgO)+0.094 V+0.059*(pH) V. The Hg/Hg₂SO₄ electrode was stored in saturated K₂SO₄ solution between measurements. Electrode potentials measured in aqueous acidic media were converted to the RHE scale using E(RHE)=E(Hg/Hg₂SO₄)+0.65 V+0.059*(pH) V.

Routine electrochemical measurements were performed at a 5 mm diameter glassy carbon disk electrode rotated at 2000 RPM. All scan rates were 5 mV/s to allow for adequate equilibration between the bulk solution and outer Helmholtz plane. Cyclic and linear sweep voltammograms were started from the open circuit potential and swept in the cathodic direction. All experiments were run without iR compensation due to negligible iR losses in the electrolytes used in this study. Solutions were sparged for 10 minutes before the initial experiment with either N₂ or O₂ and for another 10 minutes when changing between solubilized gases. During an experiment, the headspace of the cell was continually flushed with the working gas to minimize solution contamination by atmospheric gases. All experiments were conducted using 10 μL of ink was dropcast on a polished RDE, except where noted. Catalytic onset potentials were taken to be the potential at which the observed current density was equivalent to −100 μA cm⁻².

a. Preparation of Carbon Inks. Inks for use in electrochemical studies are obtained by suspending 1 mg/mL catalyst (either porphyrin- or (phen₂N₂)-based) in 2.5 mg/mL Vulcan VXC72R carbon. DCM, EtOH and 5 wt % Nafion solution are added sequentially in a ratio of 7:2:1. The resulting mixture is sonicated for 16 minutes to give the product ink. Inks were usually produced in 1 mL batches. Note that superior results in terms of carbon powder dispersion and ORR activity are obtained when DCM is added to the solid precursor mixture first followed by EtOH and Nafion solution.

b. Rotating ring-disk electrode (RRDE) voltammetry. RRDE was performed with a Pine rotator using a ChangeDisk tip. RRDE experiments conducted in acid were performed with a platinum ring while experiments conducted in base were performed with a gold ring.⁴⁴ The Pt and Au rings were cleaned by cyclic voltammetry at 50 mV s⁻¹ over potential ranges of 1 to −0.8 V and 1.1 to −0.7 V, respectively, vs the Hg/Hg₂SO₄ reference in 0.1 M HClO₄. The potential was swept over this range until the cyclic voltammograms overlaid exactly.

The proportion of H₂O₂ produced during ORR was quantified using the following relationship:⁴⁵

$$\% {H}_{2} {O}_{2} = \frac{100 ( \frac{2 {i}_{ring}}{N} )}{{i}_{disk} + ( \frac{{i}_{ring}}{N} )} \qquad ( 1 )$$

In this case, i_{ring} and i_{disk} are the currents at the ring and disk electrodes, respectively and N is the collection efficiency. The number of electrons transferred as a function of applied potential was calculated using equation 2:⁴⁶

$${n}_{e -} = \frac{4 {i}_{disk}}{{i}_{disk} + ( \frac{{i}_{ring}}{N} )} \qquad ( 2 )$$

The collection efficiency constant was calculated at the end of each experimental set under a given set of conditions by examining the Fe(III/II) couple of a suitable redox reagent via chronoamperometry or cyclic voltammetry where the collection efficiency is defined as the ratio of i_{ring} to i_{disk}. Typical collection efficiency values were in the range of 18-22%. Collection efficiency measurements were conducted using a blank glassy carbon disk and clean ring. Fe₂(SO₄)₃ and K₃Fe(CN)₆ were used as the redox agents for the collection efficiency measurements in acid and base, respectively.

Zero Field ⁵⁷Fe Mössbauer spectroscopy and curve fitting. Zero-field ⁵⁷Fe Mössbauer spectra were measured with a constant acceleration spectrometer (SEE Co., Minneapolis, Minn.) at 90 K. Solid samples (20-30 mg for molecular samples and 120 mg for Fe—N—C) were prepared by mixing each sample powder with Paratone-N oil. With the exception of the (phen₂N₂)FeCl sample, each sample was prepared outside the glovebox. The (phen₂N₂)FeCl sample was prepared similarly except the sample preparation process was carried out inside a nitrogen-filled glovebox and the sample was frozen with liquid nitrogen before handling outside the glovebox. All isomer shifts are reported relative to a-Fe metal at 298 K. All data were processed, fitted, and analyzed using an in-house software package for IGOR Pro 6 (Wavemetrics, Lake Oswego, Oreg.).

X-ray photoelectron spectroscopy and curve fitting. X-ray photoelectron spectroscopy experiments were performed on ThermoFisher Aluminum K Alpha+ (ESCA) or ThermoFisher Nexsa X-ray spectrometer systems with monochromatic aluminum K_{α} X-ray sources (1486.68 eV). Samples for analysis were prepared by distributing a small amount of Au powder (for referencing) on conductive carbon tape and spreading the analyte on top. The analyte was mixed with the Au powder to allow for simultaneous detection of analyte and the Au powder. All experiments were run with the flood gun on to prevent sample charging. All data were collected using a 400 μm, 72 W focused X-ray beam at a base pressure of 2×10⁻⁷ millibar or lower. Survey scans were collected at a pass energy of 200 eV and step size of 1 eV. High resolution scans were collected with a pass energy of 50 eV and a step size of 0.1 eV. All data were analyzed with the Thermo Avantage software package (v5.987). The Au 4f_{7/2} peak arising from the Au powder was assigned an energy of 84.0 eV and used as an internal binding energy reference for all spectra. In all cases the recorded spectral data was not modified with a smoothing algorithm. High-resolution spectra were fit by application of a Shirley-type (Smart) background and Gaussian/Lorentzian line-shapes of 30% Gaussian shape. The Simplex fitting algorithm was used in all cases. This procedure was used to generate the data in FIG. 19.

X-Ray Absorption Spectroscopy

X-ray absorption spectroscopy (XAS) experiments were performed at the 10-BM beamline at the Advanced Photon Source (APS) at Argonne National Laboratory. All measurements were performed at the Fe K edge (7.112 keV) in transmission mode in fast scan from 250 eV below the edge to 550 eV above the edge. Samples were pressed into a stainless-steel sample holder and placed in a sample cell. The cell was sealed and purged with He at room temperature. The data were interpreted using WinXAS 3.1 software to find the coordination number and bond distance using standard procedures. The phase and amplitude functions for Fe—N and Fe—O were extracted from theoretical Feff6 calculations. The Fe foil (CN=8, R=2.54 Å) was used a reference to calibrate the Sₒ², which was 0.64. Theoretical phase and amplitude files were created for the Fe—N (CN=1, R=1.94 Å) and Fe—O (CN=1, R=1.99 Å) scattering pairs. Least squared fits of the first shell of r-space and isolated q-space were performed on the k² weighted Fourier transform data over the range 2.71 to 10 Å⁻¹ in each spectrum to fit the magnitude and imaginary components.

Computational Details

All DFT calculations were performed using the ab-initio software package Q-Chem,⁴⁸ using the meta-hybrid functional TPSSh⁴⁹ and the basis set 6-31+G*.⁵⁰⁻⁵² To model solvation, the implicit solvation model IEF-PCM with a dielectric constant of 78.4 was used.⁵³ All molecular images were generated using the software package VESTA.⁵⁴

The geometry of (phen₂N₂)Fe, porphyrinFe, and both material analogues were optimized with spin states mₛ=0, 1, and 2. It was determined that the most stable spin state with our method is mₛ=1, as has previously been noted for porphyrinFe.⁵⁵ The geometry of each catalyst was optimized with O₂, CN⁻, and CO bound to the iron atom of (phen₂N₂)Fe with various spin states, and it was determined that mₛ=0 is the most stable spin state. For O₂, it was necessary to break spin symmetry and obtain the lower energy anti-ferromagnetic ground singlet state, for which constrained-DFT was used to generate an initial guess for a subsequent unrestricted calculation.⁵⁶

### Example 1. Synthesis of (phen₂N₂)H₂ and (phen₂N₂)FeCl

Compound 2 was synthesized via alkylation of 1,10-phenanthroline using an excess of 1,3-dibromopropane in refluxing toluene. Briefly, 10.787 g (59.86 mmol) 1,10-phenanthroline was suspended in 105 mL toluene. The mixture was stirred and heated to 70° C. and, subsequently, 28 mL (55.47 g, 275 mmol, 4.59 equiv.) 1,3-dibromopropane was added. The temperature was increased to 120° C. and the mixture was refluxed for 4 hours. After allowing the reaction vessel to cool, the mixture was filtered and washed with hexanes to yield 18.688 g (82%) of compound 2 as a yellow powder. Observed NMR peaks in D₂O matched the literature.⁴³

Compound 3 was prepared using the modified workup described by Song et al.⁴ 5.061 g (13.24 mmol) of compound 2 was suspended in 85 mL tert-butanol and sonicated for 15 minutes. The mixture was then stirred while 6.026 g (53.7 mmol, 4.06 equiv.) KOtBu was added in small portions over the course of 15 minutes. The reaction mixture was then heated to 40° C. and stirred for 12 hours. The solvent was removed by rotary evaporation and the crude material was suspended in 100 mL of water. The product was extracted with 100 mL of chloroform and 5% methanol by volume was added to the chloroform solution. The mixture was then filtered through a plug of silica on a glass frit and the silica was washed with chloroform until the eluant was colorless. The combined washings were concentrated to dryness by rotary evaporation to yield 1.746 g (52%) of compound 3 as a brown solid. The observed NMR peaks in CDCl₃ matched those reported in the literature.⁴³

Compound 4 was synthesized via treatment of compound 3 with PCl₅ in POCl₃. Under inert atmosphere, a mixture of 1.916 g (7.60 mmol) compound 3 and 3.326 g (15.97 mmol) PCl₅ was suspended in 40 mL POCl₃. The mixture was then refluxed under inert atmosphere for 14 hours. After cooling to room temperature, the POCl₃ solvent and unreacted PCl₅ were quenched and the resulting mixture was neutralized with aqueous ammonium hydroxide (30%) to a pH>8. After neutralization, the resulting precipitate was filtered. The solid was washed with water and dried overnight in an oven to yield 1.801 g (95%) of compound 4 as a light brown powder. NMR peaks in CDCl₃ matched those given in the literature.⁴³

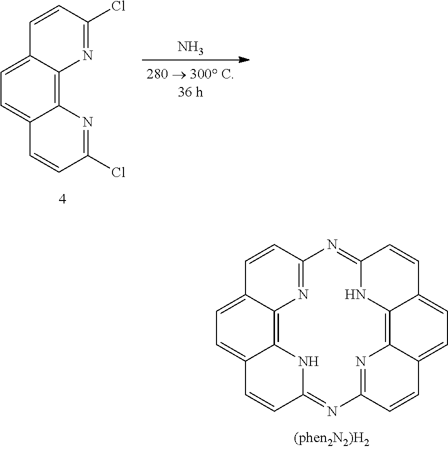

3bH,10bH-1,14:7,8-Diethenotetrapyrido[2,1,6-de:2′,1′,6′-gh:2″,1″,6″-kl:2″′,1′″,6′″-na][1,3,5,8,10,12]hexa-azacyclotetradecine, (phen₂N₂)H₂. 0.5467 g (2.19 mmol) 2,9-dichlorophenanthroline is added to a cylindrical glass insert and enclosed in a Parr bomb at room temperature. The bomb was purged with nitrogen for 10 minutes before being pressurized with anhydrous ammonia at 114 PSI. The bomb was then immersed in a bed of aluminum beads and brought to 300° C. using a heating mantle over 24 hours. After heating for a further 5 hours, the bomb is allowed to return to room temperature. The residual ammonia is vented and the crude product is dissolved in a mixture of acetic acid and methanol and stirred for 30 minutes. The mixture is basified with 4M NaOH before the mixture is stirred for an additional 12 hours. The precipitate is filtered and sequentially washed with 100 mL each of ethanol and chloroform before being dried at 60° C. for 12 hours. The filtrate is concentrated in vacuo and heated to 300° C. under inert atmosphere for a further 24 hours in a 500 mL round bottom flask affixed to a reflux condenser. After cooling to room temperature, the solid derived from the filtrate is treated with an identical dissolution, precipitation and washing sequence as before to yield a second crop. 0.2797 g (0.506 mmol, 66% combined yield) of (phen₂N₂)H₂ is isolated as a brown solid. ¹H NMR (C₆D₆ in d-TFA): δ 9.41 (d, 4H, 10 Hz), 8.76 (s, 4H), 8.49 (d, 4H, 10 Hz). MALDI-MS (POPOP matrix): m/z 386.42 [M]⁺ Anal. Calcd for (phen₂N₂)H₂.H₂O (C₂₄H₁₆N₆O₁): C, 71.28; H, 3.99; N, 20.78. Found: C, 70.93; H, 3.47; N, 21.12.

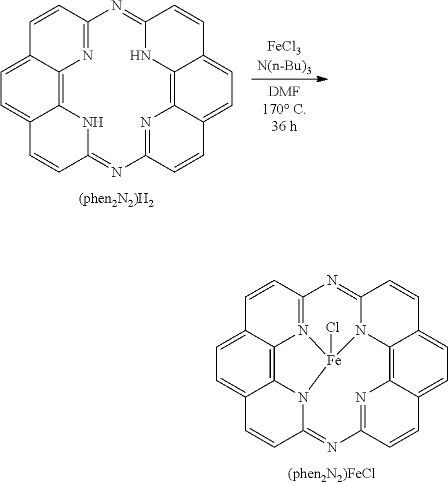

1,14:7,8-Diethenotetrapyrido[2,1,6-de:2′,1′,6′-gh:2″,1″,6″-kl:2′″,1′″,6′″-na][1,3,5,8,10,12]hexa-azacyclotetradecine iron(III) chloride, (phen₂N₂)FeCl. 0.0600 g (0.155 mmol) (phen₂N₂)H₂ is added to a pressure tube containing a stir bar in the glovebox. 0.0358 g (0.221 mmol, 1.42 equiv.) FeCl₃ and 0.221 mL (0.930 mmol, 6.00 equiv.) Bu3N are added to the vessel followed by 7 mL DMF. The tube is sealed and removed from the glovebox before being heated to 170° C. for 36 hours with vigorous stirring. The temperature is allowed to return to ambient levels and the mixture is diluted with 20 mL DCM under inert atmosphere. The mixture is then cooled overnight at 38° C. and the resulting precipitate filtered and washed with ether and DCM to yield 54 mg (73%) (phen₂N₂)FeCl. HR MALDI-TOF (POPOP matrix): m/z 440.1197 (M—Cl, calc. for C₂₄H₁₆FeN₆: 440.0473).

### Example 2. Synthesis of Fe—N—C

Fe—N—C was synthesized by a hybrid method adapted from previously published procedures.^{57,58} 19.4 mg (0.111 mmol) Fe(OAc)₂, 206.3 mg (1.14 mmol) 1,10-phenanthroline and 803.5 mg (3.53 mmol) ZIF-8 MOF are mixed together in an agate mortar for 15 minutes. To remove excess water and oxygen, the prepyrolysis mixture was subjected to vacuum for 30 minutes at 90° C. followed by a further 12 hours at room temperature. 855.7 mg of the precatalyst powder is weighed into an alumina boat and loaded into a single-zone alumina tube furnace. The tube furnace is sealed and placed under vacuum briefly before being continuously purged with argon. The furnace is heated to 1000° C. at a ramp rate of 10° C. min⁻¹ and maintained at 1000° C. for 60 minutes. The furnace is allowed to return to room temperature and the system is evacuated before being continuously purged with 5% hydrogen in argon. The furnace is ramped to 800° C. at a rate of 10° C. min⁻¹ and maintained at 800° C. for 30 minutes before being allowed to return to room temperature. The product Fe—N—C is sonicated in 30 mL of 0.1 M H₂SO₄ for 60 minutes. Afterwards, the product is filtered and washed with water until the eluant pH is neutral. After washing with acetone to remove excess water, the product is dried overnight at 60° C. to yield 219.2 mg of Fe—N—C.

### Example 3. Synthesis of (ph₄phen₂N₂)FeCl

(Ph₄phen₂N₂)FeCl was synthesized according to the route depicted in Scheme 1.

Synthesis of (ph₄phen₂N₂)H₂. 17.3 mg (0.0477 mmol) 2,9-diaminobathophenanthroline is added to a 50 mL flask containing a stir bar. 17.3 mg (0.047 mmol, 0.99 equiv.) 2,9-difluorobathophenanthroline and 0.704 g (5.1 mmol, 107 equiv.) potassium carbonate are added to the flask. 40 mL DMF is added and the mixture is degassed and the yellow mixture is stirred for 48 hours at 160° C. After cooling to room temperature, the mixture is poured into 100 mL distilled water. The resulting precipitate is collected by centrifugation and dried in a 60° C. oven. Chromatography in 5% methanol in dichloromethane on silica gel gives the title compound as a yellow solid. ¹H NMR (CDCl₃): δ 7.66 (s, 4H), 7.64 (dd, 8H, 8, 2 Hz), 7.58-7.52 (m, 16H). MALDI-MS (POPOP matrix): m/z 690.624 ([M]⁺ calc. for C₂₄H₁₄N₆: 690.253).

Synthesis of (ph₄phen₂N₂)FeCl. 21.5 mg (0.0312 mmol) (ph₄phen₂N₂)H₂ is added to a 25 mL flask containing a stir bar and is dissolved in 4 mL dimethylacetamide. 15.3 mg (0.077 mmol, 2.47 equiv.) FeCl₂.4H₂O and 0.2 mL (0.145 g, 1.43 mmol, 46 equiv.) triethylamine are added and the mixture is stirred at 155° C. for 4 hours. After cooling the mixture to room temperature, the contents are poured onto ice. 4 mL of 6 M aqueous HCl is added and the mixture is stirred at room temperature for 14 hours. The mixture is extracted repeatedly with dichloromethane. The organics are combined and concentrated to dryness on the rotary evaporator. During the process of removing the solvent, heptane is added to help remove trace dimethylacetamide. Afterwards, the brown solid is placed in a 100° C. oven for several hours. 23 mg (95%) (ph₄phen₂N₂)FeCl is obtained as a brown powder. MALDI-TOF (POPOP matrix): m/z 744.583 ([M-Cl]⁺, calc. for C₄₈H₂₈FeN₆: 744.177), 779.571 ([M]⁺, calc. for C₄₈H₂₈ClFeN₆: 779.141).

### Example 4. Synthesis of [(phen₂N₂)Fe]₂O and [(OEP)Fe]₂O

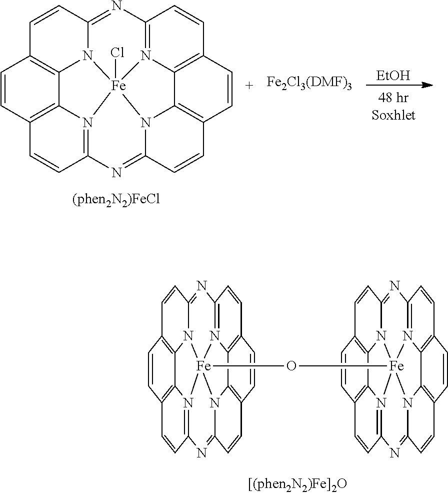

Synthesis of [(phen₂N₂)Fe]₂O. (μ-Oxo)bis[(1,14:7,8-Diethenotetrapyrido[2,1,6-de:2′,1′,6′-gh:2″,1″,6″-kl:2′″,1′″,6′″-na][1,3,5,8,10,12]hexa-azacyclotetradecine)iron(III)], [(phen₂N₂)Fe]₂O. In a typical preparation, a sample of (phen₂N₂)FeCl was placed in a cellulose extraction thimble and loaded into a Soxhlet apparatus. After placing the apparatus under inert atmosphere by purging extensively with argon, the sample was washed continuously with hot ethanol for 48 hours. Afterwards, the sample was removed from the Soxhlet apparatus and dried in an oven overnight to remove trace water and volatile solvents. XPS N:Fe ratio: 6.3:1. ⁵⁷Fe Mössbauer (90 K): δ=0.45 mm s⁻¹, |ΔE_{Q}|=0.87 mm s⁻¹. HR MALDI-TOF (POPOP matrix): m/z 440.0975 ([M-C₂₄H₁₂FeN₆O]⁺, calc. for C₂₄H₁₂FeN₆: 440.0473). A satisfactory elemental analysis for [(phen₂N₂)Fe]₂O could not be obtained due the presence of trace impurities, which were presumably carried through the metalation and Soxhlet procedures. Similar solubility issues as (phen₂N₂)FeCl above trap trace impurities which are not easily removed by washing.

Synthesis of [(OEP)Fe]₂O. (μ-Oxo)bis[(octaethylporphinato)iron(III)], [OEP)Fe]₂O. Octaethylporphinatoiron(III) chloride dissolved in CH₂Cl₂ was vigorously shaken in a separatory funnel with 2 M NaOH. After separating the layers, the organic layer was washed with water, dried over MgSO₄ and filtered. After washing the MgSO₄ with CH₂Cl₂, the combined organic layers were concentrated to dryness, resulting in a brown microcrystalline solid which was then dried at 60° C. for several hours. The Fe—O—Fe unit was identified by infrared spectroscopy with characteristic bands at 870 and 832 cm⁻¹. These observed values are in line with those reported in the literature for [(OEP)Fe]₂O.⁸ Mössbauer (90 K): δ=0.41 mm s⁻¹, |ΔE_{Q}|=0.67 mm s⁻¹.

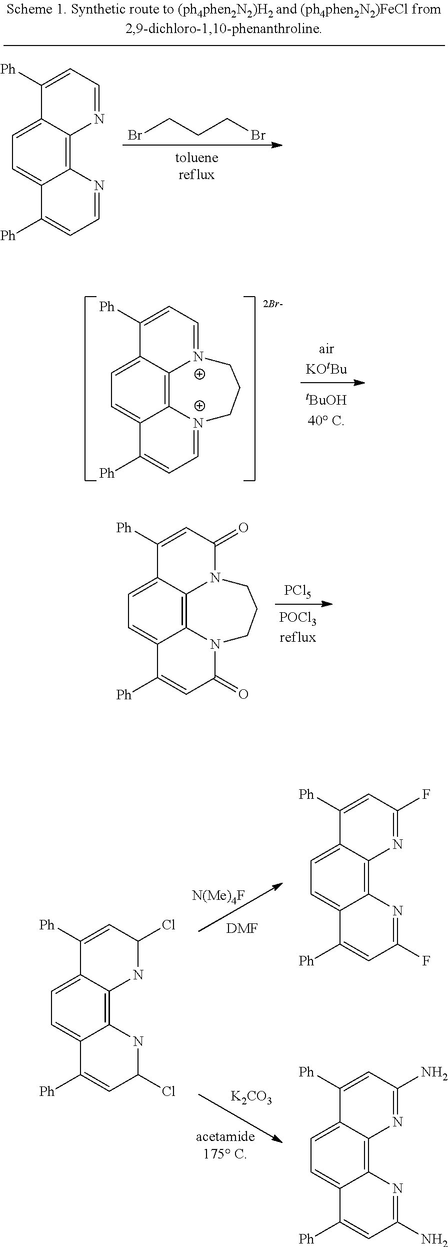

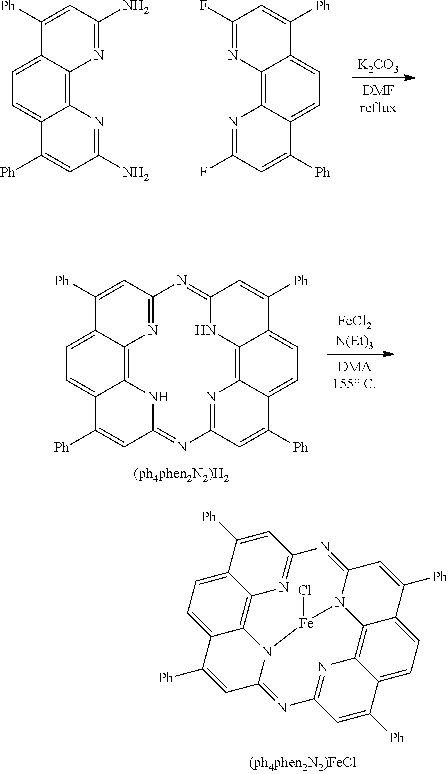

### REFERENCES CITED

(1) Seh, Z. W.; Kibsgaard, J.; Dickens, C. F.; Chorkendorff, I.; Norskov, J. K.; Jaramillo, T. F. Science 2017, 355, eaad4998.

(2) Winter, M.; Brodd, R. J. Chem. Rev. 2004, 104, 4245-4270.

(3) Shao, M.; Chang, Q.; Dodelet, J.-P.; Chenitz, R. Chem. Rev. 2016, 116, 3594-3657.

(4) Sealy, C. Mater. Today 2008, 11, 65-68.

(5) Steele, B. C. H.; Heinzel, A. Nature 2001, 414, 345-352.

(6) Bouwkamp-Wijnoltz, A. L.; Visscher, W.; van Veen, J. A. R.; Boellaard, E.; van der Kraan, A. M.; Tang, S. C. J. Phys. Chem. B 2002, 106, 12993-13001.

(7) Faubert, G.; Cote, R.; Guay, D.; Dodelet, J. P.; Denes, G.; Bertrandc, P. Electrochimica Acta 1998, 43, 341-353.

(8) Zitolo, A.; Goellner, V; Armel, V; Sougrati, M.-T.; Mineva, T.; Stievano, L.; Fonda, E.; Jaouen, F. Nat. Mater. 2015, 14, 937-942.

(9) Kramm, U. I.; Lefvre, M.; Bogdanoff, P.; SchmeiBer, D.; Dodelet, J.-P. J. Phys. Chem. Lett. 2014, 5, 3750-3756.

(10) Jaouen, F.; Marcotte, S.; Dodelet, J.-P.; Lindbergh, G. J. Phys. Chem. B 2003, 107, 1376-1386.

(11) Kramm, U. I.; Lefevre, M.; Larouche, N.; Schmeisser, D.; Dodelet, J.-P. J. Am. Chem. Soc. 2014, 136, 978-985.

(12) Rauf, M.; Zhao, Y-D.; Wang, Y-C.; Zheng, Y.-P.; Chen, C.; Yang, X.-D.; Zhou, Z.-Y; Sun, S.-G. Electrochem. Commun. 2016, 73, 71-74.

(13) Strickland, K.; Miner, E.; Jia, Q.; Tylus, U.; Ramaswamy, N.; Liang, W.; Sougrati, M.-T.; Jaouen, F.; Mukerjee, S. Nat. Commun. 2015, 6.

(14) Ramaswamy, N.; Tylus, U.; Jia, Q.; Mukerjee, S. J. Am. Chem. Soc. 2013, 135, 15443-15449.

(15) Tylus, U.; Jia, Q.; Strickland, K.; Ramaswamy, N.; Serov, A.; Atanassov, P.; Mukerjee, S. J. Phys. Chem. C 2014, 118, 8999-9008.

(16) Jia, Q.; Ramaswamy, N.; Hafiz, H.; Tylus, U.; Strickland, K.; Wu, G.; Barbiellini, B.; Bansil, A.; Holby, E. F.; Zelenay, P.; et al. ACS Nano 2015, 9, 12496-12505.

(17) Jia, Q.; Ramaswamy, N.; Tylus, U.; Strickland, K.; Li, J.; Serov, A.; Artyushkova, K.; Atanassov, P.; Anibal, J.; Gumeci, C.; et al. Nano Energy 2016, 29, 65-82.

(18) Gewirth, A. A.; Varnell, J. A.; DiAscro, A. M. Chem. Rev. 2018, 118, 2313-2339.

(19) Strauss, S. H.; Silver, M. E.; Long, K. M.; Thompson, R. G.; Hudgens, R. A.; Spartalian, K.; Ibers, J. A. J. Am. Chem. Soc. 1985, 107, 4207-4215.

(20) van Veen, J. A. R.; van Baar, J. F.; Kroese, K. J. J. Chem. Soc. Faraday Trans. 1 1981, 77, 2827-2843.

(21) Taube, R. Pure Appl. Chem. 1974, 38, 427-438.

(22) Melendres, C. A. J. Phys. Chem. 1980, 84, 1936-1939.

(23) Lovecchio, F. V.; Gore, E. S.; Busch, D. H. J. Am. Chem. Soc. 1974, 96, 3109-3118.

(24) Sustmann, R.; Korth, H.-G.; Kobus, D.; Baute, J.; Seiffert, K.-H.; Verheggen, E.; Bill, E.; Kirsch, M.; de Groot, H. Inorg. Chem. 2007, 46, 11416-11430.

(25) Kramm, U. I.; Herrmann-Geppert, I.; Behrends, J.; Lips, K.; Fiechter, S.; Bogdanoff, P. J. Am. Chem. Soc. 2016, 138, 635-640.

(26) Seno, M.; Tsuchiya, S.; Ogawa, S. J. Am. Chem. Soc. 1977, 99, 3014-3018.

(27) Lavallee, D. K.; Brace, J.; Winograd, N. Inorg. Chem. 1979, 18, 1776-1780.

(28) Jia, H.; Sun, Z.; Jiang, D.; Yang, S.; Du, P. Inorg. Chem. Front. 2016, 3,821-827.

(29) Zhang, Z.; Sun, J.; Wang, F.; Dai, L. Angew. Chem. Int. Ed. 2018, 57, 9038-9043.

(30) Kastner, M. E.; Scheidt, W. R.; Mashiko, T.; Reed, C. A. J. Am. Chem. Soc. 1978, 100, 666-667.

(31) Reed, C. A.; Mashiko, T.; Bentley, S. P.; Kastner, M. E.; Scheidt, W. R.; Spartalian, K.; Lang, G. J. Am. Chem. Soc. 1979, 101, 2948-2958.

(32) Sakai, T.; Ohgo, Y.; Hoshino, A.; Ikeue, T.; Saitoh, T.; Takahashi, M.; Nakamura, M. Inorg. Chem. 2004, 43, 5034-5043.

(33) Schünemann, V.; Gerdan, M.; Trautwein, A. X.; Haoudi, N.; Mandon, D.; Fischer, J.; Weiss, R.; Tabard, A.; Guilard, R. Angew. Chem. Int. Ed. 1999, 38, 3181-3183.

(34) Sahoo, D.; Rath, S. P. Chem. Commun. 2015, 51, 16790-16793.

(35) Ohgo, Y; Neya, S.; Ikeue, T.; Takahashi, M.; Takeda, M.; Funasaki, N.; Nakamura, M. Inorg. Chem. 2002, 41, 4627-4629.

(36) Jäger, E.-G.; Hähnel, H.; Klein, H.-F.; Schmidt, A. J. Für Prakt. Chem. 1991, 333,423-430.

(37) Keutel, H.; Käpplinger, I.; Jäger, E.-G.; Grodzicki, M.; Schünemann, V; Trautwein, A. X. Inorg. Chem. 1999, 38, 2320-2327.

(38) Dolphin, D. H.; Sams, J. R.; Tsin, T. B. Inorg. Chem. 1977, 16, 711-713.

(39) Sams, J. R.; Tsin, T. B. In The Porphyrins; Elsevier, 1979; pp 425-478.

(40) Ling, Y; Zhang, Y. J. Am. Chem. Soc. 2009, 131, 6386-6388.

(41) Birry, L.; Zagal, J. H.; Dodelet, J.-P. Electrochem. Commun. 2010, 12, 628-631.

(42) Bae, I. T.; Scherson, D. A. J. Phys. Chem. B 1998, 102, 2519-2522.

(43) Guo, H. C.; Zheng, R. H.; Jiang, H. J. Org. Prep. Proced. Int. 2012, 44, 392-396.

(44) Annibale, V. T.; Batcup, R.; Bai, T.; Hughes, S. J.; Song, D. Organometallics 2013, 32, 6511-6521.

(45) Zhou, R.; Zheng, Y.; Jaroniec, M.; Qiao, S.-Z. ACS Catal. 2016, 6, 4720-4728.

(46) Rigsby, M. L.; Wasylenko, D. J.; Pegis, M. L.; Mayer, J. M. J. Am. Chem. Soc. 2015, 137, 4296-4299.

(47) Song, C.; Zhang, J. In PEM Fuel Cell Electrocatalysts and Catalyst Layers; Zhang, J., Ed.; Springer London: London, 2008; pp 89-134.

(48) Favier, I.; Duñach, E. Tetrahedron Lett. 2004, 45, 3393-3395.

(49) Shao, Y.; Gan, Z.; Epifanovsky, E.; Gilbert, A. T. B.; Wormit, M.; Kussmann, J.; Lange, A. W.; Behn, A.; Deng, J.; Feng, X.; et al. Mol. Phys. 2015, 113, 184-215.

(50) Staroverov, V. N.; Scuseria, G. E.; Tao, J.; Perdew, J. P. J. Chem. Phys. 2003, 119, 12129-12137.

(51) Hehre, W. J.; Ditchfield, R.; Pople, J. A. J. Chem. Phys. 1972, 56, 2257-2261.

(52) Ditchfield, R.; Hehre, W. J.; Pople, J. A. J. Chem. Phys. 1971, 54, 724-728.

(53) Clark, T.; Chandrasekhar, J.; Spitznagel, G. W.; Schleyer, P. V. R. J. Comput. Chem. 1983, 4, 294-301.

(54) Cances, E.; Mennucci, B.; Tomasi, J. J. Chem. Phys. 1997, 107, 3032.

(55) Momma, K.; Izumi, F. J. Appl. Crystallogr. 2008, 41, 653-658.

(56) Chen, H.; Ikeda-Saito, M.; Shaik, S. J. Am. Chem. Soc. 2008, 130, 14778-14790.

(57) Wu, Q.; Van Voorhis, T. Phys. Rev. A 2005, 72.

(58) Zitolo, A.; Goellner, V.; Armel, V.; Sougrati, M.-T.; Mineva, T.; Stievano, L.; Fonda, E.; Jaouen, F. Nat. Mater. 2015, 14, 937-942.

### INCORPORATION BY REFERENCE

All of the U.S. patents and U.S. patent application publications cited herein are hereby incorporated by reference. In case of conflict, the present specification, including definitions, will control.

### EQUIVALENTS

Those skilled in the art will recognize, or be able to ascertain using no more than routine experimentation, many equivalents to the specific embodiments of the invention described herein. Such equivalents are intended to be encompassed by the following claims.

1. A compound of Formula I or a salt thereof: 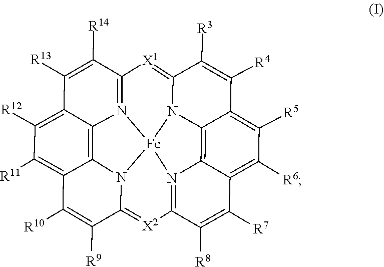
wherein
X¹ and X² are independently N, C(R¹⁵), (O⁺)X⁻, or (S⁺)X⁻;
X⁻ is independently for each occurrence boron tetrafluoride, phosphorus tetrafluoride, phosphorus hexafluoride, alkylsulfonate, fluoroalkylsulfonate, arylsulfonate, bis(alkylsulfonyl)amide, bis(fluoroalkylsulfonyl)amide, bis(arylsulfonyl)amide, (fluoroalkylsulfonyl)(fluoroalkylcarbonyl)amide, halide, nitrate, nitrite, sulfate, hydrogensulfate, alkyl sulfate, aryl sulfate, carbonate, bicarbonate, alkyl carboxylate, aryl carboxylate, phosphate, hydrogen phosphate, dihydrogen phosphate, hypochlorite, or an anionic site of a cation-exchange resin;
R³, R⁴, R⁵, R⁶, R⁷, R⁸, R⁹, R¹⁰, R¹¹, R¹², R¹³, and R¹⁴ are independently hydrogen, halogen, —CN, —OR¹⁵, —CO₂⁻(Y⁺), —SO₃H, —SO₃⁻(Y⁺), —NR¹⁶R¹⁷, —NO₂, substituted or unsubstituted alkyl, substituted or unsubstituted cycloalkyl, substituted or unsubstituted aryl, substituted or unsubstituted heteroaryl, substituted or unsubstituted heterocycloalkyl, haloalkyl, —OC(O)R²⁰, —C(O)R²⁰, —C(O)OR²⁰, —C(O)NR²¹R²², —S(O)R²³, or —SO₂R²³;
Y⁺ is Li⁺, Na⁺, K⁺, Mg²⁺, Ca²⁺, or ⁺NR¹⁶R¹⁷R¹⁸R¹⁹;
and
R¹⁵, R¹⁶, R¹⁷, R¹⁸, R¹⁹, R²⁰, R²¹, and R²³ are independently hydrogen, haloalkyl, substituted or unsubstituted alkyl, substituted or unsubstituted cycloalkyl, substituted or unsubstituted aryl, substituted or unsubstituted heteroaryl, or substituted or unsubstituted heterocycloalkyl.

2. The compound of claim 1, wherein X¹ is C(R¹⁵) or X² is C(R¹⁵).

3. (canceled)

4. The compound of claim 1, wherein X¹ is C(R¹⁵); and X² is C(R¹⁵).

5. The compound of claim 1, wherein X¹ is N or X² is N.

6. (canceled)

7. The compound of claim 1, wherein X¹ is (O⁺)X⁻ or (S⁺)X⁻ or X² is (O⁺)X⁻ or (S⁺)X⁻.

8. (canceled)

9. The compound of claim 1, wherein R¹⁵ is selected from the group consisting of hydrogen, substituted alkyl, unsubstituted alkyl, substituted cycloalkyl, unsubstituted cycloalkyl, substituted aryl, unsubstituted aryl, substituted heteroaryl, and unsubstituted heteroaryl.

10-13. (canceled)

14. The compound of claim 1, wherein:
X¹ is N; and X² is N; or
X¹ is (O⁺)X⁻ or (S⁺)X⁻; and X² is (O⁺)X⁻ or (S⁺)X⁻.

15. (canceled)

16. The compound of claim 1, wherein at least one, at least two, at least three, or at least four of R³, R⁴, R⁵, R⁶, R⁷, R⁸, R⁹, R¹⁰, R¹¹, R¹², R¹³, and R¹⁴ are not hydrogen.

17-19. (canceled)

20. The compound of claim 1, wherein R³, R⁴, R⁵, R⁶, R⁷, R⁸, R⁹, R¹⁰, R¹¹, R¹², R¹³, and R¹⁴ are hydrogen; and
X¹ is C(R¹⁵), (O⁺)X⁻, or (S⁺)X⁻;
X¹ is C(R¹⁵), (O⁺)X⁻, or (S⁺)X⁻; and X² is C(R¹⁵), (O⁺)X⁻, or (S⁺)X⁻;
X¹ is C(R¹⁵); and X² is C(R¹⁵);
X¹ is (O⁻)X⁻ or (S⁺)X⁻; and X² is (O⁺)X⁻ or (S⁺)X⁻; or
X¹ is N; and X² is N.

21-26. (canceled)

27. The compound of claim 1, wherein:
X¹ is N; and the compound of Formula I is a Bronsted conjugate acid or a quaternary (C₁-C₆)alkyl ammonium salt at X¹; or
X² is N; and the compound of Formula I is a Bronsted conjugate acid or a quaternary (C₁-C₆)alkyl ammonium salt at X².

28. (canceled)

29. The compound of claim 1, wherein X¹ is N; X² is N; the compound of Formula I is a Bronsted conjugate acid or a quaternary (C₁-C₆)alkyl ammonium salt at X¹; and the compound of Formula I is a Bronsted conjugate acid or a quaternary (C₁-C₆)alkyl ammonium salt at X².

30. A composition, comprising a compound of claim 1; and a support material; wherein the compound is in contact with the support material.

31. The composition of claim 30, wherein the support material comprises carbon.

32. (canceled)

33. The composition of claim 30, wherein the support material comprises carbon powder, carbon black (CB), multi-walled carbon nanotubes (MWCNT), graphene oxide (GO), or reduced graphene oxide (rGO).

34. (canceled)

35. A cathode catalyst, comprising a compound of claim 1.

36. A fuel cell, comprising a cathode catalyst of claim 35.

37. A method of reducing oxygen, comprising:
in an electrochemical device, applying current to a mixture comprising an aqueous medium, hydrogen gas, oxygen gas, and a compound of claim 1.

38. The method of claim 37, wherein the aqueous medium is an alkaline medium or an acidic medium.

39. The method of claim 37, wherein the electrochemical device is an anion-exchange membrane fuel cell or an alkaline metal-air battery.

40. (canceled)

41. The method of claim 39, wherein the electrochemical device is a proton-exchange membrane fuel cell.
